(19) United States
(12) Patent Application Publication
(10) Pub. No.: US 2024/0063387 A1
(43) Pub. Date: Feb. 22, 2024

(54) POSITIVE ELECTRODE ACTIVE MATERIAL AND SECONDARY BATTERY

(71) Applicant: SEMICONDUCTOR ENERGY LABORATORY CO., LTD., Atsugi-shi (JP)

(72) Inventors: Shunpei YAMAZAKI, Tokyo (JP); Tetsuya KAKEHATA, Isehara (JP); Shuhei YOSHITOMI, Ayase (JP); Yohei MOMMA, Isehara (JP); Atsushi KAWATSUKI, Yokohama (JP); Mayumi MIKAMI, Atsugi (JP); Junya MARUYAMA, Ebina (JP); Akio ENDO, Atsugi (JP); Kaori OGITA, Isehara (JP)

(21) Appl. No.: 18/449,140

(22) Filed: Aug. 14, 2023

(30) Foreign Application Priority Data
Aug. 18, 2022 (JP) 2022-130430
Dec. 20, 2022 (JP) 2022-203401

(51) Int. Cl. H01M 4/525; C01G 51/00; H01M 50/109; H01M 4/62; H01M 4/66; H01M 50/417

(52) U.S. Cl. CPC H01M 4/525; C01G 51/42; H01M 50/109; H01M 4/625; H01M 4/623; H01M 4/661; H01M 50/417; C01P 2002/52; C01P 2006/40; C01P 2004/61; C01P 2004/04; C01P 2002/90; C01P 2002/77; C01P 2002/72

(57) ABSTRACT

A positive electrode active material having a high charge-discharge capacity and high safety and a secondary battery including the positive electrode active material are provided. The positive electrode active material includes lithium, a transition metal M, an additive element, and oxygen. The powder volume resistivity of the positive electrode active material is higher than or equal to 1.0×10⁵ Ω·cm at a temperature of higher than or equal to 180° C. and lower than or equal to 200° C. and at a pressure of higher than or equal to 0.3 MPa and lower than or equal to 2 MPa. The median diameter of the positive electrode active material is preferably greater than or equal to 3 μm and less than or equal to 10 μm.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device each including a secondary battery, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Documents 1 to 3). Crystal structures of positive electrode active materials have also been studied (Non-Patent Documents 1 to 4).

X-ray diffraction (XRD) is one of methods used for analysis of a crystal structure of a positive electrode active material. XRD data can be analyzed with the use of the Inorganic Crystal Structure Database (ICSD) described in Non-Patent Document 5. For example, the ICSD can be referred to for the lattice constant of the lithium cobalt oxide described in Non-Patent Document 6. For Rietveld analysis, the analysis program RIETAN-FP (Non-Patent Document 7) can be used, for example. For example, VESTA (Non-Patent Document 8) or the like can be used for drawing crystal structures

Shannon's ionic radii (Non-Patent Document 9) can be referred to for consideration of a crystal structure of an oxide.

As image processing software, for example, ImageJ (Non-Patent Documents 10 to 12) is known. Using this software makes it possible to analyze the shape of a positive electrode active material, for example.

Nanobeam electron diffraction can also be effectively used to identify the crystal structure of a positive electrode active material, in particular, the crystal structure of a surface portion of the positive electrode active material. For analysis of electron diffraction patterns, an analysis program called ReciPro (Non-Patent Document 13) can be used, for example.

Fluorides such as fluorite (calcium fluoride) have been used as fusing agents in iron manufacture and the like for a very long time, and the physical properties of fluorides have been studied (Non-Patent Document 14).

Various researches and developments have been conducted for the reliability and safety of lithium-ion secondary batteries. For example, Non-Patent Document 15 shows the thermal stability of a positive electrode active material and an electrolyte solution.

### REFERENCE

[Patent Document 1] Japanese Published Patent Application No. 2019-179758
[Patent Document 2] PCT International publication No. WO2020/026078
[Patent Document 3] Japanese Published Patent Application No. 2020-140954

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 22, 2012, pp. 17340-17348.
[Non-Patent Document 2] T. Motohashi et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂”, Journal of The Electrochemical Society, 149 (12), 2002, A1604-A1609.
[Non-Patent Document 4] G. G. Amatucci et al., “CoO₂, The End Member of the LiₓCoO₂ Solid Solution”, J. Electrochem. Soc., 143 (3), 1114-1123 (1996).
[Non-Patent Document 5] Belsky, A. et al., “New developments in the Inorganic Crystal Structure Database (ICSD): accessibility in support of materials research and design”, Acta Cryst., (2002), B58, 364-369.
[Non-Patent Document 6] Akimoto, J.; Gotoh, Y.; Oosawa, Y. “Synthesis and structure refinement of LiCoO₂ single crystals”, Journal of Solid State Chemistry (1998) 141, pp. 298-302.
[Non-Patent Document 7] F. Izumi and K. Momma, “Three-Dimensional Visualization in Powder Diffraction” Solid State Phenom., (2007) 130, 15-20
[Non-Patent Document 8] K. Momma and F. Izumi, “VESTA 3 for three-dimensional visualization of crystal, volumetric and morphology data” J. Appl. Cryst. (2011) 44, 1272-1276.
[Non-Patent Document 9] Shannon, R. D, “Revised Effective Ionic Radii and Systematic Studies of Interatomic Distances in Halides and Chalcogenides” Acta Crystallographica Section A, (1976) A32, 751-767.
[Non-Patent Document 10] Rasband, W. S., ImageJ, U. S. National Institutes of Health, Bethesda, Maryland, USA, http://rsb.info.nih.gov/ij/, 1997-2012.
[Non-Patent Document 11] Schneider, C. A., Rasband, W. S., Eliceiri, K. W., “NIH Image to ImageJ: 25 years of image analysis”, Nature Methods, 9, 671-675, 2012.
[Non-Patent Document 12] Abramoff, M. D., Magelhaes, P. J., Ram, S. J., “Image Processing with ImageJ”, Biophotonics International, volume 11, issue 7, pp. 3642, 2004.
[Non-Patent Document 13] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.
[Non-Patent Document 14] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1], 12-17 (1953).
[Non-Patent Document 15] Shinya Kitano et al., GS Yuasa Technical Report, Vol. 2, No. 2, December, 2015, pp. 18-24.

### SUMMARY OF THE INVENTION

Development of lithium-ion secondary batteries has room for improvement in terms of discharge capacity, cycle performance, reliability, safety, cost, and the like.

Therefore, positive electrode active materials that can improve discharge capacity, cycle performance, reliability, safety, cost, and the like when used in lithium-ion secondary batteries have been needed.

An object of one embodiment of the present invention is to provide a positive electrode active material with high safety when the positive electrode active material is used in a lithium-ion secondary battery. Another object of one embodiment of the present invention is to provide a positive electrode active material or a composite oxide which can be used in a lithium-ion secondary battery and with which a decrease in discharge capacity due to charge-discharge cycles is suppressed. Another object is to provide a positive electrode active material or a composite oxide having a crystal structure that is unlikely to be broken by repeated charge and discharge. Another object is to provide a positive electrode active material or a composite oxide with high discharge capacity. Another object is to provide a secondary battery with high safety or high reliability.

Another object of one embodiment of the present invention is to provide a positive electrode active material, a composite oxide, a power storage device, or a manufacturing method thereof.

Another object of one embodiment of the present invention is to provide a measurement apparatus of electric resistance of a positive electrode active material or a secondary battery or a method for measuring the electric resistance.

Note that the description of these objects does not preclude the existence of other objects. One embodiment of the present invention does not need to achieve all these objects. Other objects can be derived from the description of the specification, the drawings, and the claims.

To solve any of the above objects, one embodiment of the present invention is to increase the electric resistance of a surface of a positive electrode active material. For example, a positive electrode active material having a high volume resistivity can be provided. With such a positive electrode active material having a high volume resistivity used in a secondary battery, safety of the secondary battery against an internal short circuit or the like is expected to be increased.

One embodiment of the present invention is a positive electrode active material including lithium, a transition metal M, an additive element and oxygen, in which a powder volume resistivity of the positive electrode active material is higher than or equal to 1.0×10¹⁰ Ω·cm at a temperature of higher than or equal to 20° C. and lower than or equal to 30° C. and at a pressure of higher than or equal to 10 MPa and lower than or equal to 20 MPa.

Another embodiment of the present invention is a positive electrode active material including lithium, a transition metal M, an additive element and oxygen, in which a powder volume resistivity of the positive electrode active material is higher than or equal to 1.0×10⁵ Ω·cm at a temperature of higher than or equal to 180° C. and lower than or equal to 200° C. and at a pressure of higher than or equal to 0.3 MPa and lower than or equal to 2 MPa.

In the above, a median diameter of the positive electrode active material is preferably greater than or equal to 3 μm and less than or equal to 10 μm.

In the above, the additive element is preferably at least one of magnesium, fluorine, nickel, and aluminum.

Another embodiment of the present invention is a secondary battery including a positive electrode comprising a positive electrode active material comprising lithium, a transition metal M, an additive element, and oxygen and an electrolyte solution. The electrolyte solution has a current density of less than or equal to 1.0 mA·cm⁻² at any voltage of lower than or equal to 5.0 V when a linear sweep voltammetry (LSV) measurement is performed at a voltage scanning rate of 1.0 mV·s⁻¹ at a temperature of 25° C. on a coin cell comprising a working electrode in which a mixture of acetylene black (AB) and poly(vinylidene fluoride) (PVDF) with a ratio of 1:1 is applied to aluminum foil coated with carbon, a lithium metal counter electrode, and a polypropylene separator.

According to one embodiment of the present invention, a positive electrode active material with high safety when used in a lithium-ion secondary battery can be provided. According to another embodiment of the present invention, a positive electrode active material or a composite oxide which can be used in a lithium-ion secondary battery and with which a decrease in discharge capacity due to charge-discharge cycles is suppressed can be provided. According to another embodiment of the present invention, a positive electrode active material or a composite oxide having a crystal structure that is unlikely to be broken by repeated charge and discharge can be provided. According to another embodiment of the present invention, a positive electrode active material or a composite oxide with high discharge capacity can be provided. According to another embodiment of the present invention, a highly safe or highly reliable secondary battery can be provided.

According to another embodiment of the present invention, a positive electrode active material, a composite oxide, a power storage device, or a manufacturing method thereof can be provided.

According to another object of one embodiment of the present invention, a measurement apparatus of electric resistance of a positive electrode active material or a secondary battery, or a method for measuring the electric resistance can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A and 1B are cross-sectional views of a positive electrode active material;

FIG. 2 is an example of a TEM image showing crystal orientations substantially aligned with each other;

FIG. 3A is an example of a STEM image with which crystal orientations substantially aligned with each other are observed, FIG. 3B is an FFT pattern of a region of a rock-salt crystal RS, and FIG. 3C is an FFT pattern of a region of a layered rock-salt crystal LRS;

FIG. 4 shows crystal structures of a positive electrode active material;

FIG. 5 shows crystal structures of a conventional positive electrode active material;

FIG. 6 shows XRD patterns calculated from crystal structures;

FIG. 7 shows XRD patterns calculated from crystal structures;

FIGS. 8A and 8B show XRD patterns calculated from crystal structures;

FIGS. 9A and 9B illustrate examples of a method for manufacturing a sample for measuring a volume resistivity and FIG. 9C is a schematic view of a measurement system for measuring a volume resistivity;

FIG. 10 is a photograph showing the measurement system for measuring a volume resistivity;

FIGS. 11A to 11C illustrate methods for forming a positive electrode active material;

FIG. 12 shows a method for forming a positive electrode active material;

FIGS. 13A to 13C illustrate methods for forming a positive electrode active material;

FIG. 14 is an external view of a secondary battery;

FIGS. 15A to 15C illustrate an example of a method for forming a secondary battery;

FIGS. 16A and 16B illustrate an example of a secondary battery;

FIG. 17 illustrates an example of a secondary battery;

FIGS. 18A to 18C illustrate an example of a secondary battery;

FIGS. 19A to 19C show an example of a secondary battery;

FIGS. 20A and 20B are a perspective view and a schematic cross-sectional view illustrating one embodiment of the present invention, respectively;

FIG. 21 is an enlarged schematic cross-sectional view of part of a secondary battery according to one embodiment of the present invention;

FIGS. 22A and 22B are cross-sectional views each illustrating a secondary battery according to one embodiment of the present invention;

FIGS. 23A and 23B are schematic cross-sectional views illustrating a nail penetration test;

FIGS. 24A to 24H illustrate examples of electronic devices;

FIGS. 25A to 25D illustrate examples of electronic devices;

FIGS. 26A to 26C illustrate examples of electronic devices;

FIGS. 27A to 27C illustrate examples of vehicles;

FIG. 28 is a graph showing the relation between a volume resistivity and a temperature of a positive electrode active material;

FIG. 29 is a cross-sectional SEM image of a positive electrode;

FIGS. 30A and 30B are graphs showing charge-discharge cycle performance;

FIGS. 31A and 31B are graphs showing charge-discharge cycle performance;

FIGS. 32A and 32B are graphs showing charge-discharge cycle performance;

FIGS. 33A and 33B are graphs showing charge-discharge cycle performance;

FIGS. 34A and 34B are graphs showing charge-discharge cycle performance;

FIG. 35 is a graph showing charge-discharge cycle performance;

FIG. 36 is a graph showing charge-discharge cycle performance;

FIG. 37 is a graph showing charge-discharge cycle performance;

FIGS. 38A and 38B are graphs showing charge-discharge rate characteristics;

FIGS. 39A and 39B are graphs showing charge-discharge rate characteristics;

FIGS. 40A and 40B are graphs showing charge-discharge rate characteristics;

FIGS. 41A1 to 41B2 are photographs of a nail penetration test; and

FIGS. 42A1 to 42B2 are photographs illustrating results of a nail penetration test.

### DETAILED DESCRIPTION OF THE INVENTION

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, a positive electrode active material refers to a compound containing oxygen and a transition metal into and from which lithium can be inserted and extracted.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

With respect to the theoretical capacity, the remaining amount of lithium in a positive electrode active material is represented by x in a compositional formula, e.g., LiₓCoO₂. In the case of a positive electrode active material in a secondary battery, x can be represented by (theoretical capacity−charge capacity)/theoretical capacity. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

In the case where lithium cobalt oxide almost satisfies the stoichiometric proportion is LiCoO₂, the occupancy rate of Li in the lithium sites is x=1. Even after discharge of a secondary battery ends, the lithium cobalt oxide can be called LiCoO₂ with x of 1. Here, “discharge ends” means that a voltage becomes 2.5 V or lower (vs. Li counter electrode) at a current of 100 mAh/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary. At this time, it can be said that the discharge ends. In general, in a lithium-ion secondary battery using LiCoO₂, the discharge voltage rapidly decreases until discharge voltage reaches 2.5 V; thus, discharge is regarded as ending when the above condition is satisfied. When the positive electrode in which discharge has ended is analyzed by an X-ray Diffraction (XRD) pattern or the like, a general crystal structure of LiCoO₂ can be observed.

The charge capacity and discharge capacity used for calculation of x in LiₓCoO₂ are preferably measured under conditions of no short circuits and no or less influence of decomposition of an electrolyte. For example, data of a secondary battery, containing a sudden change that seems to result from a short circuit should not be used for calculation of x.

The space group of a crystal structure is identified by an XRD pattern, an electron diffraction pattern, a neutron diffraction pattern, or the like. Thus, in this specification and the like, belonging to a space group or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned right above voids between anions packed in a first layer, and anions in a third layer are placed at the positions that are positioned right above voids between the anions in the second layer and are not positioned right above the anions in the first layer. Accordingly, anions do not necessarily form a cubic lattice structure. At the same time, actual crystals have a defect and thus, analysis results are not necessarily consistent with the theory. For example, in an electron diffraction pattern or a fast Fourier transform (FFT) pattern of a transmission electron microscope (TEM) image or the like, a spot may appear in a position slightly different from a theoretical position. For example, anions may be regarded as forming a cubic close-packed structure when a difference in orientation from a theoretical position is 5° or less or 2.5° or less.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex. The positive electrode active material refers to a plurality of particles of lithium cobalt nickel oxide.

The potential of a positive electrode generally increases with increasing charge voltage of a secondary battery. The positive electrode active material of one embodiment of the present invention has a stable crystal structure even at a high charge voltage. The stable crystal structure of the positive electrode active material in a charged state can reduce a decrease in a charge and discharge capacity due to repeated charge and discharge.

A short circuit of a secondary battery might cause not only a malfunction in charge operation and/or discharge operation of the secondary battery but also heat generation and ignition. In order to obtain a safe secondary battery, short-circuit current is preferably inhibited even at a high charge voltage. With the positive electrode active material of one embodiment of the present invention, short-circuit current is inhibited even at a high charge voltage. Thus, a secondary battery with both high discharge capacity and high safety can be provided.

The description is made on the assumption that materials (such as a positive electrode active material, a negative electrode active material, an electrolyte, and the like) of a secondary battery have not deteriorated unless otherwise specified. For example, a state where a charge-discharge capacity is higher than or equal to 97% of the rated capacity of a secondary battery can be regarded as a non-degraded state. The rated capacity conforms to Japanese Industrial Standards (JIS C 8711:2019). Note that in this specification and the like, in some cases, materials included in a secondary battery that have not deteriorated are referred to as initial products or materials in an initial state, and materials that have deteriorated (have a charge-discharge capacity lower than 97% of the rated capacity of the secondary battery) are referred to as products in use, materials in a used state, products that are already used, or materials in an already-used state.

### Embodiment 1

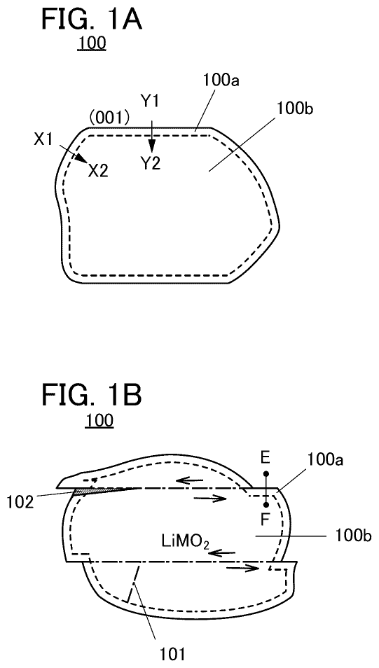

In this embodiment, the positive electrode active material 100 of one embodiment of the present invention will be described with reference to FIG. 1A to FIG. 9C.

FIGS. 1A and 1B are cross-sectional views of the positive electrode active material 100 of one embodiment of the present invention. As illustrated in FIG. 1A, the positive electrode active material 100 includes a surface portion 100a and an inner portion 100b. In the drawings, the dashed line denotes a boundary between the surface portion 100a and the inner portion 100b. In FIG. 1B, the dashed-dotted line denotes part of a crystal grain boundary 101. FIG. 1B illustrates the positive electrode active material 100 including a filling portion 102. In the drawing, (001) refers to a (001) plane of lithium cobalt oxide. LiCoO₂ belongs to a space group R-3m.

In this specification and the like, the surface portion 100a of the positive electrode active material 100 refers to, for example, a region ranging from the surface to a depth of 50 nm or less, preferably a depth of 35 nm or less, further preferably a depth of 20 nm or less, most preferably a depth of 10 nm or less in a perpendicular direction or a substantially perpendicular direction from the surface toward the inner portion. Note that “substantially perpendicular” refers to a state where an angle is greater than or equal to 80° and less than or equal to 100°. A plane generated by at least one of a slip, a crack, and a split can be considered as the surface of the positive electrode active material 100. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

The surface of the positive electrode active material 100 refers to a surface of a composite oxide that includes the surface portion 100a and the inner portion 100b, for example. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100 are not contained either.

The crystal grain boundary 101 refers to, for example, a portion where particles of the positive electrode active material 100 adhere to each other, or a portion where a crystal orientation changes inside the positive electrode active material 100, i.e., a portion where repetition of bright lines and dark lines is discontinuous in a scanning transmission electron microscope (STEM) image or the like, a portion including a large number of crystal defects, a portion with a disordered crystal structure, or the like. A crystal defect refers to a defect that can be observed in a cross-sectional transmission electron microscope (TEM) image, a cross-sectional STEM image, or the like, i.e., a structure including another atom between lattices, a cavity, or the like. The crystal grain boundary 101 can be regarded as a plane defect. The vicinity of the crystal grain boundary 101 refers to a region ranging from the crystal grain boundary 101 to 10 nm or less.

### <Volume Resistivity>

The positive electrode active material 100 preferably has a high powder volume resistivity. Specifically, in the temperature of higher than or equal to 20° C. and lower than or equal to 30° C. at the pressure of higher than or equal to 10 MPa and lower than or equal to 20 MPa, the powder volume resistivity of the positive electrode active material 100 is preferably higher than or equal to 1.0×10⁶ Ω·cm, further preferably higher than or equal to 1.0×10⁸ Ω·cm, still further preferably higher than or equal to 1.0×10¹⁰ Ω·cm, yet still further preferably higher than or equal to 1.0×10¹¹ Ω·cm.

Note that in this specification and the like, the temperature that is one of measurement conditions of a volume resistivity represents a temperature measured by a temperature sensor placed near a measurement sample. The temperature sensor can be provided, for example, in parts that apply a pressure to a sample in a measurement apparatus. In addition, the pressure that is one of measurement conditions of the volume resistivity represents a value obtained by a load sensor placed in the same axis as the direction of a pressure applied to the measurement sample. A load cell can be used as the load sensor, for example, and can be placed in the same axis as the direction of a pressure, being in contact with the parts that apply the pressure to the sample in the measurement apparatus.

Furthermore, the powder volume resistivity of the positive electrode active material 100 is preferably higher than or equal to 1.0×10⁶ Ω·cm, further preferably higher than or equal to 1.0×10⁸ Ω·cm, still further preferably higher than or equal to 1.0×10¹⁰ Ω·cm, yet still further preferably higher than or equal to 1.0×10¹¹ Ω·cm at a temperature of higher than or equal to 40° C. and lower than or equal to 50° C. and at a pressure of higher than or equal to 0.3 MPa and lower than or equal to 2 MPa, typically 1.52 MPa.

In addition, the powder volume resistivity of the positive electrode active material 100 is preferably higher than or equal to 1.0×10⁶ Ω·cm, further preferably higher than or equal to 5.0×10⁷ Ω·cm, still further preferably higher than or equal to 1.0×10⁹ Ω·cm, yet further preferably higher than or equal to 1.0×10¹⁰ Ω·cm at a temperature of higher than or equal to 55° C. and lower than or equal to 65° C. and at a pressure of higher than or equal to 0.3 MPa and lower than or equal to 2 MPa.

Furthermore, the powder volume resistivity of the positive electrode active material 100 is preferably higher than or equal to 1.0×10⁵ Ω·cm, further preferably higher than or equal to 5.0×10⁶ Ω·cm, still further preferably higher than or equal to 1.0×10⁸ Ω·cm at a temperature of higher than or equal to 90° C. and lower than or equal to 110° C. and at a pressure of higher than or equal to 0.3 MPa and lower than or equal to 2 MPa.

Moreover, the powder volume resistivity of the positive electrode active material 100 is preferably higher than or equal to 1.0×10⁴ Ω·cm, further preferably higher than or equal to 1.0×10⁵ Ω·cm, still further preferably higher than or equal to 1.0×10⁶ Ω·cm at a temperature of higher than or equal to 180° C. and lower than or equal to 200° C. and at a pressure of higher than or equal to 0.3 MPa and lower than or equal to 2 MPa.

Such a high volume resistivity results from a larger detection amount of an additive element in the surface portion 100a than that of the inner portion 100b as described later.

With a higher powder volume resistivity of the positive electrode active material, current is less likely to flow into the positive electrode active material when an internal short circuit or the like occurs, so that the reduction reaction rate of the positive electrode active material can be slowed. Therefore, a higher volume resistivity of the positive electrode active material makes it less likely to cause release of oxygen from the positive electrode active material, decomposition of an electrolyte solution, or the like when an internal short circuit occurs, probably resulting in inhibiting thermal runway of a secondary battery and reducing risks such as ignition or smoking. Accordingly, a secondary battery using the positive electrode active material of one embodiment of the present invention can have high safety. Note that the ease of thermal runway, ignition, and reeking smoke due to an internal short circuit can be evaluated by a nail penetration test described later, for example.

However, too high a powder volume resistivity is not preferred, making the internal resistance too high when the positive electrode active material is used in a secondary battery. Therefore, the powder volume resistivity is preferably lower than or equal to 1.0×10¹⁴ Ω·cm, further preferably lower than or equal to 1.0×10¹³ Ω·cm at a temperature of higher than or equal to 20° C. and lower than or equal to 30° C. and at a pressure of higher than or equal to 10 MPa and lower than or equal to 20 MPa.

### <Contained Element>

The positive electrode active material 100 contains lithium, cobalt, oxygen, and an additive element. The positive electrode active material 100 contains lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material 100 of one embodiment of the present invention mainly contain cobalt as a transition metal taking part in an oxidation-reduction reaction. In addition to cobalt, at least one or both of nickel and manganese may be contained. Using cobalt at greater than or equal to 75 atomic %, preferably greater than or equal to 90 atomic %, further preferably greater than or equal to 95 atomic % as the transition metal contained in the positive electrode active material 100 brings many advantages such as relatively easy synthesis, easy handling, and excellent cycle performance, which is preferable.

When cobalt is used as the transition metal contained in the positive electrode active material 100 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge-discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements is preferably less than 25 atomic %, further preferably less than 10 atomic %, still further preferably less than 5 atomic %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element is preferably present in the positive electrode active material 100. Thus, in STEM-energy dispersive X-ray spectroscopy (EDX) line analysis, for example, a position where the amount of the detected additive element increases is preferably at a deeper level than a position where the amount of the detected transition metal M increases, i.e., on the inner portion side of the positive electrode active material 100.

In this specification and the like, the depth at which the amount of detected element increases in STEM-EDX line analysis refers to the depth at which a measured value, which can be determined not to be a noise in terms of intensity, spatial resolution, and the like, is successively obtained.

Such an additive element further stabilizes the crystal structure of the positive electrode active material 100 as described later. In this specification and the like, an additive element can be rephrased as part of a raw material or a mixture.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

### <Crystal Structure>

<<x in LiₓCoO₂ is 1>>

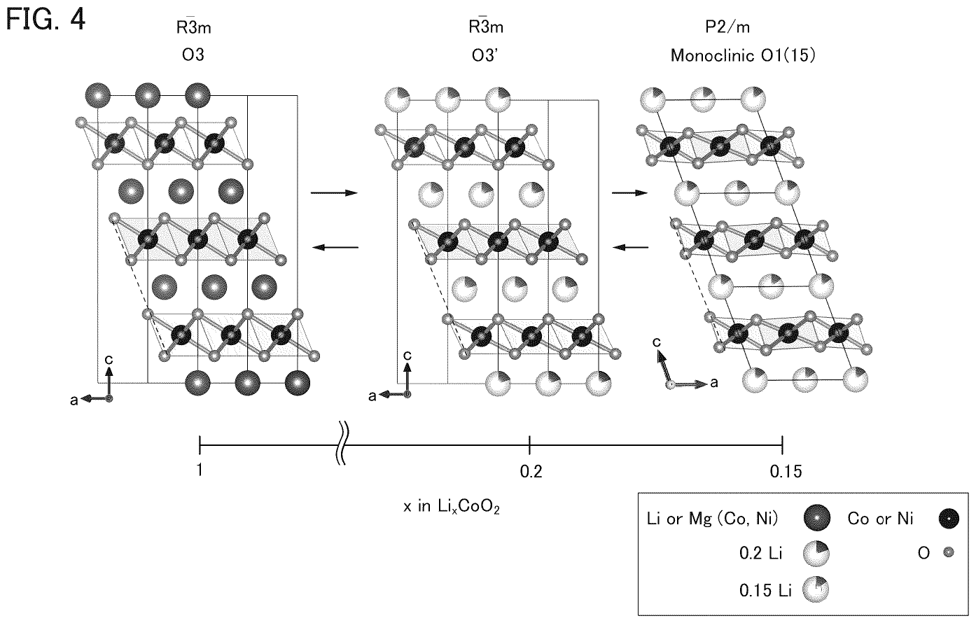

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure is favorably used as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 4, the layered rock-salt crystal structure is denoted by R-3m O3. In the R-3m O3 type structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 6).

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibiting extraction of oxygen and/or a structural change of the surface portion 100a and the inner portion 100b of the positive electrode active material 100 such as a shift in the layered structure formed of octahedrons of cobalt and oxygen, and/or inhibiting oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. For example, it is presumable that a shift in the crystal structure of the layered structure formed of octahedrons of cobalt and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, when the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be suppressed.

### [Distribution]

To obtain a stable composition and a stable crystal structure in the surface portion 100a, the surface portion 100a preferably contains an additive element, further preferably a plurality of additive elements. The surface portion 100a preferably contains one or more selected from the additive elements at higher concentrations than those in the inner portion 100b. The one or more selected from the additive elements contained in the positive electrode active material 100 preferably have concentration gradients. In addition, it is further preferable that the additive elements contained in the positive electrode active material 100 be differently distributed. For example, it is further preferable that peaks of the detected amounts of the additive elements in the surface portion be exhibited at different depths from the surface or the reference point in energy dispersive X-ray spectroscopy (EDX) line analysis described later. The peak of the detected amount here refers to a local maximum value of the detected amount in the surface portion 100a or a region ranging from the surface to 50 nm or less. The detected amount refers to counts in EDX line analysis.

The arrow X1-X2 is shown in FIG. 1A as a depth direction example of a crystal plane, which is not the (001) plane of the positive electrode active material 100 of one embodiment of the present invention.

The detected amounts of at least magnesium and nickel among the additive elements are preferably larger in the surface portion 100a in the crystal plane, which is not the (001) plane of the positive electrode active material 100 than in the inner portion 100b. Peaks with small peak widths of the detected amounts of magnesium and nickel are preferably observed in a region of the surface portion 100a that is closer to the surface. For example, the peaks of the detected amounts of magnesium and nickel are preferably observed in a region ranging from the surface or the reference point to 3 nm or less. The distribution of magnesium and that of nickel preferably overlap with each other. The peak of the detected amount of magnesium and that of the detected amount of nickel may be at the same depth, the peak of magnesium may be closer to the surface than the peak of nickel, or the peak of nickel may be closer to the surface than the peak of magnesium. The difference in depth between the peak of the detected amount of magnesium and the peak of the detected amount of nickel is preferably less than or equal to 3 nm, further preferably less than or equal to 1 nm.

In some cases, the detected amount of nickel in the inner portion 100b is much smaller than that of nickel in the surface portion 100a or is not detected.

As in the case of magnesium or nickel, the detected amount of fluorine is preferably larger in the surface portion 100a than in the inner portion 100b. A peak of the detected amount of fluorine is preferably observed in a region of the surface portion 100a that is closer to the surface. For example, the peak of the detected amount of fluorine is preferably observed in a region ranging from the surface or the reference point to 3 nm or less. Similarly, the detected amounts of titanium, silicon, phosphorus, boron, and/or calcium are/is also preferably larger in the surface portion 100a than in the inner portion 100b. The peaks of the detected amounts are preferably observed in a region of the surface portion 100a that is closer to the surface. For example, the peaks of the detected amounts are preferably observed in a region ranging from the surface or the reference point to 3 nm or less.

A peak of the detected amount of at least aluminum among the additive elements is preferably observed in a region that is located inward from a region in which a peak of the detected amount of magnesium is observed. The distribution of magnesium and that of aluminum may overlap with each other; alternatively, there may be almost no overlap between the distribution of magnesium and that of aluminum. A peak of the detected amount of aluminum may be observed in the surface portion 100a or in a region at a larger depth than the surface portion 100a. For example, the peak is preferably observed in a region ranging from the surface or the reference point to a depth of from 5 nm to 30 nm, both inclusive, toward the inner portion.

Aluminum is distributed more inwardly than magnesium as described above probably because the diffusion rate of aluminum is higher than that of magnesium. The detected amount of aluminum is small in the region that is the closest to the surface, by contrast, probably because aluminum can stay stably in a region other than a region where the concentration of magnesium or the like is high.

To be specific, in a region having a layered rock-salt crystal structure belonging to the space group R-3m or a cubic rock-salt crystal structure, the distance between a cation and oxygen in a region where the concentration of magnesium is high is longer than the distance between a cation and oxygen in LiAlO₂ having a layered rock-salt crystal structure, and aluminum is thus difficult to be present stably. In the vicinity of cobalt, valence change due to substitution of Mg²⁺ for Li⁺ can be compensated for by Co³⁺ becoming Co²⁺, so that cation balance can be maintained. By contrast, Al is always trivalent and is thus presumed to be unlikely to coexist with magnesium in a rock-salt or layered rock-salt crystal structure.

As in the case of aluminum, a peak of the detected amount of manganese is preferably observed in a region that is located inward from a region in which a peak of the detected amount of magnesium is observed.

Note that the additive elements do not necessarily have similar concentration gradients and similar distributions throughout the surface portion 100a of the positive electrode active material 100. The arrow Y1-Y2 is shown in FIG. 1A as a depth direction example of the (001) plane of lithium cobalt oxide of the positive electrode active material 100.

The distribution of the additive element at the surface having a (001) orientation may be different from that at other surfaces in the positive electrode active material 100. For example, the detected amounts of one or more of the additive elements may be smaller at the surface having the (001) orientation and the surface portion 100a thereof than at a surface having an orientation other than the (001) orientation. Specifically, the detected amount of nickel may be smaller. Alternatively, at the surface having a (001) orientation and the surface portion 100a thereof, one or more of the additive elements may not be detected. Specifically, nickel may not be detected. Especially in the case of EDX or any other analysis method in which characteristic X-rays are detected, the energy of Kβ line in cobalt is close to that of Kα line in nickel and it is thus difficult to detect a slight amount of nickel in a material whose main element is cobalt. Alternatively, the peaks of the detected amounts of one or more of the additive elements at the surface having the (001) orientation and the surface portion 100a thereof may be positioned at portions shallower from the surface than the peaks of the detected amounts of the one or more of the additive elements at the surface having an orientation other than the (001) orientation. Specifically, the peaks of the detected amounts of magnesium and aluminum may be positioned at portions shallower from the surface than the peaks of the detected amounts of magnesium and aluminum at the surface having an orientation other than the (001) orientation.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus extremely important to reinforce the surface having an orientation other than a(001) orientation and the surface portion 100a for maintaining the crystal structure of the whole positive electrode active material 100.

Accordingly, in the positive electrode active material 100 of one embodiment of the present invention, it is important that the profile of the additive element at the surface having an orientation other than a (001) orientation and the surface portion 100a thereof is distribution described above. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface having an orientation other than the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface having an orientation other than the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in the following embodiment, in which high-purity LiCoO₂ is formed, the additive element is mixed afterwards, and heating is performed, the additive element spreads mainly through a diffusion path of lithium ions. Thus, distribution of the additive element at the surface having an orientation other than the (001) orientation and the surface portion 100a thereof can easily fall within a preferred range.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high magnesium concentration in the surface portion 100a can be expected to increase the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites as well as the lithium sites. Moreover, an undesired magnesium compound (e.g., an oxide or a fluoride) which does not enter the lithium site or the cobalt site might be unevenly distributed in the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

### [Nickel]

Nickel in a layered rock-salt crystal structure of LiMeO₂ can exist at a cobalt site and/or a lithium site. Since nickel has a lower oxidation-reduction potential than cobalt, the presence of nickel at a cobalt site can facilitate release of lithium and electrons during charging, for example. As a result, the charge and discharge speed is expected to be increased. Accordingly, at the same charge voltage, the charge-discharge capacity in the case of the transition metal M being nickel can be higher than that in the case of the transition metal M being cobalt.

In addition, when nickel exists at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel at the lithium sites also serves as a column supporting the CoO₂ layers. Therefore, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO having a rock-salt crystal structure and CoO having a rock-salt crystal structure, and the orientations of NiO and LiCoO₂ are likely to be aligned with each other.

Ionization tendency is the lowest in nickel, followed in order by cobalt, aluminum, and magnesium (Mg>Al>Co>Ni). Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can exist at a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to suppress a change in the crystal structure. This would reduce degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charging tolerance. Moreover, an Al—O bond is stronger than a Co—O bond and thus extraction of oxygen around aluminum can be inhibited. These effects improve thermal stability. Therefore, a secondary battery that includes the positive electrode active material 100 containing aluminum as the additive element can have higher stability. In addition, the positive electrode active material 100 having a crystal structure that is unlikely to be broken by repeated charge and discharge can be provided.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on whether fluorine exists. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge-discharge characteristics, improved large current characteristics, or the like. When fluorine exists at the surface portion 100a including the surface that is in contact with an electrolyte solution, or when a fluoride is attached to the surface, an overreaction between the positive electrode active material 100 and the electrolyte solution can be suppressed. In addition, the corrosion resistance to hydrofluoric acid can be effectively increased.

In the case where a fluoride such as lithium fluoride that has a lower melting point than the other additive element sources, the fluoride can serve as a fusing agent (also referred to as a flux) for lowering the melting point of the other additive element sources. In the case where the fluoride contains LiF and MgF₂, the eutectic point of LiF and MgF₂ is around 742° C.; thus, the heating temperature in the heating step following the mixing of the additive element is preferably set higher than or equal to 742° C.

A mixture in which LiF and MgF₂ are mixed at a molar ratio of 1:3 exhibits an endothermic peak at around 830° C. in differential scanning calorimetry (DSC) measurement.

Thus, the temperature of the heating following the mixing of the additive element is preferably higher than or equal to 742° C., further preferably higher than or equal to 830° C. Alternatively, the temperature of the heating may be higher than or equal to 800° C. between the above temperatures.

### [Other Additive Elements]

An oxide of titanium is known to have superhydrophilicity. Accordingly, the positive electrode active material 100 that contains titanium oxide in the surface portion 100a can have good wettability with respect to a high-polarity solvent. In a secondary battery formed using this positive electrode active material 100, the positive electrode active material 100 and a high-polarity electrolyte solution can have favorable contact at the interface therebetween, which can reduce an increase in an internal resistance.

The surface portion 100a preferably contains phosphorus, in which case a short circuit can be sometimes inhibited while x in LiₓCoO₂ is kept small. For example, a compound containing phosphorus and oxygen is preferably included in the surface portion 100a.

When the positive electrode active material 100 contains phosphorus, phosphorus may react with hydrogen fluoride generated by the decomposition of the electrolyte solution or the electrolyte, which may decrease the hydrogen fluoride concentration in the electrolyte and is preferable.

In the case where the electrolyte contains LiPF₆, hydrogen fluoride might be generated by hydrolysis. In addition, hydrogen fluoride might be generated by the reaction of poly(vinylidene fluoride) (PVDF) used as a component of the positive electrode and alkali. The decrease in hydrogen fluoride concentration in the electrolyte may inhibit corrosion of a current collector and/or separation of a coating portion or may inhibit a reduction in adhesion properties due to gelling and/or insolubilization of PVDF.

The positive electrode active material 100 preferably contains magnesium and phosphorus, in which case the crystal structure is extremely stable in a state with small x in LiₓCoO₂. When the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where the positive electrode active material 100 has a crack, crack development can be suppressed by phosphorus, more specifically, a compound containing phosphorus and oxygen or the like being in the inner portion of the positive electrode active material having the crack on its surface, e.g., the filling portion 102.

### [Synergistic Effect Between a Plurality of Additive Elements]

When the surface portion 100a contains both magnesium and nickel, divalent nickel can be more stable in the vicinity of divalent magnesium. Thus, even when x in LixCoO2 is small, dissolution of magnesium can be reduced, which can contribute to stabilization of the surface portion 100a.

For a similar reason, when the additive element is added to lithium cobalt oxide in the formation process, magnesium is preferably added in a step before addition of nickel. Alternatively, magnesium and nickel are preferably added in the same step. The reason is as follows: magnesium has a large ion radius and thus is likely to remain in the surface portion of lithium cobalt oxide regardless of in which step magnesium is added, but nickel may be widely diffused to the inner portion of lithium cobalt oxide when magnesium is absent. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure of a wider region can be stabilized. For example, the stable crystal structure can be obtained in a wider region in the case where the positive electrode active material 100 contains, in the surface portion 100a, magnesium and nickel distributed in a region closer to the surface and aluminum distributed in a region deeper than magnesium and nickel, than in the case where only one or two of the additive elements are contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region ranging in depth from the surface to 1 nm to 25 nm, both inclusive. Aluminum is preferably widely distributed in a region ranging in depth from the surface to 0 nm to 100 nm, both inclusive, further preferably a region ranging in depth from the surface to 0.5 nm to 50 nm, both inclusive, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, when measurement by X-ray photoelectron spectroscopy (XPS) is performed from the surface of the positive electrode active material 100, the ratio of the number of magnesium (Mg) atoms to the number of cobalt (Co) atoms (Mg/Co) is preferably less than or equal to 0.62. In addition, the concentration of cobalt is preferably higher than those of nickel, aluminum, and fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and is present randomly also in the inner portion 100b at low concentrations. When magnesium and aluminum are present at the lithium sites of the inner portion 100b at appropriate concentrations, an effect of facilitating maintenance of the layered rock-salt crystal structure can be obtained in a manner similar to the above. When nickel is present in the inner portion 100b at an appropriate concentration, a shift in the layered structure formed of octahedrons of cobalt and oxygen can be suppressed in a manner similar to the above. Also in the case where both magnesium and nickel are contained, a synergistic effect of suppressing dissolution of magnesium can be expected in a manner similar to the above.

### <Substantially the Same Crystal Orientation>

It is preferable that the crystal structure continuously change from the inner portion 100b toward the surface owing to the above-described concentration gradients of such additive elements. Alternatively, it is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the orientations of the surface portion 100a that has a rock-salt crystal structure or has the features of both a rock-salt crystal structure and a layered rock-salt crystal structure and the layered rock-salt inner portion 100b are preferably substantially aligned with each other.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may be present. In the layered rock-salt crystal structure, strictly, a lattice of a rock-salt crystal is distorted in some cases.

A rock-salt crystal structure refers to a structure in which a cubic crystal structure such as a space group Fm-3m is included and cations and anions are alternately arranged. Note that a cation or anion vacancy may be present.

Having features of both a layered rock-salt crystal structure and a rock-salt crystal structure can be determined by electron diffraction, a TEM image, a cross-sectional STEM image, or the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged is seen in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the (111) plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The crystal orientations in two regions being substantially aligned with each other can be determined, for example, from a TEM image, a STEM image, a high-angle annular dark field scanning TEM (HAADF-STEM) image, an annular bright-field scanning transmission electron microscope (ABF-STEM) image, an electron diffraction pattern, an FFT pattern of a TEM image, or an FFT pattern of a STEM image or the like. Furthermore, XRD, neutron diffraction, or the like can also be used for determination.

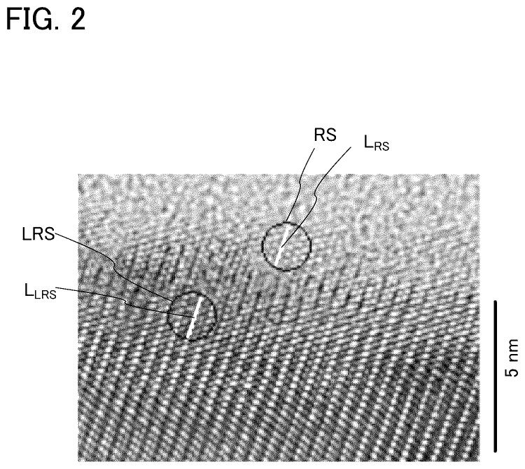

FIG. 2 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 2) is 5° or less or 2.5° or less in the TEM image, it can be determined that the crystal planes are substantially aligned with each other, that is, orientations of the crystals are substantially aligned with each other. Similarly, when the angle between the dark lines is 5° or less or 2.5° or less, it can be determined that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 50 or less or 2.5° or less in a HAADF-STEM image, it can be determined that arrangements of the atoms are substantially aligned with each other, that is, orientations of the crystals are substantially aligned with each other. Similarly, when the angle between the dark lines is 50 or less or 2.5° or less, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

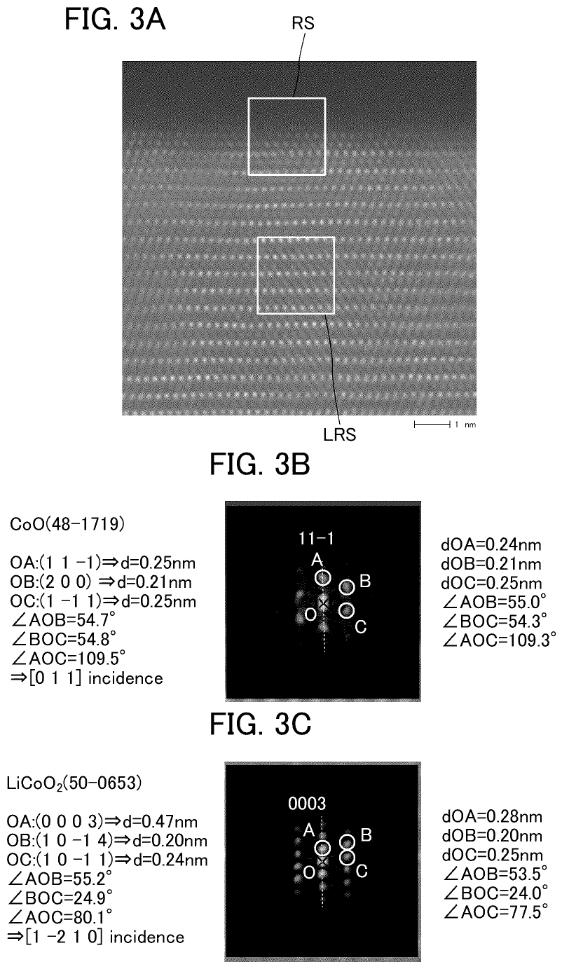

FIG. 3A shows an example of a STEM image in which orientations of the layered rock-salt crystal LRS and the rock-salt crystal RS are substantially aligned with each other. FIG. 3B shows an FFT pattern of a region of the rock-salt crystal RS, and FIG. 3C shows an FFT pattern of a region of the layered rock-salt crystal LRS. In FIGS. 3B and 3C, the composition, the JCPDS card number, and d values and angles calculated from the JCPDS card data are shown on the left. The measured values are shown on the right. A spot denoted by O is zero-order diffraction.

A spot denoted by A in FIG. 3B is derived from 11-1 reflection of a cubic structure. A spot denoted by A in FIG. 3C is derived from 0003 reflection of a layered rock-salt crystal structure. It is found from FIGS. 3B and 3C that the direction of the 11-1 reflection of the cubic structure and the direction of the 0003 reflection of the layered rock-salt crystal structure are substantially aligned with each other. That is, a straight line that passes through AO in FIG. 3B is substantially parallel to a straight line that passes through AO in FIG. 3C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferred that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 3C is derived from 1014 reflection of the layered rock-salt crystal structure. This is sometimes observed at a position where the difference in orientation from the reciprocal lattice point derived from the 0003 reflection of the layered rock-salt crystal structure (A in FIG. 3C) is greater than or equal to 52° and less than or equal to 56° (i.e., ∠AOB is 52° to 56°) and d is greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 3B is derived from 200 reflection of the cubic structure. This diffraction spot is sometimes observed at a position where the difference in orientation of reflection derived from the 11-1 reflection of the cubic structure (A in FIG. 3B) is greater than or equal to 54° and less than or equal to 56° (i.e., ∠AOB is greater than or equal to 54° and less than or equal to 56°). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin using a focused ion beam (FIB) or the like such that an electron beam of a TEM, for example, enters in [12-10], in order to easily observe the (0003) plane in careful observation of the shape of the positive electrode active material with a scanning electron microscope (SEM) or the like. To determine alignment of crystal orientations, a sample is preferably processed to be thin so that the (0003) plane of the layered rock-salt crystal structure is easily observed.

<<x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

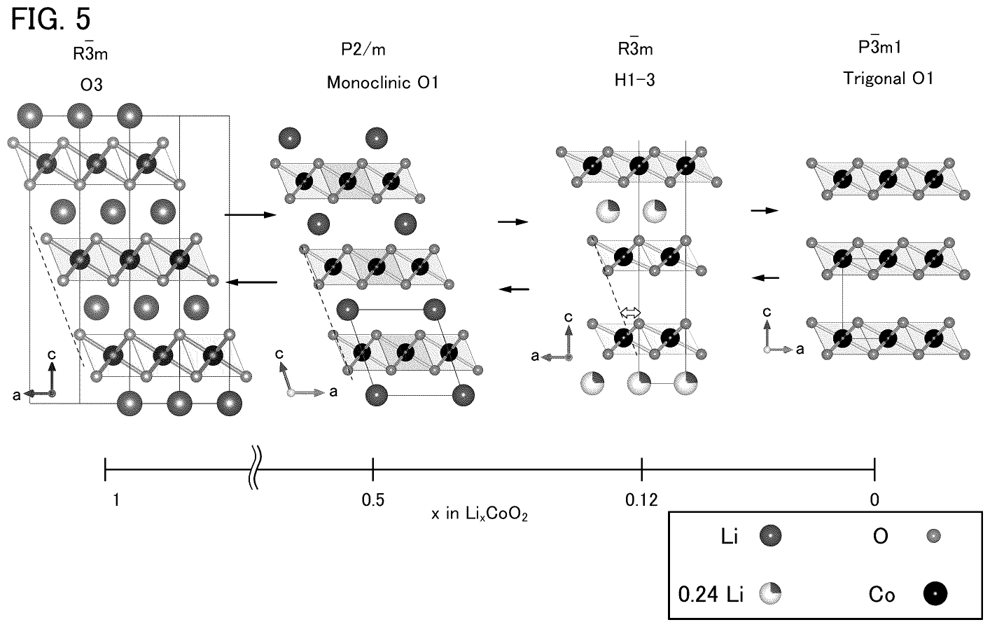

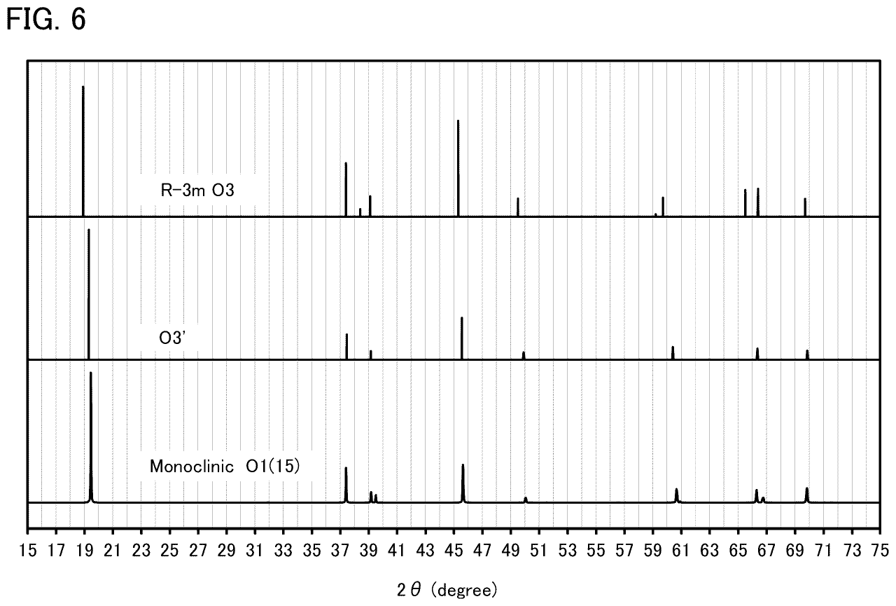

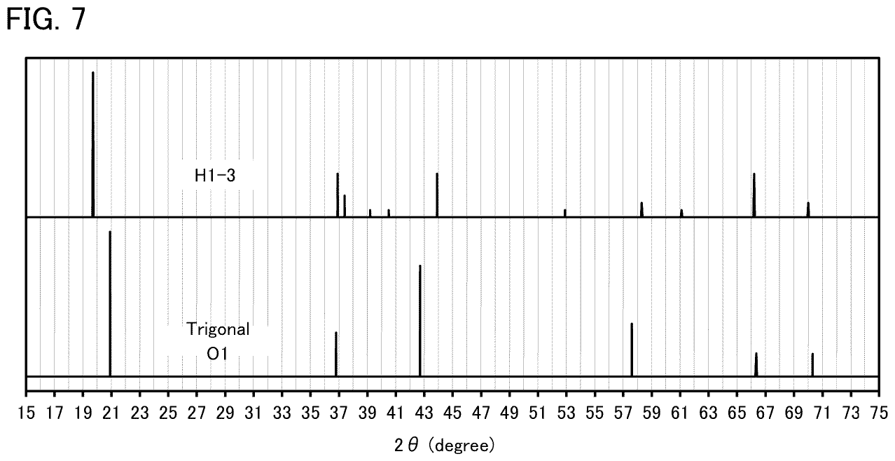

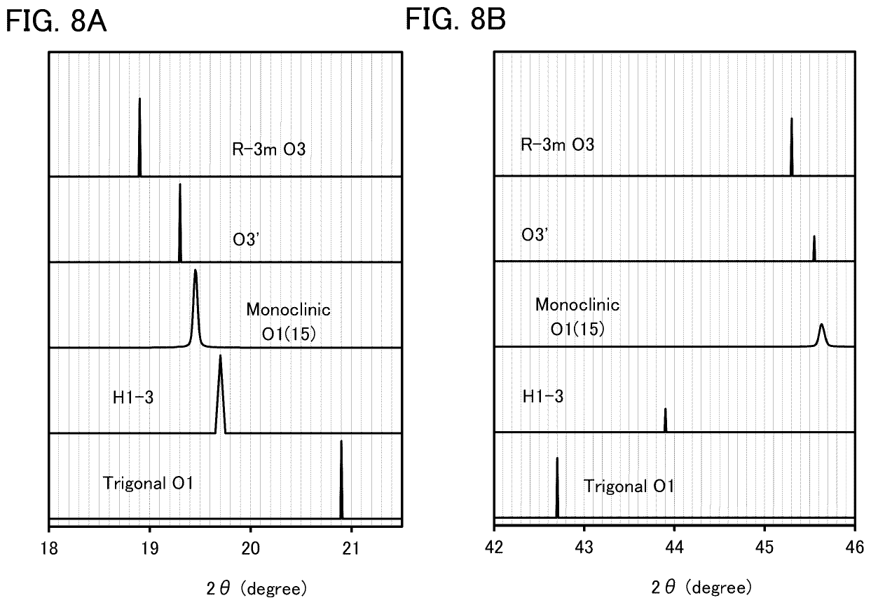

A conventional positive electrode active material and the positive electrode active material 100 of one embodiment of the present invention are compared, and changes in the crystal structures owing to a change in x in LiₓCoO₂ will be described with reference to FIG. 4, FIG. 5, FIG. 6, FIG. 7, and FIGS. 8A and 8B.

A change in the crystal structure of the conventional positive electrode active material is shown in FIG. 5. The conventional positive electrode active material shown in FIG. 5 is lithium cobalt oxide (LiCoO₂) containing no additive element. A change in the crystal structure of lithium cobalt oxide containing no additive element is described in Non-Patent Documents 1 to 4 and the like.

In FIG. 5, the crystal structure of lithium cobalt oxide with x in LiₓCoO₂ being 1 is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that since insertion and extraction of lithium do not necessarily uniformly occur in the positive electrode active material in reality, the lithium concentrations can vary in the positive electrode active material. Thus, the H1-3 type structure is started to be observed when x is approximately 0.25 in practice. The number of cobalt atoms per unit cell in the actual H1-3 type structure is twice that in other structures. However, in this specification including FIG. 5, the c-axis of the H1-3 type structure is half that of the unit cell for easy comparison with the other crystal structures.

For the H1-3 type structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charge that makes x in LiₓCoO₂ be 0.24 or less and discharge are repeated, the crystal structure of conventional lithium cobalt oxide repeatedly changes between the H1-3 type structure and the R-3m O3 type structure in a discharged state (i.e., an unbalanced phase change).

However, there is a large shift in the CoO₂ layers between these two crystal structures. As denoted by the dotted lines and the arrows in FIG. 5, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. The percentage of volume change between the H1-3 type structure and the R-3m O3 type structure in a discharged state that contain the same number of cobalt atoms is greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites which lithium can occupy stably and makes it difficult to insert and extract lithium.

Meanwhile, in the positive electrode active material 100 of one embodiment of the present invention shown in FIG. 4, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and obtain excellent cycle performance. In addition, the positive electrode active material 100 of one embodiment of the present invention with x in LiₓCoO₂ of 0.24 or less can have a more stable crystal structure than a conventional positive electrode active material. Thus, in the positive electrode active material 100 of one embodiment of the present invention, a short circuit is less likely to occur in a state where x in LiₓCoO₂ is kept at 0.24 or less. This is preferable because the safety of a secondary battery is further improved.

FIG. 4 shows crystal structures of the inner portion 100b of the positive electrode active material 100 in a state where x in LiₓCoO₂ is 1, approximately 0.2, and approximately 0.15. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x of 1 has the R-3m O3 type structure, which is the same as that of conventional lithium cobalt oxide.

However, in a state where x is 0.24 or less, e.g., approximately 0.2 or approximately 0.15, the positive electrode active material 100 has a crystal structure different from the H1-3 type structure of conventional lithium cobalt oxide.

The positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 4, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically, c=13.781 (Å).

When x is approximately 0.15, the positive electrode active material 100 of one embodiment of the present invention has a monoclinic crystal structure belonging to the space group P2/m. In this structure, a unit cell includes one CoO₂ layer. Here, lithium in the positive electrode active material 100 is approximately 15 atomic % of that in a discharged state. Thus, this crystal structure is referred to as a monoclinic O1(15) type structure. In FIG. 4, this crystal structure is denoted by P2/m monoclinic O1(15).

In the unit cell of the monoclinic O1(15) type structure, the coordinates of cobalt and oxygen can be represented by Co1 (0.5, 0, 0.5), Co2 (0, 0.5, 0.5), O1 (X_{O1}, 0, Z_{O1}) within the range of 0.23≤X_{O1}≤0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants a=4.880±0.05 (Å), b=2.817±0.05 (Å), c=4.839±0.05 (Å), α=90°, β=109.6±0.1°, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants a=2.817±0.02 (Å) and c=13.68±0.1 (Å).

In both the O3′ type structure and the monoclinic O1(15) type structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 4, the CoO₂ layers hardly shift between the R-3m O3 structure in a discharged state, the O3′ type structure, and the monoclinic O1(15) type structure.

The percentage of volume change between the R-3m O3 type structure in a discharged state and the O3′ type structure that contain the same number of cobalt atoms is 2.5% or less, specifically 2.2% or less, typically 1.8%.

The percentage of volume change between the R-3m O3 type structure in a discharged state and the monoclinic O1(15) type structure that contain the same number of cobalt atoms is 3.3% or less, specifically 3.0% or less, typically 2.5%.

Table 1 shows a difference in volume of one cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, the values in the documents (ICSD coll. code. 172909 and 88721) can be referred to. For the lattice constants of the H1-3 type structure, Non-Patent Document 3 can be referred to. The lattice constants of the O3′ type structure and the monoclinic O1(15) type structure can be calculated from the experimental values of XRD.

TABLE 1

| | | | | | | | Volume |
|---|---|---|---|---|---|---|---|
| | | | | | Volume | Volume | change |
| Crystal | Lattice constant | | | | of unit cell | per Co | percentage |
| structure | a (Å) | b (Å) | c (Å) | β (°) | (Å³) | (Å³) | (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic O1(15) | 4.881 | 2.817 | 4.839 | 109.6 | 62.69 | 31.35 | 2.5 |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is reduced. Thus, the crystal structure of the positive electrode active material 100 is less likely to break even when charge that makes x be 0.24 or less and discharge are repeated. Therefore, a decrease in charge and discharge capacity of the positive electrode active material 100 in charge-discharge cycles is reduced. Furthermore, the positive electrode active material 100 can stably use a large amount of lithium than a conventional positive electrode active material and thus has large discharge capacity per weight and per volume. Thus, with the use of the positive electrode active material 100, a secondary battery with large discharge capacity per weight and per volume can be fabricated.

Note that the positive electrode active material 100 actually has the O3′ type structure in some cases when x in LiₓCoO₂ is greater than or equal to 0.15 and less than or equal to 0.24, and is assumed to have the O3′ type structure even when x is greater than 0.24 and less than or equal to 0.27. In addition, the positive electrode active material 100 actually has the monoclinic O1(15) type structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge-discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have the O3′ type structure and/or the monoclinic O1(15) type structure. Not all the particles contained in the inner portion 100b of the positive electrode active material 100 necessarily have the O3′ type structure and/or the monoclinic O1(15) type structure. Some of the particles may have another crystal structure or be amorphous.

In order to make x in LiₓCoO₂ μmall, charge at a high charge voltage is necessary in general. Therefore, the state where x in LiₓCoO₂ is small can be rephrased as a state where charge at a high charge voltage has been performed. For example, when CC/CV charge is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

That is, the positive electrode active material 100 of one embodiment of the present invention is preferable because the R-3m O3 structure having symmetry can be maintained even when charge at a high charge voltage, e.g., 4.6 V or higher is performed at 25° C. Moreover, the positive electrode active material 100 of one embodiment of the present invention is preferable because the O3′ type structure can be obtained when charge at a higher charge voltage, e.g., a voltage higher than or equal to 4.65 V and lower than or equal to 4.7 V is performed at 25° C. Furthermore, the positive electrode active material 100 of one embodiment of the present invention is preferable because the monoclinic O1(15) type structure can be obtained when charge at a much higher charge voltage, e.g., a voltage higher than 4.7 V and lower than or equal to 4.8 V is performed at 25° C.

At a far higher charge voltage, the H1-3 type structure is eventually observed in the positive electrode active material 100 in some cases. As described above, the crystal structure is influenced by the number of charge-discharge cycles, a charge current and a discharge current, temperature, an electrolyte, and the like, so that the positive electrode active material 100 of one embodiment of the present invention may sometimes have the O3′ type structure even at a lower charge voltage, e.g., a charge voltage of higher than or equal to 4.5 V and lower than 4.6 V at 25° C. Similarly, the positive electrode active material 100 may sometimes have the monoclinic O1(15) type structure at a charge voltage of higher than or equal to 4.65 V and lower than or equal to 4.7 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a similar crystal structure is obtained at a voltage corresponding to a difference between the above-described voltage and the potential of the graphite.

Although lithium occupies all lithium sites in the O3′ type structure and the monoclinic O1(15) type structure with an equal probability in the illustration of FIG. 4, the present invention is not limited thereto. Lithium may exist unevenly in only some of the lithium sites. For example, lithium may be symmetrically present as in the monoclinic O1 type structure (Li_{0.5}CoO₂) in FIG. 4. Distribution of lithium can be analyzed by neutron diffraction, for example.

Each of the O3′ type structure and the monoclinic O1(15) type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution refers to a state where the concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary 101 and the vicinity thereof in the positive electrode active material 100 is preferably higher than that in a region other than the crystal grain boundary 101 and the vicinity thereof in the inner portion 100b. In addition, the fluorine concentration at the crystal grain boundary 101 and the vicinity thereof is preferably higher than that in a region other than the crystal grain boundary 101 and the vicinity thereof in the inner portion 100b. In addition, the nickel concentration at the crystal grain boundary 101 and the vicinity thereof is preferably higher than that in a region other than the crystal grain boundary 101 and the vicinity thereof in the inner portion 100b. In addition, the aluminum concentration at the crystal grain boundary 101 and the vicinity thereof is preferably higher than that in a region other than the crystal grain boundary 101 and the vicinity thereof in the inner portion 100b.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof is, the more effectively the change in the crystal structure can be reduced.

In the case where the magnesium concentration and the fluorine concentration are high at the crystal grain boundary 101 and the vicinity thereof, the magnesium concentration and the fluorine concentration in the vicinity of a surface generated by a crack are also high even if the crack is generated along the crystal grain boundary 101 of the positive electrode active material 100 of one embodiment of the present invention. Thus, the positive electrode active material including a crack can also have an increased corrosion resistance to hydrofluoric acid. In addition, the positive electrode active material including a crack can suppress a side reaction between the electrolyte solution and the positive electrode active material.

### <Particle Diameter>

When the particle diameter of the positive electrode active material 100 of one embodiment of the present invention is too large, the following problems may arise: the material is easily broken at a C-plane by being pressurized or the like in a fabrication process of a positive electrode, the surface of the active material layer becomes too rough, and lithium is difficult to diffuse when the positive electrode active material is used in a secondary battery. By contrast, too small a particle diameter causes problems such as an overreaction with the electrolyte solution. Therefore, the median diameter (D50) is preferably greater than or equal to 1 μm and less than or equal to 30 μm, further preferably greater than or equal to 3 μm and less than or equal to 10 μm, still further preferably greater than or equal to 8 μm and less than or equal to 9 μm. Alternatively, it is preferably greater than or equal to 1 μm and less than or equal to 10 μm. Alternatively, it is preferably greater than or equal to 1 μm and less than or equal to 9 μm. Alternatively, it is preferably greater than or equal to 3 μm and less than or equal to 30 μm. Alternatively, it is preferably greater than or equal to 3 μm and less than or equal to 9 μm. Alternatively, it is preferably greater than or equal to 8 μm and less than or equal to 30 μm. Alternatively, it is preferably greater than or equal to 8 μm and less than or equal to 10 μm.

A positive electrode is preferably formed using a mixture of particles having different particle diameters to have an increased electrode density and enable a high energy density of a secondary battery. The positive electrode active material 100 with a relatively small particle diameter is expected to enable favorable charge-discharge rate characteristics. A secondary battery that includes the positive electrode active material 100 having a relatively large particle diameter is expected to have high charge-discharge cycles performance and maintain high discharge capacity.

### <Smooth Surface>

Preferably, the surface of the positive electrode active material 100 including the single particle in FIG. 1A is smooth and has less unevenness. Having a smooth surface refers to a state where the positive electrode active material 100 has less unevenness, is rounded as a whole and its corner portion is rounded. A smooth surface refers to a surface to which few foreign substances are attached. Foreign substances are deemed to cause unevenness and are preferably not attached to a surface.

The surfaces of the positive electrode active materials 100 are smooth and slippery; thus, the positive electrode active materials are not easily broken by being under pressure in the fabrication process of the positive electrode and it is possible that the high density of the positive electrode can be easily achieved.

### <Analysis Method>

Whether or not a positive electrode active material is the positive electrode active material 100 of one embodiment of the present invention, which has the O3′ type structure and/or the monoclinic O1(15) type structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. The peaks appearing in the powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the influence of orientation due to pressure or the like is preferably removed. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material 50% or more of which has the crystal structure to be largely changed by high-voltage charge is not preferable because the material cannot withstand repetition of high-voltage charge and discharge.

It should be noted that the O3′ type structure or the monoclinic O1(15) type structure is not obtained in some cases only by addition of the additive element. For example, in a state with x in LiₓCoO₂ of 0.24 or less, lithium cobalt oxide containing magnesium and fluorine or lithium cobalt oxide containing magnesium and aluminum has the O3′ type structure and/or the monoclinic O1(15) type structure at 60% or more in some cases, and has the H1-3 type structure at 50% or more in other cases, depending on the concentration and distribution of the additive element.

In addition, in a state where x in LiₓCoO₂ is too small, e.g., 0.1 or less, or charge voltage is higher than 4.9 V, the positive electrode active material 100 of the present invention might have the H1-3 structure or the trigonal O1 structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed when the positive electrode active material is exposed to the air. For example, the O3′ type structure and the monoclinic O1(15) type structure change into the H1-3 type structure in some cases. For that reason, all samples to be used for analysis of the crystal structure are preferably handled in an inert atmosphere such as an argon atmosphere.

Whether the additive element contained in a positive electrode active material has the above-described distribution can be determined by analysis using XPS, EDX, electron probe microanalysis (EPMA), or the like.

The crystal structure of the surface portion 100a, the crystal grain boundary 101, or the like can be analyzed by electron diffraction of a cross section of the positive electrode active material 100, for example.

### <<Charge Method>>

Charge for determining whether or not a composite oxide is the positive electrode active material 100 of one embodiment of the present invention can be performed on a CR2032 coin cell (with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at a volume ratio of 3:7 and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is charged to a freely selected voltage (e.g., 4.5 V, 4.55 V, 4.6 V, 4.65 V, 4.7 V, 4.75 V, or 4.8 V). The charge conditions are not particularly limited as long as charge to a freely selected voltage can be performed for sufficient time. In the case of CCCV charge, for example, CC charge can be performed with a current higher than or equal to 20 mA/g and lower than or equal to 100 mA/g, and CV charge can be ended with a current higher than or equal to 2 mA/g and lower than or equal to 10 mA/g. To observe a phase change of the positive electrode active material, charge with such a small current value is preferably performed. Meanwhile, in the case where a current does not reach higher than or equal to 2 mA/g and lower than or equal to 10 mA/g even when CV charge is performed for a long time, the CV charge may be ended after the sufficient time passes from the start because the current is probably consumed not for charging the positive electrode active material but for decomposing the electrolyte solution. The sufficient time in this case can be longer than or equal to 1.5 hours and shorter than or equal to 3 hours. The temperature is set to 25° C. or 45° C. After the charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere for various analyses to be performed later. For example, XRD can be performed on the positive electrode active material enclosed in an airtight container with an argon atmosphere. After the charge is completed, the positive electrode is preferably taken out immediately and analyzed. Specifically, the positive electrode is preferably analyzed within 1 hour after the completion of the charge, further preferably 30 minutes after the completion of the charge.

In the case where the crystal structure in a charged state after multiple charge-discharge cycles is analyzed, the conditions of the multiple charge-discharge cycles may be different from the above-described charge conditions. For example, the charge can be performed in the following manner: constant current charge to a freely selected voltage (e.g., 4.6 V, 4.65 V, 4.7 V, 4.75 V, or 4.8 V) at a current value of higher than or equal to 20 mA/g and lower than or equal to 100 mA/g is performed and then, constant voltage charge is performed until the current value becomes higher than or equal to 2 mA/g and lower than or equal to 10 mA/g. As the discharge, constant current discharge can be performed at higher than or equal to 20 mA/g and lower than or equal to 100 mA/g until the discharge voltage reaches 2.5 V.

Also in the case where the crystal structure in a discharged state after the multiple charge-discharge cycles is analyzed, constant current discharge can be performed at a current value of higher than or equal to 20 mA/g and lower than or equal to 100 mA/g until the discharge voltage reaches 2.5 V, for example.

### <<XRD>>

The apparatus and conditions adopted in the XRD measurement are not particularly limited. The measurement can be performed with the apparatus and conditions as described below, for example.
XRD apparatus: D8 ADVANCE produced by Bruker AXS
X-ray source: Cu radiation
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: one second/step
Rotation of sample stage: 15 rpm
From the obtained XRD patterns, the background and CuKα₂ radiation peak can be removed using analysis software, DIFFRAC. EVA.

In the case where the measurement sample is a powder, the sample can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the heights of the positive electrode active material layer and the measurement plane required by the apparatus are aligned.

FIG. 6, FIG. 7, and FIGS. 8A and 8B show ideal powder XRD patterns with CuKα₁ radiation that are calculated from models of the O3′ type structure, the monoclinic O1(15) type structure, and the H1-3 type structure. For comparison, ideal XRD patterns calculated from the crystal structure of LiCoO₂ (O3) with x in LiₓCoO₂ of 1 and the trigonal O1 type structure with x of 0 are also shown. FIGS. 8A and 8B each show both the XRD pattern of the O3′ type structure, that of the monoclinic O1(15) type structure, and that of the H1-3 type structure; FIG. 8A is an enlarged view showing a range of 26 of greater than or equal to 18° and less than or equal to 21° and FIG. 8B is an enlarged view showing a range of 26 of greater than or equal to 42° and less than or equal to 46°. Note that the patterns of LiCoO₂ (O3) and CoO₂ (O1) are made on the basis of crystal structure data obtained from the Inorganic Crystal Structure Database (ICSD) (see Non-Patent Document 5) with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. The pattern of the H1-3 type structure is similarly made on the basis of the crystal structure data disclosed in Non-Patent Document 3. The O3′ type structure and the monoclinic O1(15) type structure are estimated from the XRD pattern of the positive electrode active material of one embodiment of the present invention, the crystal structures are fitted with TOPAS ver. 3 (crystal structure analysis software produced by Bruker Corporation), and the XRD patterns of the O3′ type structure and the monoclinic O1(15) type structure are made in a similar manner to other structures.

As shown in FIG. 6 and FIGS. 8A and 8B, the O3′ type structure exhibits diffraction peaks at 2θ of 19.25±0.12° (greater than or equal to 19.13° and less than 19.37°) and 2θ of 45.4710.10° (greater than or equal to 45.37° and less than 45.57°).

The monoclinic O1(15) type structure exhibits diffraction peaks at 2θ of 19.4710.10° (greater than or equal to 19.37° and less than or equal to 19.57°) and 2θ of 45.6210.05° (greater than or equal to 45.57° and less than or equal to 45.67°).

However, as shown in FIG. 7 and FIGS. 8A and 8B, the H1-3 type structure and the trigonal O1 type structure do not exhibit peaks at these positions. Thus, exhibiting the peak at 2θ of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 of one embodiment of the present invention.

It can be said that, in the positive electrode active material 100 of one embodiment of the present invention, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure and/or the monoclinic O1(15) type structure when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1(15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to 50%, preferably greater than or equal to 60%, further preferably greater than or equal to 66% can have sufficiently good cycle performance.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed.

Furthermore, even after 100 or more charge-discharge cycles after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 26 value. In the case of the above-described measurement conditions, the peak observed in the 2θ range of 43° to 46°, both inclusive, preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity greatly contributes to stability of the crystal structure after charging.

The crystallite size of the O3′ type structure and the monoclinic O1(15) type structure of the positive electrode active material 100 is decreased to approximately 1/20 of that of LiCoO₂ (O3) in a discharged state. Thus, the peak of the O3′ type structure and/or the monoclinic O1(15) type structure can be clearly observed when x in LiₓCoO₂ is small even under the same XRD measurement conditions as those of a positive electrode before charging and discharging. By contrast, conventional LiCoO₂ has a small crystallite size and exhibits a broad and small peak although it can partly have a structure similar to the O3′ type structure and/or the monoclinic O1(15) type structure. The crystallite size can be calculated from the half width of the XRD peak.

### <<EDX>>

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB or the like and analyzing the cross section using EDX, EPMA, or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as EDX line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium are present and a region where oxygen and the transition metal Mare absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

In a STEM-EDX line analysis or the like, it is sometimes difficult to precisely determine the surface because a steep change in a profile of an element is not seen in principle or due to a measurement error. Therefore, when the depth direction in a STEM-EDX line analysis or the like is mentioned, a reference point is a point where a value of the amount of the detected transition metal M is equal to 50% of the sum of the average value M_{AVE} of the amount of the detected transition metal M in the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points are different between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal M in the inner portion and the average value M_{BG} of the amount of the background transition metal M can be used. In the case of a positive electrode active material containing a plurality of transition metals M, the reference point can be determined using M_{AVE} and M_{BG} of an element whose count number is the largest in the inner portion 100b.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the count numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image. Alternatively, the surface refers to an intersection of a tangent drawn at a luminance profile from the surface toward the bulk and an axis in the depth direction in a STEM image. The surface in a STEM image or the like may be determined by using additionally an analysis with higher spatial resolution.

The spatial resolution of STEM-EDX is approximately 1 nm. Thus, the maximum value of an additive element profile may be shifted by approximately 1 nm. For example, even when the maximum value of the profile of an additive element such as magnesium is outside the surface determined in the above-described manner, it can be said that a difference between the maximum value and the surface is within the margin of error as long as the difference is less than 1 nm.

A peak in STEM-EDX line analysis refers to the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used as the profile of each element. The number of scanning is not limited to six and an average of measured values obtained by performing scanning seven or more times can be used as the profile of each element.

STEM-EDX line analysis can be performed as follows. First, a protective film is deposited over a surface of a positive electrode active material. For example, carbon can be deposited with an ion sputter apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a micro probing system (MPS), and an accelerating voltage at final processing can be, for example, 10 kV.

The STEM-EDX line analysis can be performed using HD-2700 produced by Hitachi High-Tech Corporation as a STEM apparatus and Octane T Ultra W (with two detectors) produced by EDAX Inc as EDX detectors. In the EDX line analysis, the emission current of the STEM apparatus is set to be in the range of 6 μA to 10 μA, both inclusive, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is 6 or more.

EDX area analysis or EDX point analysis of the positive electrode active material 100 of one embodiment of the present invention reveals that the concentration of each additive element, in particular, the additive element Xin the surface portion 100a is preferably higher than that in the inner portion 100b.

For example, EDX area analysis or EDX point analysis of the positive electrode active material 100 containing magnesium as the additive element reveals that the magnesium concentration in the surface portion 100a is preferably higher than that in the inner portion 100b. In the EDX line analysis, a peak of the magnesium concentration in the surface portion 100a is preferably observed in a region ranging, toward the center of the positive electrode active material 100, from the surface thereof or a reference point to a depth of 3 nm, further preferably a depth of 1 nm, still further preferably a depth of 0.5 nm. In addition, the magnesium concentration preferably attenuates, at a depth of 1 nm from the point where the concentration reaches the peak, to less than or equal to 60% of the peak concentration. The magnesium concentration preferably attenuates, at a depth of 2 nm from the point where the concentration reaches the peak, to less than or equal to 30% of the peak concentration. Here, a “peak of concentration” refers to the local maximum value of concentration.

In the EDX line analysis, the magnesium concentration (the detected amount of magnesium/the sum of the detected amounts of magnesium, oxygen, cobalt, fluorine, aluminum, and silicon) in the surface portion 100a is preferably higher than or equal to 0.5 atom % and lower than or equal to 10 atom %, further preferably higher than or equal to 1 atom % and lower than or equal to 5 atom %.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a is preferably observed in a region ranging from the surface of the positive electrode active material 100 to a depth of 3 nm, further preferably a depth of 1 nm, still further preferably a depth of 0.5 nm toward the center of the positive electrode active material 100 or a reference point. It is further preferable that a peak of the fluorine concentration be exhibited slightly closer to the surface side than a peak of the magnesium concentration is, which increases resistance to hydrofluoric acid. For example, it is preferable that a peak of the fluorine concentration be exhibited slightly closer to the surface side than a peak of the magnesium concentration is by 0.5 nm or more, further preferably 1.5 nm or more.

In the positive electrode active material 100 containing nickel as the additive element, a peak of the nickel concentration in the surface portion 100a is preferably observed in a region ranging from the surface of the positive electrode active material 100 or a reference point to a depth of 3 nm, further preferably a depth of 1 nm, still further preferably a depth of 0.5 nm toward the center of the positive electrode active material 100. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 3 nm, further preferably within 1 nm.

In the case where the positive electrode active material 100 contains aluminum as the additive element, in the EDX line analysis, the peak of the magnesium concentration, the nickel concentration, or the fluorine concentration is preferably closer to the surface than the peak of the aluminum concentration is in the surface portion 100a. For example, the peak of the aluminum concentration is preferably observed in a region ranging from the surface of the positive electrode active material 100 or a reference point to a depth of from 0.5 nm to 50 nm, both inclusive, further preferably a depth of from 5 nm and to 50 nm, both inclusive, toward the center of the positive electrode active material 100.

EDX line, area, or point analysis of the positive electrode active material 100 preferably reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of aluminum to cobalt (Al/Co) at a peak of the aluminum concentration is preferably greater than or equal to 0.05 and less than or equal to 0.6, further preferably greater than or equal to 0.1 and less than or equal to 0.45. The atomic ratio of nickel to cobalt (Ni/Co) at a peak of the nickel concentration is preferably greater than or equal to 0 and less than or equal to 0.2, further preferably greater than or equal to 0.01 and less than or equal to 0.1. The atomic ratio of fluorine to cobalt (F/Co) at a peak of the fluorine concentration is preferably greater than or equal to 0 and less than or equal to 1.6, further preferably greater than or equal to 0.1 and less than or equal to 1.4.

When the positive electrode active material 100 is subjected to line analysis or area analysis, the ratio of the number of atoms of an additive element A to the number of cobalt (Co) atoms (A/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

In the case where the additive element is magnesium, for example, when the positive electrode active material 100 is subjected to line analysis or area analysis, the ratio of the number of magnesium atoms to the number of cobalt atoms (Mg/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<X-Ray Photoelectron Spectroscopy (XPS)>>

In an inorganic oxide, a region ranging from the surface to a depth of approximately 2 nm to 8 nm (normally, less than or equal to 5 nm) can be analyzed by XPS using monochromatic aluminum Kα radiation as an X-ray source; thus, the concentrations of elements in a region of part near the surface portion 100a can be quantitatively analyzed by XPS. The bonding states of the elements can be analyzed by narrow scanning. The quantitative accuracy of XPS is about ±1 atomic % in many cases.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive element(s) in the entire positive electrode active material 100, which is measured by ICP-MS, GD-MS, or the like. For example, the concentration of magnesium of at least part of the surface portion 100a, which is measured by XPS or the like, is preferably higher than the average concentration of magnesium of the entire positive electrode active material 100. The concentration of nickel of at least part of the surface portion 100a is preferably higher than the average concentration of nickel of the entire positive electrode active material 100. The concentration of aluminum of at least part of the surface portion 100a is preferably higher than the average concentration of aluminum of the entire positive electrode active material 100. The concentration of fluorine of at least part of the surface portion 100a is preferably higher than the average concentration of fluorine of the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt enables comparison while reducing the influence of a carbonate or the like which is chemically adsorbed after formation of the positive electrode active material. When XPS analysis is performed, the number of magnesium atoms is preferably 0.4 times or more and 1.2 times or less, further preferably 0.65 times or more and 1.0 times or less the number of cobalt atoms. The number of nickel atoms is preferably less than or equal to 0.15 times, further preferably greater than or equal to 0.03 times and less than or equal to 0.13 times the number of cobalt atoms. The number of fluorine atoms is preferably 0.3 times or more and 0.9 times or less, further preferably 0.1 times or more and 1.1 times or less the number of cobalt atoms. When the ratio is within the above range, it can be said that the additive element is not attached to the surface of the positive electrode active material 100 in a narrow range but widely distributed at a preferable concentration in the surface portion 100a of the positive electrode active material 100.

It is further preferable that aluminum be preferably widely distributed in a region ranging from the surface or the reference point to a depth of from 5 nm to 50 nm, both inclusive, for example. Therefore, aluminum is detected by analysis on the entire positive electrode active material 100 by ICP-MS, GD-MS, or the like, but the concentration of aluminum is preferably lower than 1 atomic % in the surface analysis such as XPS. For example, in the surface analysis such as XPS, the number of aluminum atoms is preferably less than or equal to 0.12 times, further preferably less than or equal to 0.09 times the number of cobalt atoms.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentrations of cobalt and lithium in at least part of the surface portion 100a, which are measured by XPS or the like, are preferably higher than those of magnesium, nickel, aluminum, and fluorine in at least part of the surface portion 100a, which are measured by XPS or the like.

In the XPS analysis, monochromatic aluminum Kα radiation can be used as an X-ray source, for example. An extraction angle is, for example, 45°. For example, the measurement can be performed using the following apparatus and conditions.
Measurement device: PHI Quantera II
X-ray source: monochromatic Al Kα (1486.6 eV)
Detection area: 100 μmϕ
Detection depth: approximately 4 nm to 5 nm (extraction angle 45°)
Measurement spectrum: wide scan, narrow scan of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV).

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that is present at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with a several square micrometers and a depth of approximately 1 μm of a surface portion, a Co—O bond that exists only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel crystal structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that an appropriate range of the surface portion 100a of the positive electrode active material 100 has a rock-salt crystal structure.

This embodiment can be implemented in combination with any of the other embodiments.

### Embodiment 2

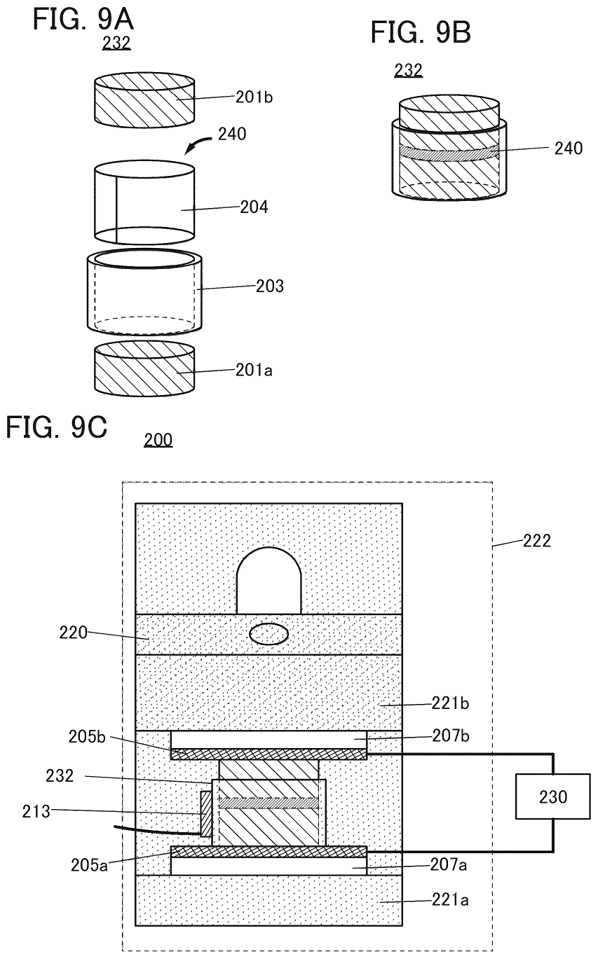

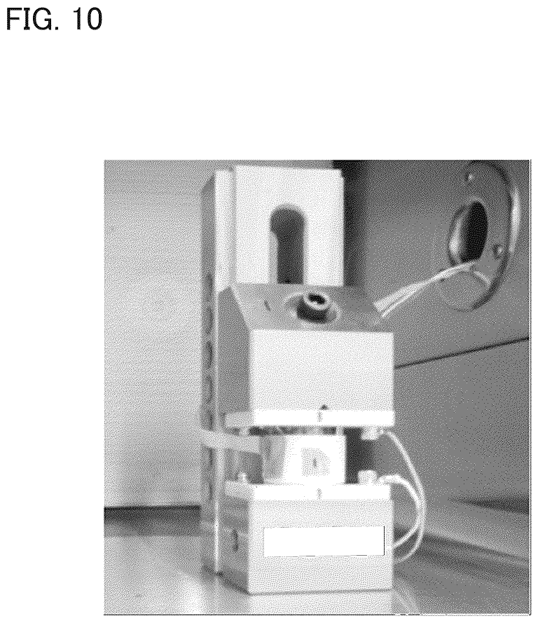

In this embodiment, a measurement apparatus and a measurement method of powder volume resistivity are described with reference to FIGS. 9A to 9C and FIG. 10.

A sample holder 232 illustrated in FIG. 9A includes terminals 201a and 201b and a cylinder 203. In addition to these, the sample holder 232 preferably further includes a cover 204 inside the cylinder 203. As illustrated in FIG. 9B, a measurement sample 240 can be placed between the terminals 201a and 201b in the sample holder 232 and be measured.

A measurement apparatus 200 of powder volume resistivity illustrated in FIG. 9C includes conductive plates 205a and 205b, insulating plates 207a and 207b, a temperature sensor 213, a resistance meter 230, and a vise 220. The insulating plate 207a and the conductive plate 205a are attached to a jaw 221a included in the vise 220, and the insulating plate 207b and the conductive plate 205b are attached to a jaw 221b included in the vise 220. The conductive plate 205a and the conductive plate 205b are electrically connected to the resistance meter 230. The sample holder 232 is interposed between the conductive plates 205a and 205b and the vise 220 is closed, and electric resistance can be measured by the resistance meter 230 with the measurement sample 240 being under pressure.

In the measurement apparatus 200, the vise 220 and parts sandwiched between the jaws 221a and 221b in the vise 220 are placed in a thermostatic oven 222 and electric resistance can be measured at an arbitrary temperature. By attaching the temperature sensor 213 to the sample holder 232, the measurement temperature (also referred to as a logger temperature) can be obtained. Although the temperature sensor 213 is attached to the outside of the cylinder 203 in FIG. 9C, one embodiment of the present invention is not limited thereto. For example, the temperature sensor 213 may be embedded in the terminal 201a and/or the terminal 201b. Alternatively, a hole may be opened in the cylinder 203 and the temperature sensor 213 may be inserted through the hole. The temperature sensor 213 is attached so as to be closer to the measurement sample 240, so that a more accurate measurement temperature can be obtained.

The terminals 201a and 201b preferably each have a flat top surface and a flat bottom surface so that a pressure can be applied uniformly to the measurement sample 240. Furthermore, preferably, the terminals 201a and 201b have strength high enough to withstand the pressure applied by the vise 220, have high conductivity and are chemically stable at high temperature (e.g., approximately 200° C.). In addition, preferably, the terminals 201a and 201b have a small thermal expansion coefficient and have a small difference in thermal expansion coefficient from the cylinder 203. For example, a cylindrical column made of an alloy with a low coefficient of heat expansion, a gold-plated cylindrical column made of an alloy with a low coefficient of heat expansion, a cylindrical column made of stainless steel, a gold-plated cylindrical column made of stainless steel, or the like can be used. In this embodiment, cylindrical columns made of stainless steel are used.

Preferably, the cylinder 203 has strength high enough to withstand the pressure applied by the vise 220, has a high insulating property, and is chemically stable at high temperature. Preferably, the cylinder 203 has a small thermal expansion coefficient and a small difference in thermal expansion coefficient from the terminals 201a and 201b. For example, a cylinder made of quartz glass, a cylinder made of alumina, or the like can be used. In this embodiment, a cylinder made of alumina is used.

The cover 204 has a function of inhibiting the terminals 201a and 201b and the cylinder 203 from being worn out and inhibiting the measurement sample 240 from being scattered and lost. The cover 204 preferably has a high insulating property and is chemically stable at high temperature. In this embodiment, a polyimide film is used.

Preferably, the conductive plates 205a and 205b have strength high enough to withstand the pressure applied by the vise 220, have high conductivity, and are chemically stable at high temperature. For example, a stainless steel plate, a gold-plated stainless steel plate, a gold-plated copper plate, or the like can be used. In this embodiment, a stainless steel plate is used.

Preferably, the insulating plates 207a and 207b have strength high enough to withstand the pressure applied by the vise 220, have a high insulating property, and have a high thermal insulation property.

The vise 220 has a function of applying pressure to the sample holder 232. The vise 220 further preferably has a function of measuring the pressure. In this embodiment, a precision vise is used and a torque wrench is used to close the vise.

As the resistance meter 230, an appropriate meter may be used so as to measure electric resistance of the measurement sample 240. In this embodiment, DMM6500 (produced by Keithley Instruments) is used.

FIG. 10 is a photograph showing a state where the vise 220 and parts sandwiched between the jaws 221a and 221b in the vise 220 are placed in the thermostatic oven 222 of the measurement apparatus 200.

This embodiment can be implemented in combination with any of the other embodiments.

### Embodiment 3

In this embodiment, an example of a method for forming the positive electrode active material 100 which is one embodiment of the present invention is described.

A way of adding an additive element is important in forming the positive electrode active material 100 having the distribution of the additive element, the composition, and/or the crystal structure that were/was described in the above embodiment. Favorable crystallinity of the inner portion 100b is also important.

Thus, in the formation process of the positive electrode active material 100, preferably, lithium cobalt oxide is synthesized first, then an additive element source is mixed, and heat treatment is performed.

In a method of synthesizing lithium cobalt oxide containing an additive element by mixing an additive element source concurrently with a cobalt source and a lithium source, it is sometimes difficult to increase the concentration of the additive element in the surface portion 100a. In addition, after lithium cobalt oxide is synthesized, only mixing an additive element source without performing heating causes the additive element to be just attached to, not dissolved in, the lithium cobalt oxide. It is difficult to distribute the additive element favorably without sufficient heating. Therefore, it is preferable that lithium cobalt oxide be synthesized, and then an additive element source be mixed and heat treatment be performed. The heat treatment after mixing of the additive element source may be referred to as annealing.

However, annealing at an excessively high temperature may cause cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. Lowering the melting points makes it easier to distribute the additive element favorably at a temperature at which cation mixing is less likely to occur.

### [Initial Heating]

It is further preferable that heat treatment be performed between the synthesis of the lithium cobalt oxide and the mixing of the additive element. This heating is referred to as initial heating in some cases.

Since lithium is extracted from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is easy to diffuse into the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, Me-O distance is 2.09 Å and 2.11 Å in Ni_{0.5}Mg_{0.5}O having a rock-salt crystal structure and MgO having a rock-salt crystal structure, respectively. Even when a spinel phase is formed in part of the surface portion 100a, Me-O distance is 2.0125 Å and 2.02 Å in NiAl₂O₄ having a spinel structure and MgAl₂O₄ having a spinel structure, respectively. In each case, Me-O distance is longer than 2 Å. Note that 1 Å (angstrom) is 10⁻¹⁰ m.

Meanwhile, in a layered rock-salt crystal structure, the bond distance between oxygen and a metal other than lithium is shorter than the above-described distance. For example, Al—O distance is 1.905 Å (Li—O distance is 2.11 Å) in LiAlO₂ having a layered rock-salt crystal structure. In addition, Co—O distance is 1.9224 Å (Li—O distance is 2.0916 Å) in LiCoO₂ having a layered rock-salt crystal structure.

According to Shannon's ionic radii (Non-Patent Document 9), the ion radius of hexacoordinated aluminum and the ion radius of hexacoordinated oxygen are 0.535 Å and 1.40 Å, respectively, and the sum of these values is 1.935 Å.

From the above, aluminum is considered to exist at sites other than lithium sites more stably in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface,

Moreover, the initial heating is expected to increase the crystallinity of the layered rock-salt crystal structure of the inner portion 100b.

For this reason, the initial heating is preferably performed in order to form the positive electrode active material 100 that has the monoclinic O1(15) type structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, e.g., annealing, the positive electrode active material 100 that has the O3′ type structure and/or the monoclinic O1(15) type structure when x in LiₓCoO₂ is small can be formed.

### <<Formation Method 1 of Positive Electrode Active Material>>

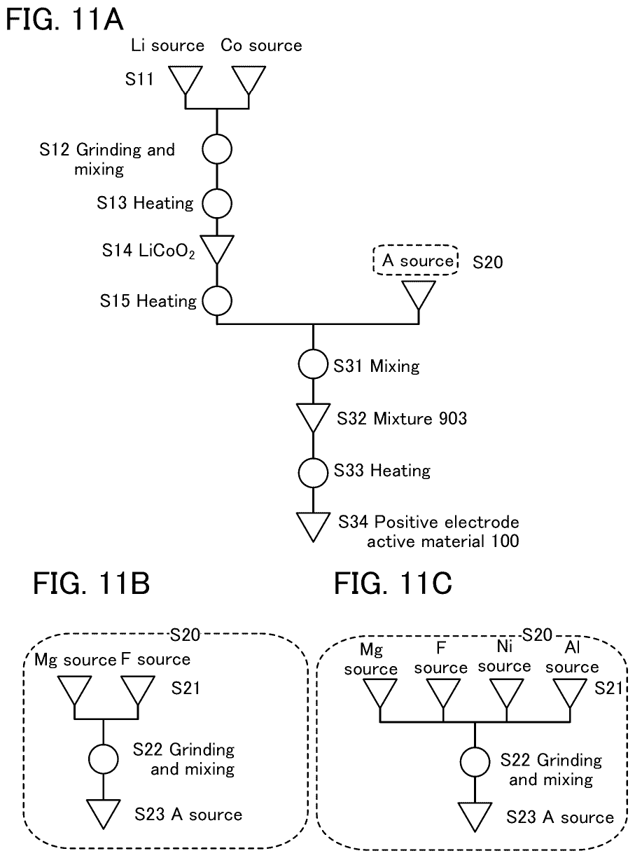

A formation method 1 of the positive electrode active material 100, in which annealing and the initial heating are performed, is described with reference to FIGS. 11A to 11C.

### <Step S11>

In Step S11 shown in FIG. 11A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide, cobalt hydroxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with increased capacity and/or increased reliability can be provided.

Furthermore, the cobalt source preferably has high crystallinity and for example, the cobalt source preferably includes single crystal grains. The crystallinity of the cobalt source can be evaluated with a TEM image, an STEM image, a HAADF-STEM image, or an ABF-STEM image or by XRD, electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 11A, the lithium source and the cobalt source are ground and mixed to form a mixed material. The grinding and mixing can be performed by a dry method or a wet method. A wet method is preferred because it can crush a material into a smaller size. In the case of a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% for the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 11A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flow”.

In the case where the heating atmosphere is an oxygen-containing atmosphere, flow is not necessarily performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool down, and the time for temperature falling to a room temperature from a predetermined temperature is preferably longer than or equal to 10 hours and shorter than or equal to 50 hours. Note that the temperature does not necessarily need to fall to the room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization of a material can be prevented.

A used crucible is preferred to a new crucible. In this specification and the like, anew crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger. Loss of some materials due to such phenomena increases a concern that an element is not distributed in a preferred range particularly in the surface portion of the positive electrode active material. In contrast, such a risk is low in the case of a used crucible.

The heated material is ground as needed and may be made to pass through a sieve. The collection of the heated material may be performed after the material is moved from the crucible to a mortar. As the mortar, an agate mortar or a partially stabilized zirconia mortar is preferably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 11A.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, as Step S15 shown in FIG. 11A, the lithium cobalt oxide is heated. The heating in Step S15 is the first heating performed on the lithium cobalt oxide and thus, this heating is sometimes referred to as the initial heating. Alternatively, the heating is sometimes referred to as preheating or pretreatment because the heating is performed before Step S20 described below.

By the initial heating, lithium is extracted from part of the surface portion 100a of the lithium cobalt oxide as described above. In addition, an effect of increasing the crystallinity of the inner portion 100b can be expected. The lithium source and/or cobalt source prepared in Step S11 and the like might contain impurities. The initial heating can reduce impurities in the lithium cobalt oxide obtained in Step S14.

Furthermore, through the initial heating, the surface of the lithium cobalt oxide becomes smooth. For the initial heating, a lithium source is not needed. Alternatively, an additive element source is not needed. Alternatively, a material functioning as a fusing agent is not needed.

When the heating time in this step is too short, an sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide can be maintained. For example, the heating is preferably performed at a temperature higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the lithium cobalt oxide formed in Step S13.

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. It can also be said that surface improvement is achieved. In other words, it is deemed that Step S15 reduces the differential shrinkage caused in the lithium cobalt oxide to make the surface of the composite oxide smooth.

Such differential shrinkage may cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. It can also be said that crystal grains are aligned. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charge and discharge of the secondary battery is suppressed and cracking of the positive electrode active material can be prevented.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIGS. 11B and 11C.

### <Step S21>

In Step S21 shown in FIG. 11B, an additive element A source (A source) to be added to the lithium cobalt oxide is prepared. A lithium source may be prepared in addition to the additive element A source.

As the additive element A, the additive element described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used also as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 11B, the magnesium source and the fluorine source are ground and mixed. Any of the conditions for the grinding and mixing that are described for Step S12 can be selected to perform Step S22.

### <Step S23>

Next, in Step S23 shown in FIG. 11B, the materials ground and mixed in the above step are collected to give the additive element A source (A source). Note that the additive element A source in Step S23 contains a plurality of starting materials and can be referred to as a mixture.

As for the particle diameter of the mixture, its D50 (median diameter) is preferably greater than or equal to 600 nm and less than or equal to 10 μm, further preferably greater than or equal to 1 μm and less than or equal to 5 μm. Also when one kind of material is used as the additive element source, the D50 (median diameter) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion 100a of the composite oxide after heating.

### <Step S21>

A process different from that in FIG. 11B is described with reference to FIG. 11C. In Step S21 shown in FIG. 11C, four kinds of additive element sources to be added to the lithium cobalt oxide are prepared. In other words, FIG. 11C is different from FIG. 11B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 11B. As the nickel source, nickel oxide, nickel hydroxide, or the like can be used. As the aluminum source, aluminum oxide, aluminum hydroxide, or the like can be used.

### <Steps S22 and S23>

Step S22 and Step S23 shown in FIG. 11C are similar to the steps described with reference to FIG. 11B.

### <Step S31>

Next, in Step S31 shown in FIG. 11A, the lithium cobalt oxide and the additive element A source (A source) are mixed. The ratio of the number of cobalt (Co) atoms in the lithium cobalt oxide to the number of magnesium (Mg) atoms in the additive element A source (Co:Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 11A, the materials mixed in the above step are collected, whereby a mixture 903 is obtained. At the time of the collection, the materials may be crushed and made to pass through a sieve as needed.

Note that although FIGS. 11A to 11C show the formation method in which the addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Steps S11 to S14 and Steps S21 to S23, so that the method is simplified and enables increased productivity.

Alternatively, lithium cobalt oxide that contains some of the additive elements in advance may be used. When lithium cobalt oxide to which magnesium and fluorine are added is used, for example, some steps of Steps S11 to S14 and Step S20 can be skipped, so that the method is simplified and enables increased productivity.

Alternatively, after the heating in Step S15 is performed on lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 shown in FIG. 11A, the mixture 903 is heated. Any of the heating conditions described for Step S13 can be selected. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d}, 0.757 times the melting temperature Tₘ. Accordingly, the heating temperature in Step S33 is desirably higher than or equal to 650° C.

Needless to say, the reaction more easily proceeds at a temperature higher than or equal to the temperature at which one or more of the materials contained in the mixture 903 are melted. For example, in the case where LiF and MgF₂ are used as the additive element sources, the lower limit of the heating temperature in Step S33 is preferably higher than or equal to 742° C. because the eutectic point of LiF and MgF₂ is around 742° C.

The mixture 903 in which LiCoO₂, LiF, and MgF₂ are mixed at the molar ratio of 100:0.33:1 exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 830° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lowered to a temperature below the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and block a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flow of an atmosphere is preferably performed after an atmosphere is purged first and an oxygen atmosphere is introduced into the kiln. Oxygen flow, which might cause evaporation of the fluorine source, is not preferable for maintaining the smoothness of the surface.

In the case of using a roller hearth kiln for the heating, the mixture 903 can be heated in an atmosphere containing LiF with the container in which the mixture 903 is put covered with a lid.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

In the case where the lithium cobalt oxide in Step S14 in FIG. 11A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 11A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

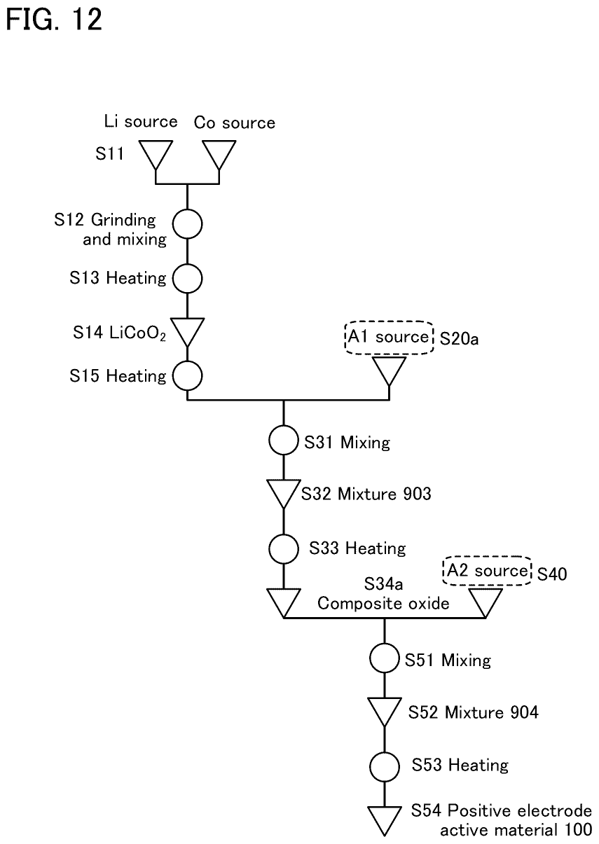

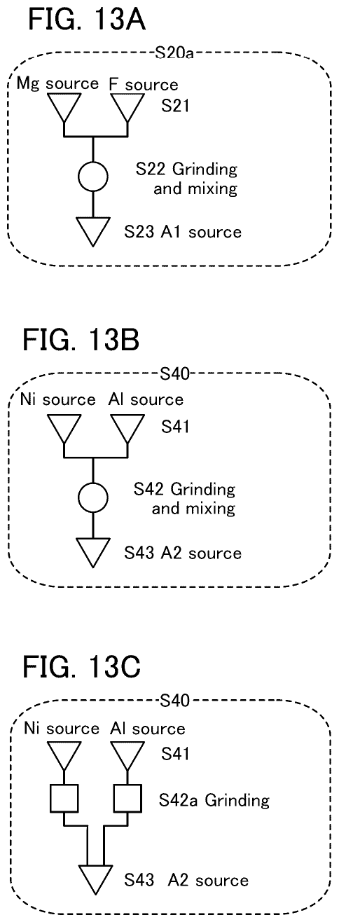

Next, as one embodiment of the present invention, a formation method 2 of a positive electrode active material, which is different from the formation method 1 of a positive electrode active material, is described with reference to FIG. 12 and FIGS. 13A to 13C. The formation method 2 of a positive electrode active material is different from the formation method 1 mainly in the number of times of adding additive elements and a mixing method. For the description except for the above, the description of the formation method 1 of a positive electrode active material can be referred to.

Steps S11 to S15 in FIG. 12 are performed as in FIG. 13A to prepare lithium cobalt oxide that has been subjected to the initial heating.

<Step 20a>

Next, as shown in Step S20a, an additive element A1 is preferably added to the lithium cobalt oxide that has been subjected to the initial heating.

### <Step S21>

In Step S21 shown in FIG. 13A, a first additive element source is prepared. For the first additive element source, any of the elements exemplified as the additive element A in Step S21 with reference to FIG. 11B can be used. For example, one or more elements of magnesium, fluorine, and calcium can be suitably used as the additive element A1. FIG. 13A shows an example of using a magnesium source (Mg source) and a fluorine source (F source) as the first additive element source.

Steps S21 to S23 shown in FIG. 13A can be performed in a manner similar to that of Steps S21 to S23 shown in FIG. 11B. As a result, the additive element source (A1 source) can be obtained in Step S23.

Steps S31 to S33 shown in FIG. 12 can be performed in a manner similar to that of Steps S31 to S33 shown in FIG. 11A.

### <Step S34a>

Next, the material heated in Step S33 is collected to give lithium cobalt oxide containing the additive element A1. This composite oxide is called a second composite oxide to be distinguished from the composite oxide in Step S14.

### <Step S40>

In Step S40 shown in FIG. 12, an additive element A2 is added. The following description is made with reference to FIGS. 13B and 13C.

### <Step S41>

In Step S41 shown in FIG. 13B, the second additive element source is prepared. For the second additive element source, any of the elements exemplified as the additive element A in Step S21 with reference to FIG. 11B can be used. For example, one or more elements of nickel, titanium, boron, zirconium, and aluminum can be suitably used as the additive element A2. FIG. 13B shows an example of using a nickel source (Ni source) and an aluminum source (Al source) as the second additive element source.

Steps S41 to S43 shown in FIG. 13B can be performed in a manner similar to that of Steps S21 to S23 shown in FIG. 11B. As a result, the additive element source (A2 source) can be obtained in Step S43.

FIG. 13C shows a modification example of the steps which are described with reference to FIG. 13B. A nickel source (Ni source) and an aluminum source (Al source) are prepared in Step S41 shown in FIG. 13C and are separately ground in Step S42a. Accordingly, a plurality of second additive element sources (A2 sources) are prepared in Step S43. FIG. 13C is different from FIG. 13B in separately grinding the additive elements in Step S42a.

### <Step S51 to Step S53>

Next, Steps S51 to S53 shown in FIG. 12 can be performed under conditions similar to those of Steps S31 to S34 shown in FIG. 11A. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 12 and FIGS. 13A to 13C, in the formation method 2, introduction of the additive elements to the lithium cobalt oxide is separated into introduction of the additive element A1 and that of the additive element A2. When the additive elements are separately introduced, the additive elements can be at different concentration distributions in the depth direction, for example. The concentration of the additive element A1 can be higher in the surface portion 100a than in the inner portion 100b, and the concentration of the additive element A2 can be higher in the inner portion 100b than in the surface portion 100a, for example.

The initial heating described in this embodiment makes it possible to provide a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. Such an order of steps is preferred in order to maintain the smoothness of the surface achieved by the initial heating.

The positive electrode active material 100 with a smooth surface may be less likely to be physically broken by pressure application or the like than a positive electrode active material without a smooth surface. For example, the positive electrode active material 100 is unlikely to be broken in a test involving pressure application such as a nail penetration test, meaning that the positive electrode active material 100 has high safety.

This embodiment can be implemented in combination with any of the other embodiments.

### Embodiment 4

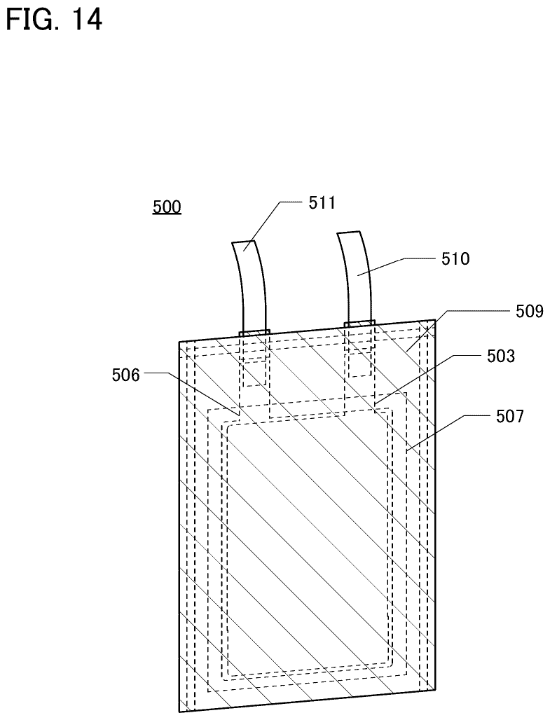

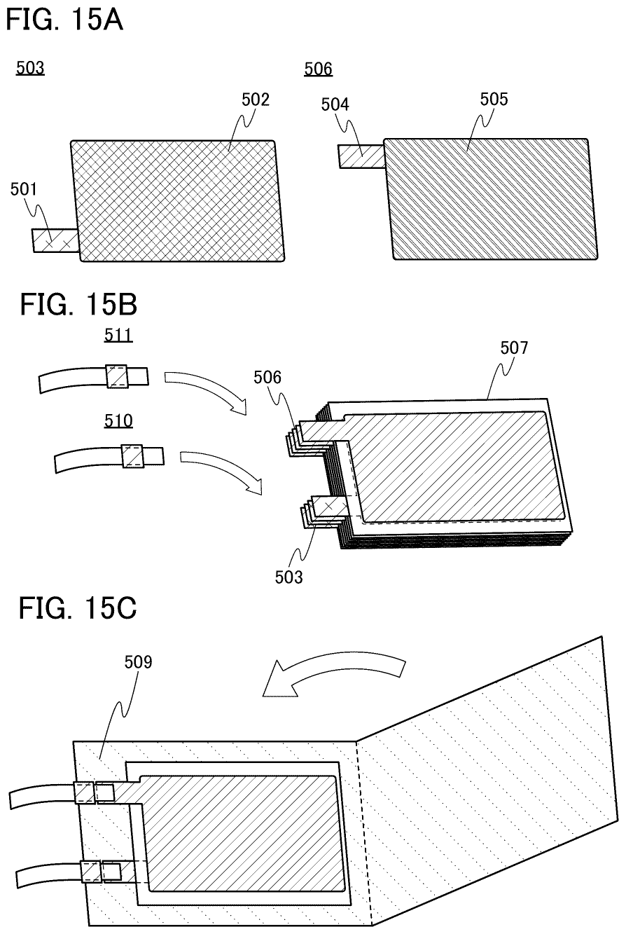

In this embodiment, examples of a secondary battery of one embodiment of the present invention are described with reference to FIG. 14 and FIGS. 15A to 15C.

### <Structure Example of Secondary Battery>

Hereinafter, a secondary battery in which a positive electrode, a negative electrode, and an electrolyte solution are wrapped in an exterior body illustrated in FIG. 14 is described as an example.

### [Positive Electrode]

The positive electrode includes a positive electrode active material layer and a positive electrode current collector. The positive electrode active material layer includes a positive electrode active material, and may include a conductive material (also referred to as a conductive additive) and a binder. As the positive electrode active material, the positive electrode active material formed by the formation method described in the above embodiments is used.

The positive electrode active material described in any of the above embodiments and a different positive electrode active material may be mixed and used.

Other examples of the different positive electrode active material mentioned above include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the different positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the conductive material, a carbon-based material such as acetylene black can be used. In addition, a carbon fiber such as carbon nanotube, graphene, or a graphene compound can be used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound sometimes has excellent electrical characteristics of high conductivity and excellent physical properties of high flexibility and high mechanical strength in some cases. A graphene compound has a sheet-like shape. A graphene compound has a curved surface in some cases, thereby enabling low-resistance surface contact. Furthermore, a graphene compound sometimes has extremely high conductivity even with a small thickness, and thus a small amount of a graphene compound allows a conductive path to be efficiently formed in an active material layer. Hence, the use of the graphene compound as a conductive material can increase the area where the active material and the conductive material are in contact with each other. The graphene compound preferably covers 80% or more of the area of the active material. Note that a graphene compound preferably clings to at least part of an active material particle. A graphene compound preferably overlays at least part of an active material particle. The shape of a graphene compound preferably conforms to at least part of the shape of an active material particle. The shape of an active material particle means, for example, an uneven surface of a single active material particle or an uneven surface formed by a plurality of active material particles. A graphene compound preferably surrounds at least part of an active material particle. A graphene compound may have a hole.

In the case where active material particles with a small diameter (e.g., 1 μm or less) are used, the specific surface area of the active material particles is large and thus more conductive paths for the active material particles are needed. In such a case, it is preferable to use a graphene compound that can efficiently form a conductive path even with a small amount.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charge and discharge are referred to as charge and discharge at, for example, 200 mA/g, 400 mA/g, or 1000 mA/g or more.

A plurality of graphenes or graphene compounds are formed to partly coat or adhere to surfaces of a plurality of particles of a positive electrode active material, so that the plurality of graphenes or graphene compounds preferably make surface contact with the particles of the positive electrode active material.

Here, the plurality of graphenes or graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. Ibis can increase the proportion of the active material in the electrode volume and weight. That is to say, the discharge capacity of the secondary battery can be increased.

A material used in formation of the graphene compound may be mixed with the graphene compound to be used for an active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

### [Current Collector]

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

### [Negative Electrode Active Material]

As a negative electrode active material, for example, an alloy-based material and/or a carbon-based material can be used.

For the negative electrode active material, an element that enables charge and discharge reactions by an alloying reaction and a dealloying reaction with lithium can be used. For example, a material containing one or more of elements such as silicon, tin, gallium, aluminum, germanium, lead, antimony, bismuth, silver, zinc, cadmium, and indium can be used. The elements have higher charge and discharge capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge-discharge reactions by alloying and dealloying reactions with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon-based material, graphite, graphitizing carbon (soft carbon), non-graphitizing carbon (hard carbon), a carbon fiber such as carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. For example, MCMB is preferably used because it may have a spherical shape. Moreover, MCMB is preferably used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of high charge-discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

### [Negative Electrode Current Collector]

For the negative electrode current collector, a material similar to that of the positive electrode current collector can be used. Note that a material that is not alloyed with carrier ions of lithium or the like is preferably used for the negative electrode current collector.

### [Electrolyte Solution]

The electrolyte solution contains the solvent and a lithium salt. As a solvent for the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When ethylene carbonate (EC) and diethyl carbonate (DEC) are contained as the electrolyte solution, it is possible to use a mixed organic solvent in which the volume ratio between EC and DEC is x:100-x (where 20≤x≤40) on the assumption that the total content of EC and DEC is 100 vol %. More specifically, a mixed organic solvent containing EC and DEC in the ratio of 30:70 by volume can be used.

As an organic solvent containing ethylene carbonate (EC), ethyl methyl carbonate (EMC), and dimethyl carbonate (DMC) in the electrolyte solution, it is possible to use a mixed organic solvent in which the volume ratio between EC, EMC, and DMC is x:y:100-x-y (where 5≤x≤35 and 0<y<65) on the assumption that the total content of EC, EMC, and DMC is 100 vol %. More specifically, a mixed organic solvent containing EC, EMC, and DMC in the ratio of 30:35:35 by volume can be used.

As the electrolyte solution, a mixed organic solvent containing a fluorinated cyclic carbonate or a fluorinated linear carbonate can be used. The above mixed organic solvent preferably contains both a fluorinated cyclic carbonate and a fluorinated linear carbonate. A fluorinated cyclic carbonate and a fluorinated linear carbonate are preferred because they each include a substituent with an electron-withdrawing property and thereby lower the solvation energy of a lithium ion. Accordingly, a fluorinated cyclic carbonate and a fluorinated linear carbonate are suitable for the electrolyte solution and a mixed organic solvent containing these carbonates are preferable.

As the fluorinated cyclic carbonate, ethylene fluoride carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low. The substituent with an electron-withdrawing property in FEC is an F group.

An example of the fluorinated linear carbonate is methyl 3,3,3-trifluoropropionate. An abbreviation of methyl 3,3,3-trifluoropropionate is MTFP. The substituent with an electron-withdrawing property in MTFP is a CF₃ group.

FEC, which is a cyclic carbonate, has a high dielectric constant and thus has an effect of promoting dissociation of a lithium salt when used in an organic solvent. Meanwhile, because FEC includes the substituent with an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC is presumed to have a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution.

FEC and MTFP having the above-described physical properties may be mixed in the ratio of x:100-x (where 5≤x≤30, preferably 10≤x≤20) on the assumption that a mixed organic solvent containing FEC and MTFP accounts for 100 vol %. In other words, MTFP and FEC are preferably mixed such that the amount of MTFP is larger than that of FEC in the mixed organic solvent.

Alternatively, the use of one or more ionic liquids (room temperature molten salts) that are unlikely to burn and volatize as the solvent of the electrolyte solution can prevent the secondary battery from exploding and/or igniting even when the internal temperature increases owing to an internal short circuit, overcharging or the like in the secondary battery. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

An electrochemically stable material is preferably used for the electrolyte solution. In particular, the positive electrode active material 100 of one embodiment of the present invention has small deterioration in the crystal structure even through high-voltage charge-discharge, and thus is preferably combined with a chemically stable electrolyte solution at high potentials. For example, an electrolyte solution that does not show a large peak at 5.0 V or lower in a linear sweep voltammetry (LSV) measurement is preferably used. Specifically, a preferred electrolyte solution is an electrolyte solution that can have a current density less than or equal to 1.0 mA·cm⁻² at any voltage of 5.0 V or lower when an LSV measurement is performed on a coin cell at a voltage scanning rate of 1.0 mV·s⁻¹ at a temperature of 25° C. The coin cell includes a working electrode in which a mixture of AB and PVDF with a ratio of 1:1 is applied to aluminum foil coated with carbon (the size is 12 mmϕ; 1130 cm²), a counter electrode formed using lithium metal, and a polypropylene separator.

Examples of the electrolyte solution that can have a current density in the above range in the LSV measurement include a mixture of EC and MTFP in the ratio of 20:80 by volume, a mixture of FEC and MP in the ratio of 20:80 by volume, a mixture of EC and MP in the ratio of 20:80 by volume, a mixture of FEC and MTFP in the ratio of 20:80 by volume, a mixture of EC, EMC, and DMC in the ratio of 30:35:35 by volume, a mixture of EC, EMC, and MP in the ratio of 20:20:40 by volume, and a mixture of EC and MTFP in the ratio of 20:80 by volume.

### [Lithium Salt]

As the lithium salt (also referred to as electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio. The lithium salt is preferably dissolved in the solvent at greater than or equal to 0.5 mol/L and less than or equal to 3.0 mol/L. Using a fluoride such as LiPF₆ or LiBF₄ enables a lithium-ion secondary battery to have improved safety.

The above electrolyte solution is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1 wt %, further preferably less than or equal to 0.1 wt %, still further preferably less than or equal to 0.01 wt %.

### [Additive Agent]

Furthermore, an additive agent such as vinylene carbonate (VC), propane sultone (PS), tert-butylbenzene (TBB), fluoroethylene carbonate (FEC), lithium bis(oxalate)borate (LiBOB), a dinitrile compound such as succinonitrile or adiponitrile, fluorobenzene, ethylene glycol bis(propionitrile) ether may be added to the electrolyte solution. The concentration of the material to be added in the whole solvent is, for example, higher than or equal to 0.1 wt % and lower than or equal to 5 wt %. VC and LiBOB are particularly preferable because they facilitate formation of a favorable coating portion.

### [Gel Electrolyte]

A polymer gel obtained by swelling a polymer with an electrolyte solution may be used as a gel electrolyte. When a polymer gel electrolyte is used, a semisolid electrolyte layer can be obtained, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a polyethylene oxide (PEO)-based polymer material, or the like may be used. When the solid electrolyte is used, a separator and/or a spacer is/are not necessary. Furthermore, the battery can be entirely solidified; therefore, there is no risk of liquid leakage and thus the safety of the battery is dramatically improved.

### [Separator]

The secondary battery preferably includes a separator. The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in high-voltage charging-discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the discharge capacity per volume of the secondary battery can be increased because the safety of the secondary battery can be maintained even when the total thickness of the separator is small.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <Laminated Secondary Battery and Fabricating Method Thereof>

FIG. 14 and FIGS. 15A to 15C illustrate examples of an external view of a laminated secondary battery 500. FIG. 14 and FIGS. 15A to 15C illustrate the positive electrode 503, the negative electrode 506, the separator 507, the exterior body 509, a positive electrode lead electrode 510, and a negative electrode lead electrode 511. When a laminated secondary battery has flexibility and is used in an electronic device at least part of which is flexible, the secondary battery can be bent accordingly as the electronic device is bent. An example of a method for fabricating the laminated secondary battery will be described with reference to FIGS. 15A to 15C

First, the negative electrode 506, the separator 507, and the positive electrode 503 are stacked. FIG. 15B illustrates a stack of the negative electrode 506, the separator 507, and the positive electrode 503. The secondary battery described here as an example includes five negative electrodes and four positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 15C. Then, the outer edges of the exterior body 509 are bonded to each other. The bonding can be performed by thermocompression, for example. At this time, a part (or one side) of the exterior body 509 is left unbonded to provide an inlet so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

When the positive electrode active material described in the above embodiment is used in the positive electrode 503, the secondary battery 500 can have high discharge capacity and excellent cycle performance.

This embodiment can be implemented in combination with any of the other embodiments.

### Embodiment 5

This embodiment will describe an example where an all-solid-state secondary battery is fabricated using the positive electrode active material obtained in the foregoing embodiment.

### [All Solid-State Secondary Battery]

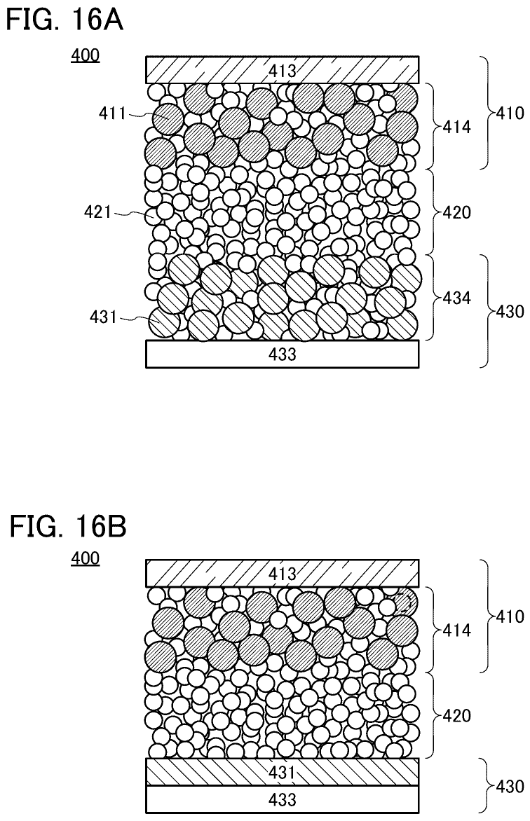

FIG. 16A shows a cross-sectional view of a secondary battery 400. The secondary battery 400 includes a positive electrode 410, a solid electrolyte layer 420, and a negative electrode 430.

The positive electrode 410 includes a positive electrode current collector 413 and a positive electrode active material layer 414. The positive electrode active material layer 414 contains a positive electrode active material 411. The positive electrode active material layer 414 preferably includes a solid electrolyte 421 in addition to the positive electrode active material 411. The positive electrode active material layer 414 may also include a conductive material and a binder in addition to the positive electrode material 411.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. In addition to the negative electrode active material 431, the negative electrode active material layer 434 preferably includes the solid electrolyte 421. The negative electrode active material layer 434 may also include a conductive material and a binder. Note that when metallic lithium is used as the negative electrode active material 431, metallic lithium does not need to be processed into particles; thus, the negative electrode 430 that does not include the solid electrolyte 421 can be formed, as illustrated in FIG. 16B. The use of metallic lithium for the negative electrode 430 is preferable because the energy density of the secondary battery 400 can be increased.

The thickness of the solid electrolyte layer 420 is preferably greater than or equal to 0.1 μm and less than or equal to 1 mm, further preferably greater than or equal to 1 μm and less than or equal to 100 μm, for example.

The thickness of the positive electrode active material layer 414 is preferably greater than or equal to 0.1 μm and less than or equal to 1 mm, further preferably greater than or equal to 1 μm and less than or equal to 100 μm, for example.

The thickness of the negative electrode active material layer 434 is preferably greater than or equal to 0.1 μm and less than or equal to 1 mm, further preferably greater than or equal to 1 μm and less than or equal to 100 μm, for example.

The thickness of each of the positive electrode current collector 413 and the negative electrode current collector 433 is preferably greater than or equal to 1 μm and less than or equal to 1 mm, further preferably greater than or equal to 5 μm and less than or equal to 200 μm, for example.

For the negative electrode active material, silicon, titanium oxide, vanadium oxide, indium oxide, zinc oxide, tin oxide, nickel oxide, or the like can be used. Furthermore, a carbon-based material such as graphite, graphitizing carbon (soft carbon), non-graphitizing carbon (hard carbon), carbon fiber such as a carbon nanotube, graphene, carbon black, or activated carbon can be used. A material that is alloyed with Li, such as tin, gallium, or aluminum can be used. Alternatively, an oxide of such a metal that is alloyed with Li may be used. A lithium titanium oxide (Li₄Ti₅O₂, LiTi₂O₄, or the like) may be used; in particular, a material containing silicon and oxygen (also referred to as a SiOx film) is preferable. A Li metal may also be used for the negative electrode active material layer 434.

As materials included in the positive electrode current collector 413 and the negative electrode current collector 433, copper, aluminum, silver, palladium, gold, platinum, nickel, titanium, or the like can be used, for example.

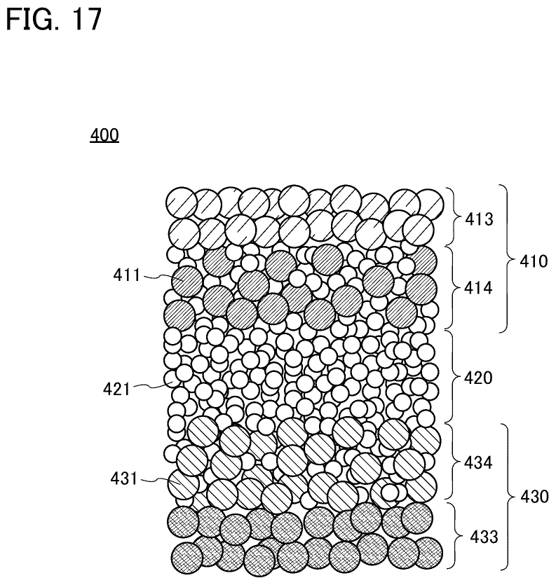

As illustrated in FIG. 17 and the like, a current collector layer formed using particles having conductivity may be used as each of the positive electrode current collector 413 and the negative electrode current collector 433. As an example, a current collector layer including aluminum particles or copper particles can be used as the positive electrode current collector 413. As an example, a current collector layer including copper particles can be used as the negative electrode current collector 433.

The positive electrode 410 and the negative electrode 430 do not necessarily include the positive electrode current collector 413 and the negative electrode current collector 433, respectively.

As the solid electrolyte 421, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

As an oxide-based solid electrolyte, lithium phosphate (Li₃PO₄), nitrogen-containing lithium phosphate LiₓPO_{4-y}N_{y} (2.8≤x≤3), lithium niobate, a Li—Si—O-based compound, a Li—P—Si—O-based compound, a Li—V—Si—O-based compound, a Li—P—B—O-based compound, or the like can be used. Examples of the oxide-based solid electrolyte include oxide glass (e.g., Li₃PO₄—Li₄SiO₄ and 50Li₄SiO₄·50Li₃BO₃) and oxide-based crystallized glass (e.g., Li_{1.07}Al_{0.69}Ti_{1.46}(PO₄)₃ and Li_{1.5}Al_{0.5}Ge_{1.5}(PO₄)₃). Examples of the oxide-based solid electrolyte include a material with a perovskite crystal structure (e.g., La_{2/3-x}Li₃ₓTiO₃), a material with a NASICON crystal structure (e.g., LiₓM_{y}(PO₄)₃(1≤x≤2, 1≤y≤2, and M is one or more of Ti, Ge, Al, Ga, and Zr), specifically, Li_{1-Y}Al_{Y}Ti_{2-Y}(PO₄)₃ or the like), a material with a garnet crystal structure (e.g., Li₇La₃Zr₂O₁₂), and a material with a LISICON crystal structure (e.g., Li₁₄ZnGe₄O₁₆). The oxide-based solid electrolyte has an advantage of stability in the air, for example.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because LATP contains aluminum and titanium, which are elements allowable for the positive electrode active material used in the secondary battery 400 of one embodiment of the present invention, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### Structure Example 1 of Solid-State Secondary Battery

An exterior body of the secondary battery 400 of one embodiment of the present invention can be formed using a variety of materials and have a variety of shapes, and preferably has a function of applying pressure to the positive electrode, the solid electrolyte layer, and the negative electrode.

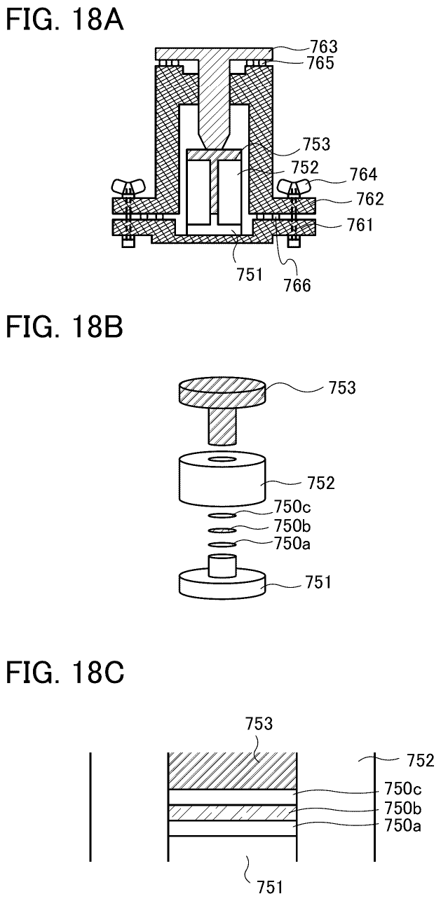

FIGS. 18A to 18C show an example of a cell for evaluating materials of an all-solid-state battery.

FIG. 18A is a schematic cross-sectional view of an evaluation cell. The evaluation cell includes a lower component 761 and an upper component 762. The lower component 761 and the upper component 762 can be fixed with a bolt in the lower component 761 and a butterfly nut or hexagonal nut 764. By rotating a pressure screw 763, an electrode plate 753 is pressed to fix an evaluation material. An insulator 766 is provided between the lower component 761 and the upper component 762 that are made of stainless steel. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 18B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 18C. Note that the same portions in FIGS. 18A to 18C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

### Structure Example 2 of Solid-State Secondary Battery

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

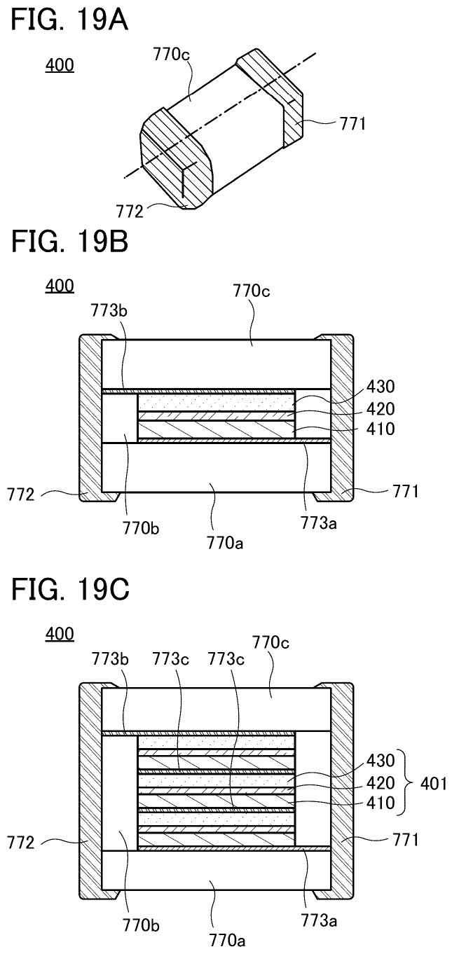

FIG. 19A is a perspective view of the secondary battery 400. The secondary battery 400 is an all-solid secondary battery that includes external electrodes 771 and 772 and is sealed with an exterior body including a plurality of package components.

FIG. 19B illustrates an example of a cross section along the dashed-dotted line in FIG. 19A. A stack including the positive electrode 410, the solid electrolyte layer 420, and the negative electrode 430 is surrounded and sealed by a package component 770a including an electrode layer 773a on a flat plate, a frame-like package component 770b, and a package component 770c including an electrode layer 773b on a flat plate. For the package components 770a, 770b, and 770c, insulating materials such as a resin material or ceramics can be used.

The external electrode 771 is electrically connected to the positive electrode 410 through the electrode layer 773a and functions as a positive electrode terminal. The external electrode 772 is electrically connected to the negative electrode 430 through the electrode layer 773b and functions as a negative electrode terminal.

When a secondary battery is fabricated, paste for the positive electrode 410, paste for the solid electrolyte layer 420, and paste for the negative electrode 430 are formed and applied, so that respective paste layers are formed. Examples of applicable application method for forming a paste layer include a die coating method, a spray coating method, a dipping method, a spin coating method, a relief printing method, an offset printing method, a gravure printing method, and a screen printing method. In addition, paste for the positive electrode current collector layer, paste for the negative electrode current collector layer, and paste for the buffer layer are formed and applied over a support substrate, so that respective paste layers are formed. It is preferable that a material adding peelability be formed in advance on the support substrate because layer separation is performed later. For example, a resin film including a binder or the like is preferably formed as pretreatment.

Each of the paste layer for the positive electrode current collector layer, the paste layer for the negative electrode current collector layer, the paste layer for the buffer layer, the paste layer for the positive electrode, the paste layer for the solid electrolyte layer, and the paste layer for the negative electrode is formed on the support substrate and removed from the support substrate. Then, the separated layers are stacked.

A stack body in which the layers are stacked in the above manner is pressed or baked.

The stack body is cut into a desired shape and then surrounded with the package component. Alternatively, the stack body may be framed and pressed so as not to spread, and then may be surrounded with the package component.

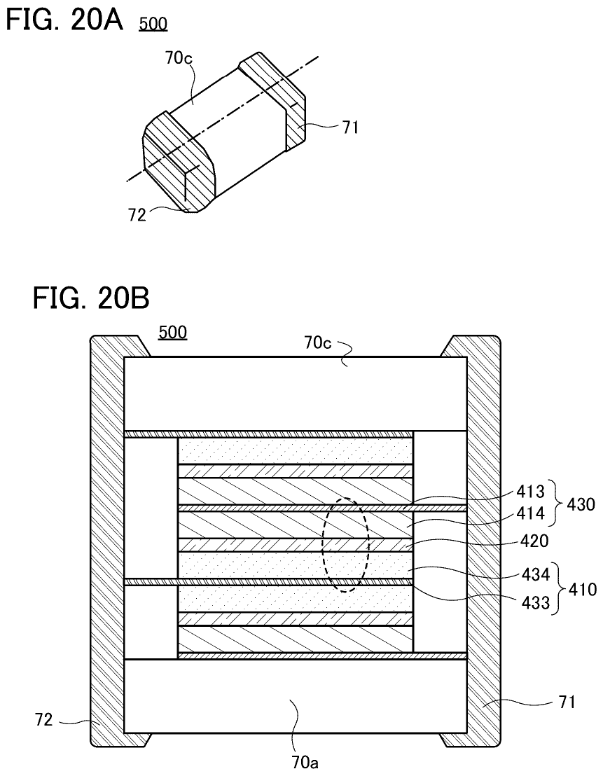

Lastly, the end face of the stack body surrounded with the package component is dipped into conductive paste. After that, baking is performed, so that the external electrodes 71 and 72 are formed, resulting in an all-solid-state secondary battery sealed by the package component illustrated in e.g., FIG. 19A and FIG. 20A described later.

The all-solid-state secondary battery of one embodiment of the present invention can be formed into, for example, a rectangular solid shape to have a dimension (the first side×the second side×height) of 3.5 mm×2.5 mm×2 mm, 4.5 mm×3 mm×1 mm, or 10 mm×10 mm×6 mm.

As illustrated in FIG. 19C, the secondary battery 400 can have a plurality of sets in each of which the positive electrode 410 and the negative electrode 430 are stacked with the solid electrolyte layer 420 place therebetween. The set in which the positive electrode 410 and the negative electrode 430 are stacked with the solid electrolyte layer 420 placed therebetween is referred to as a battery cell 401 hereinafter. The battery cell 401 can function as a secondary battery.

FIG. 19C illustrates an example where three battery cells 401 are connected in series. The current collector 773c is provided between the battery cells 401. The current collector 773c can have any of the structures of the positive electrode current collector 413, the negative electrode current collector 433, the electrode layer 773a, the electrode layer 773b, and the like described above.

### Structure Example 3 of all-Solid-State Secondary Battery

FIG. 20A is a perspective view of the secondary battery 500. The secondary battery 500 is an all-solid-state secondary battery which includes the external electrodes 71 and 72 and is sealed by the package component.

In addition, an example of a cross section taken along the dashed-dotted line in FIG. 20A is illustrated in FIG. 20B. The secondary battery 500 includes, in a region sealed by the package component, a stacked body in which the positive electrodes 410, the solid electrolyte layers 420, and the negative electrodes 430 are stacked. The stacked body is surrounded and sealed by package components 70a and 70c. For the package components 70a and 70c, an insulating material, e.g., a resin material and/or ceramics, can be used.

The positive electrode 410 includes the positive electrode current collector 413 and the positive electrode active material layer 414. The negative electrode 430 includes the negative electrode current collector 433 and the negative electrode active material layer 434.

The external electrode 72 is electrically connected to the positive electrode active material layer 414 through the positive electrode current collector 413 and serves as a positive electrode. The external electrode 71 is electrically connected to the negative electrode active material layer 434 through the negative electrode current collector 433 and serves as a negative electrode.

Note that the positive electrode current collector 413 may be provided on the package component 70a. The negative electrode current collector 433 may be provided on the package component 70c.

For the positive electrode current collector 413, aluminum particles or a copper particles can be used.

The positive electrode active material layer 414 contains a positive electrode active material. As the positive electrode active material, a positive electrode active material described in Embodiment 1 can be used.

For the solid electrolyte layer 420, the above description of the solid electrolyte layer 420 can be referred to.

For the negative electrode active material layer 434, the above description of the negative electrode active material layer 434 can be referred to.

As the negative electrode current collector 433, copper particles can be used.

In an example illustrated in FIG. 20B, three sets each including the positive electrode current collector 413, the positive electrode active material layer 414, the solid electrolyte layer 420, the negative electrode active material layer 434, and the negative electrode current collector 433 that are stacked are used; however, the number of sets may be two or four or more.

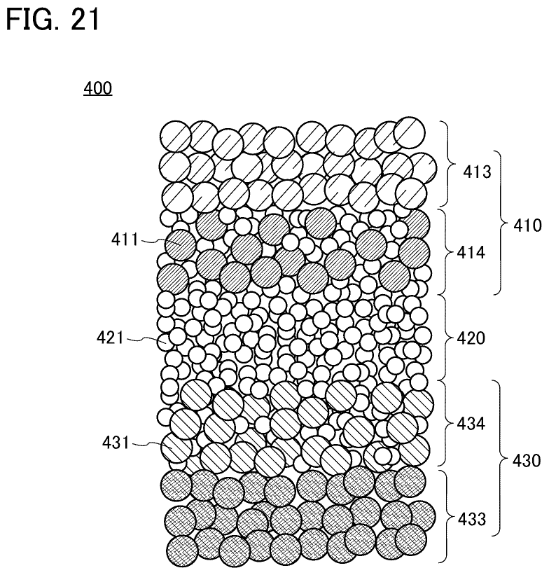

Each layer is composed of particles, though it is illustrated as a schematic view in FIG. 20B, and a secondary battery including such layers is also called a bulk-type all-solid-state battery. FIG. 21 is an enlarged schematic view of a region indicated by the dotted line in FIG. 20B. Note that although spherical particles are illustrated schematically in FIG. 21, the shape and the size of particles are not particularly limited to those in FIG. 21.

As illustrated in FIG. 21, the secondary battery 500 of one embodiment of the present invention includes the positive electrode 410, the solid electrolyte layer 420, and the negative electrode 430.

The positive electrode 410 includes the positive electrode current collector 413 and the positive electrode active material layer 414. The positive electrode active material layer 414 contains the positive electrode active material 411. The positive electrode active material layer 414 preferably includes the solid electrolyte 421 in addition to the positive electrode active material 411. The positive electrode active material layer 414 may also include a conductive material and a binder in addition to the positive electrode active material 411.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes the negative electrode current collector 433 and the negative electrode active material layer 434. The negative electrode active material layer 434 preferably includes the solid electrolyte 421 in addition to the negative electrode active material 431. The negative electrode active material layer 434 may also include a conductive material and a binder. Note that when metallic lithium is used as the negative electrode active material 431, metallic lithium does not need to be processed into particles; thus, the negative electrode 430 that does not include the solid electrolyte can be formed.

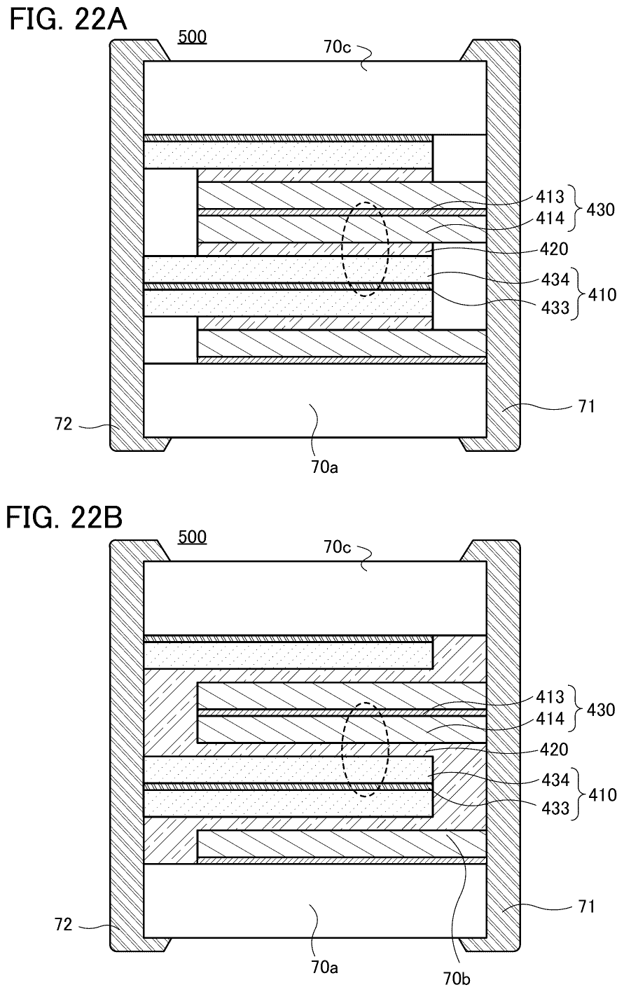

In the secondary battery 500 in the example illustrated in FIG. 20B, an end portion of the positive electrode current collector 413 extends beyond an end portion of the positive electrode active material layer 414 and reaches the external electrode 71, and an end portion of the negative electrode current collector 433 extends beyond an end portion of the negative electrode active material layer 434 and reaches the external electrode 72; however, as illustrated in FIG. 22A, the end portion of the positive electrode active material layer 414 may also reach the external electrode 71, and the end portion of the negative electrode active material layer 434 may also reach the external electrode 72.

In the examples of the secondary batteries 500 in FIG. 20B and FIG. 22A, the solid electrolyte layer 420 is placed between the positive electrode 410 and the negative electrode 430 that overlap with each other; however, as illustrated in FIG. 22B, the solid electrolyte layer 420 may be placed in a region between two positive electrodes 410 that overlap with each other, a region between two negative electrodes 430 that overlap with each other, a region between the positive electrode 410 and the package component 70a, a region between the negative electrode 430 and the package component 70c, and the like. The structure illustrated in FIG. 22B can increase the mechanical strength of the secondary battery 500, for example.

A solid-state secondary battery is expected to be chemically stable at high potentials as compared with a secondary battery including an electrolyte solution. Therefore, the all-solid-state secondary battery including the positive electrode active material obtained in the above embodiment can be expected to have favorable charge-discharge characteristics even when the charge voltage is 4.8 V or higher, for example, 5.0 V.

This embodiment can be implemented in appropriate combination with any of the other embodiments.

### Embodiment 6

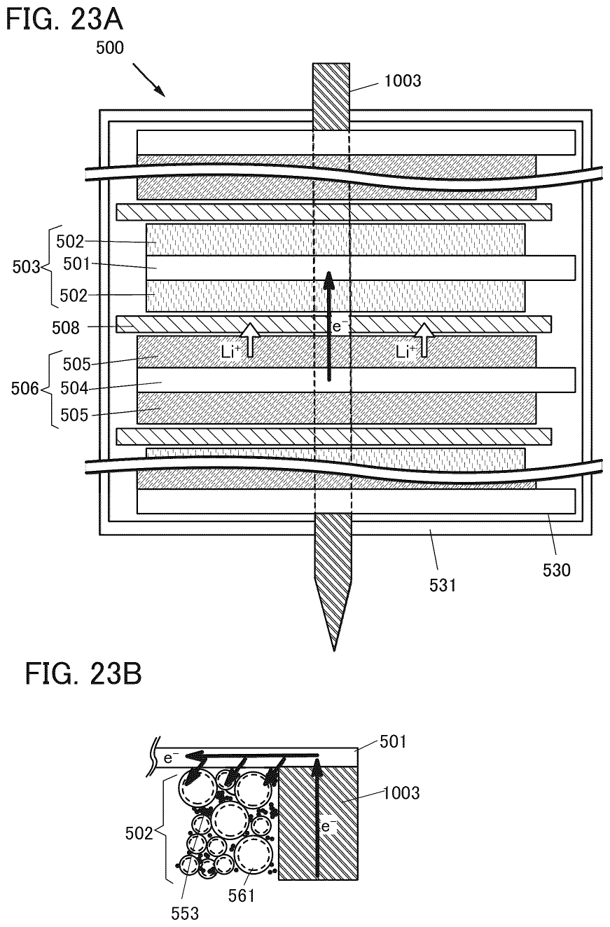

In this embodiment, a nail penetration test, which is a kind of safety tests, is described with reference to drawings including FIGS. 23A and 23B. In the nail penetration test, a nail 1003 having a predetermined diameter in the range of 2 mm to 10 mm is made to penetrate the secondary battery 500 in a fully charged state (a state of charge (SOC) of the secondary battery is 100%) at a predetermined speed. The nail penetrating speed can be, for example, greater than or equal to 1 mm/s and less than or equal to 20 mm/s. FIG. 23A is a cross-sectional view illustrating the state where the nail 1003 penetrates the a secondary battery 500. The secondary battery 500 has a structure in which the positive electrode 503, the separator 508, the negative electrode 506, and an electrolyte solution 530 are held in an exterior body 531. The positive electrode 503 includes a positive electrode current collector 501 and positive electrode active material layers 502 formed over both surfaces of the positive electrode current collector 501. The negative electrode 506 includes a negative electrode current collector 504 and negative electrode active material layers 505 formed over both surfaces of the negative electrode current collector 504. FIG. 23B is an enlarged view of the nail 1003 and the positive electrode current collector 501. The enlarged view also details the positive electrode active material 100 and a conductive material 553 of the positive electrode active material layer 502.

As illustrated in FIGS. 23A and 23B, when the nail 1003 penetrates the positive electrode 503 and the negative electrode 506, an internal short circuit occurs. This makes the potential of the nail 1003 equal to that of the negative electrode, so that an electron (e⁻) flows to the positive electrode 503 through the nail 1003 and the like as indicated by the black arrows and Joule heat is generated in the portion where the internal short circuit has occurred and the vicinity of the portion. The internal short circuit causes carrier ions, typically lithium ions (Li⁺), to be extracted from the negative electrode 506 and to be released into the electrolyte solution as indicated by the white arrows. Here, in the case where anions are insufficient in the electrolyte solution 530, the electrical neutrality of the electrolyte solution 530 is not maintained when lithium ions are extracted from the negative electrode 506 to the electrolyte solution 530, so that the electrolyte solution 530 starts decomposing to maintain the electrical neutrality.

The Joule heat sometimes increases the temperature of the secondary battery 500. At this time, when lithium cobalt oxide is used for the positive electrode active material, the crystal structure of the lithium cobalt oxide might be changed, and heat generation is further caused in some cases.

Then, the electron (e⁻) that has flowed to the positive electrode 503 reduces Co, which is tetravalent in the lithium cobalt oxide in the charged state, to trivalent or divalent Co. This reduction reaction causes oxygen release from the lithium cobalt oxide, and an oxidation reaction due to the oxygen decomposes the electrolyte solution 530. The speed at which a current flows into the positive electrode active material 100 or the like varies depending on the insulating property of the positive electrode active material, and it is presumable that the speed at which a current flows affects the above electrochemical reaction.

When an internal short circuit of the secondary battery occurs, the temperature of the secondary battery increases over time. In the case where Joule heat is continuously generated until the temperature of the secondary battery increases to reach approximately 100° C., reduction of an electrolyte solution and heat generation caused by the negative electrode (the negative electrode is C₆Li when graphite is used), oxidation of the electrolyte solution and heat generation caused by the positive electrode, and heat generation due to thermal decomposition of the electrolyte solution are caused. Accordingly, the secondary battery enters thermal runaway, resulting in ignition or the like.

In this specification and the like, the ignition in a nail penetration test represents a state in which fire is observed outside an exterior body. In addition, the ignition represents a state in which thermal runway has occurred in a secondary battery. For example, when a temperature sensor attached to the exterior body 531 in a region within 3 cm from a tab of the secondary battery 500 reads a temperature of 130° C. or higher, it can be regarded that thermal runway has occurred. The temperature sensor can be attached to the exterior body 531 with a polyimide film tape, for example. Alternatively, a state where a thermal decomposition product of a positive electrode and/or a negative electrode is observed at a position more than or equal to 2 cm away from a penetration point after a nail penetration test is finished is referred to as a state where thermal runaway has occurred.

Meanwhile, a state where a spark and/or smoke that are/is observed but do/does not spread, that is, thermal runaway of the entire secondary battery does not occur, is not referred to as ignition.

To prevent the occurrence of ignition, thermal runway, or the like in the nail penetration test, an increase in the temperature of the secondary battery should be suppressed and members constituting the secondary battery (e.g., the negative electrode, the positive electrode, and the electrolyte solution) should be stable at high temperatures. Specifically, it is preferable that the positive electrode active material have a stable structure from which no oxygen is released even at high temperatures. Alternatively, the positive electrode active material preferably has such a structure that a small amount of current flows into the positive electrode active material. The positive electrode active material 100 of one embodiment of the present invention has a high volume resistivity and thus can slow down the speed of electrons flowing into the positive electrode active material.

### Embodiment 7

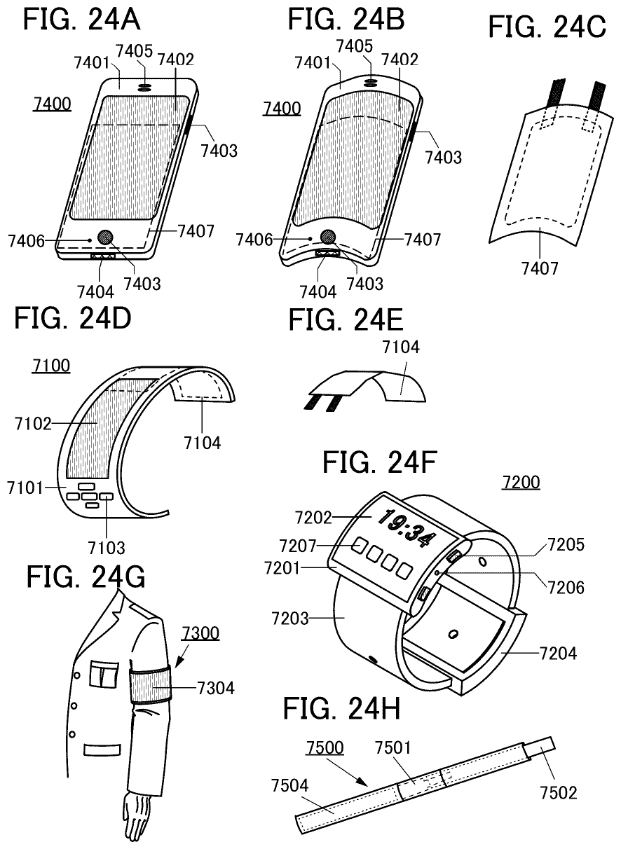

In this embodiment, examples of electronic devices each including the secondary battery of one embodiment of the present invention are described with reference to FIGS. 24A to 24H, FIGS. 25A to 25D, and FIGS. 26A to 26C.

FIGS. 24A to 24G show examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 24A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 24B illustrates the mobile phone 7400 in a state of being bent. When the whole mobile phone 7400 is bent by the external force, the secondary battery 7407 included in the mobile phone 7400 is also bent. FIG. 24C illustrates the secondary battery 7407 that is being bent at that time. The secondary battery 7407 is a thin storage battery. The secondary battery 7407 is fixed in a state of being bent. The secondary battery 7407 includes a lead electrode electrically connected to a current collector. The current collector is, for example, copper foil and is partly alloyed with gallium; thus, adhesion between the current collector and an active material layer in contact with the current collector is improved and the secondary battery 7407 can have high reliability even in a state of being bent.

FIG. 24D illustrates an example of a bangle-type display device. A portable display device 7100 includes a housing 7101, a display portion 7102, operation buttons 7103, and a secondary battery 7104. FIG. 24E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm, both inclusive. When the radius of curvature of the main surface of the secondary battery 7104 ranges from 40 mm to 150 mm, both inclusive, the reliability can be kept high. By using the secondary battery of one embodiment of the present invention as the secondary battery 7104, a lightweight long-life portable display device can be provided.

FIG. 24F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. In that case, for example, hands-free calling is possible with mutual communication between the portable information terminal 7200 and a headset capable of wireless communication.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 24E that is in the state of being curved can be provided in the housing 7201. Alternatively, the secondary battery 7104 in FIG. 24E can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 24G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charge operation may be performed by wireless power feeding without using the input/output terminal.

By using the secondary battery of one embodiment of the present invention as the secondary battery included in the display device 7300, a lightweight long-life display device can be provided.

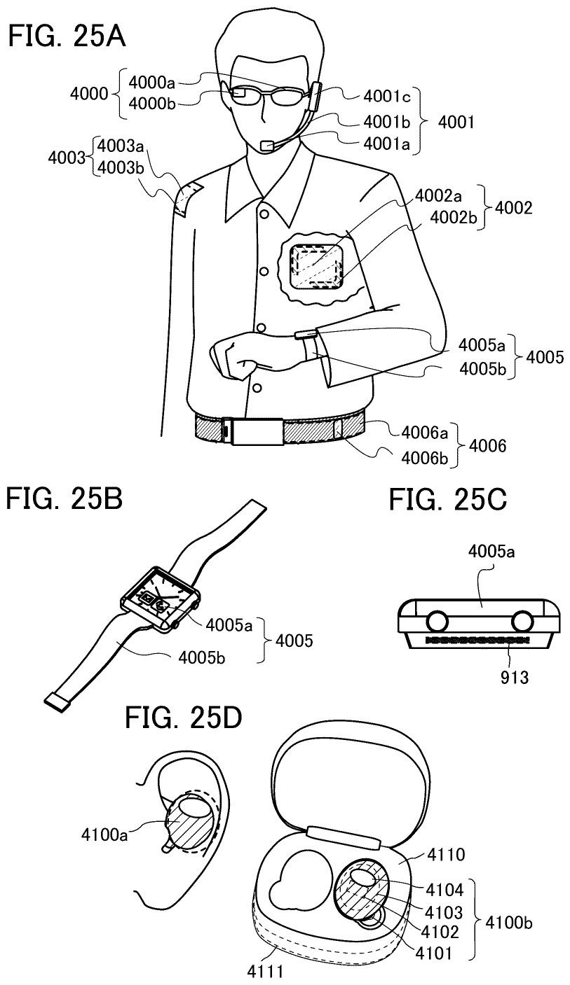

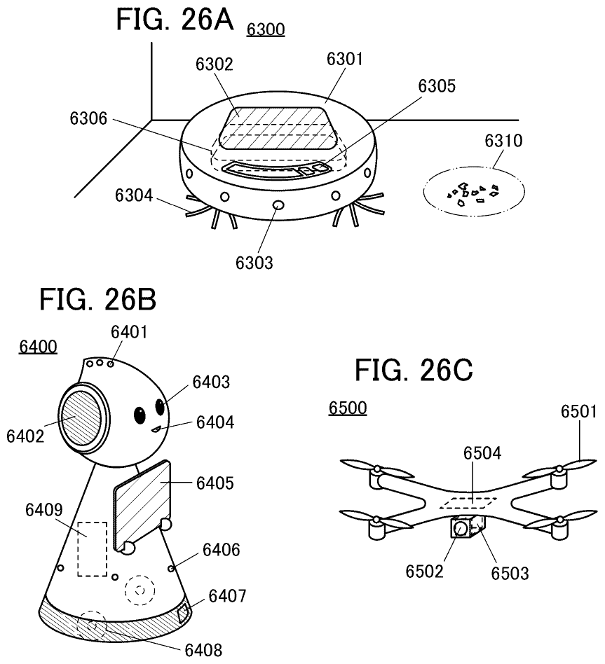

Examples of electronic devices each including the secondary battery with excellent cycling performance described in the above embodiment are described with reference to FIG. 24H, FIGS. 25A to 25D, and FIGS. 26A to 26C.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high discharge capacity are desired in consideration of handling ease for users.

FIG. 24H is a perspective view of a device called a vaporizer (electronic cigarette). In FIG. 24H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 24H includes an external terminal for connection to a charger. When the electronic cigarette 7500 is held by a user, the secondary battery 7504 is at the tip of the device; thus, it is preferred that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

FIG. 25A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 25A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 25B is a perspective view of the watch-type device 4005 that is detached from an arm.

FIG. 25C is a side view thereof. FIG. 25C illustrates a state where the secondary battery 913 is incorporated in the watch-type device 4005. The secondary battery 913 is the secondary battery described in Embodiment 4. The secondary battery 913, which is small and lightweight, overlaps with the display portion 4005a.

FIG. 25D illustrates an example of wireless earphones. The wireless earphones shown as an example consist of, but not limited to, a pair of earphone bodies 4100a and 4100b.

The earphone bodies 4100a and 4100b include a driver unit 4101, an antenna 4102, and a secondary battery 4103. The earphone bodies 4100a and 4100b may also include a display portion 4104. Moreover, the earphone bodies 4100a and 4100b preferably include a substrate where a circuit such as a wireless IC is provided, a terminal for charge, and the like. The earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 26A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 26B illustrates an example of a robot. A robot 6400 illustrated in FIG. 26B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 26C illustrates an example of a flying object. A flying object 6500 illustrated in FIG. 26C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 8

In this embodiment, examples of vehicles each including the secondary battery containing a positive electrode active material of one embodiment of the present invention are described.

The use of secondary batteries in vehicles enables production of next-generation clean energy vehicles such as hybrid vehicles (HV), electric vehicles (EV), and plug-in hybrid vehicles (PHV).

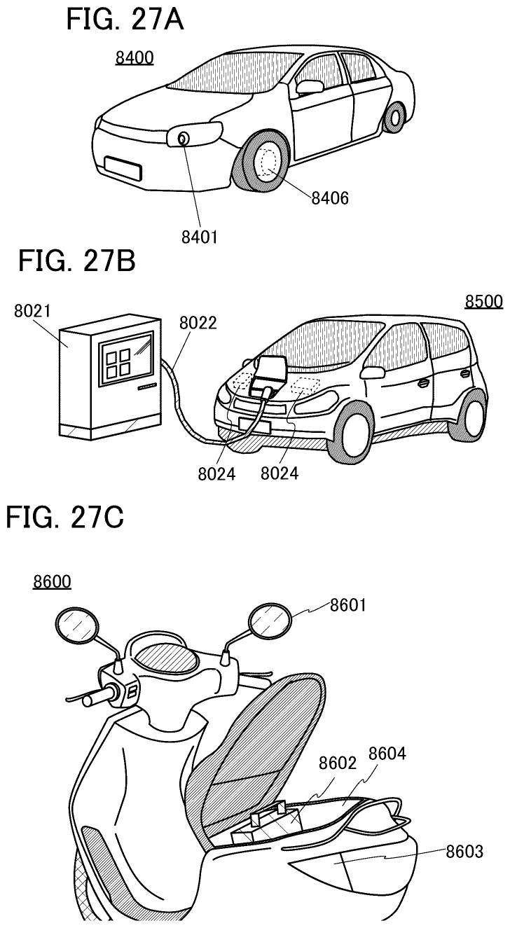

FIGS. 27A to 27C illustrate examples of vehicles each including the secondary battery of one embodiment of the present invention. An automobile 8400 illustrated in FIG. 27A is an electric vehicle that runs on the power of an electric motor. Alternatively, the automobile 8400 is a hybrid vehicle capable of driving using either an electric motor or an engine as appropriate. The use of one embodiment of the present invention allows fabrication of a high-mileage vehicle. The automobile 8400 includes the secondary battery. For example, the modules of the secondary battery can be arranged in a floor portion in the automobile to be used. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 27B illustrates an automobile 8500 including the secondary battery. The automobile 8500 can be charged when the secondary battery is supplied with electric power from external charging equipment by a plug-in system and/or a contactless power feeding system, for example. In FIG. 27B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charge method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from the outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 27C illustrates an example of a motorcycle including the secondary battery of one embodiment of the present invention. A motor scooter 8600 illustrated in FIG. 27C includes a secondary battery 8602, side mirrors 8601, and indicators 8603. The secondary battery 8602 can supply electric power to the indicators 8603.

In the motor scooter 8600 illustrated in FIG. 27C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example

In this example, a positive electrode active material of one embodiment of the present invention was formed and its characteristics were analyzed.

### <Formation of Positive Electrode Active Material>

The positive electrode active material (Sample 1) fabricated in this example is described with reference to the formation method in FIG. 12 and FIGS. 13A to 13C.

As the LiCoO₂ in Step S14 in FIG. 12, commercially available lithium cobalt oxide (Cellseed C-10N produced by NIPPON CHEMICAL INDUSTRIAL CO., LTD.) containing cobalt as the transition metal M and not containing an additive element was prepared and sieved by an automatic sieving machine. As the initial heating in Step S15, heating was performed on the lithium cobalt oxide put in a sagger covered with a lid, in a roller hearth kiln simulator furnace (produced by NORITAKE CO., LIMITED) as a baking furnace at 850° C. for two hours. In the furnace, oxygen flow was performed. The flow rate was adjusted such that a differential pressure gauge read 5 Pa, and oxygen flow was performed at 10 L/min. In cooling of the furnace, the furnace was cooled down to 200° C. at a rate of 200° C./h. Flow with dry air (dew point of −109° C.) was performed at 200° C. or lower at 25 L/min.

In this example, in accordance with Step S21 and Step S41 shown in FIGS. 13A and 13C, Mg, F, Ni, and Al were separately added as the added elements. First, in accordance with Step S21 shown in FIG. 13A, LiF and MgF₂ were prepared as the F source and the Mg source, respectively. The LiF and MgF₂ were weighed such that LiF: MgF₂=1:3 (molar ratio), and sieved by an automatic sieving machine, in accordance with Step 22. Then, the LiF and MgF₂ were mixed in dehydrated acetone at a rotational speed of 500 rpm for 20 hours to give an additive element source (A1 source).

Then, in Step S31, the A1 source and the lithium cobalt oxide subjected to the initial heating were weighed such that the magnesium of the A1 source was 1 mol % with respect to the cobalt, and were mixed by a dry method. The resulting mixture was stirred using a picobond (produced by HOSOKAWA MICRON CORPORATION) at a rotational speed of 3000 rpm for 10 minutes and sieved by an automatic sieving machine to give the mixture 903 (Step S32).

Subsequently, in Step S33, the mixture 903 was heated. The heating was performed at 900° C. for 20 hours. During the heating, the mixture 903 was in a sagger covered with a lid. As a heating furnace at this time, a roller hearth kiln simulator furnace (produced by NORITAKE CO., LIMITED) was used. Oxygen flow was performed at 10 L/min in the furnace (O₂ flow). The flow rate, specifically, the width of an opening of an outlet was adjusted such that a differential pressure gauge read 5 Pa. Cooling in the furnace was performed at a rate of 200° C./h while oxygen flow was continued until the temperature reached 200° C. Accordingly, a composite oxide containing Mg and F was obtained (Step S34a).

Then, in Step S51, the composite oxide and the additive element sources (the A2 sources) were mixed. Nickel hydroxide which had been subjected to a grinding step was prepared as the nickel source and aluminum hydroxide which had been subjected to a grinding step was prepared as the aluminum source in accordance with Step S41 to S43 shown in FIG. 13C, so that the additive element sources (the A2 sources) were obtained. The nickel hydroxide, the aluminum hydroxide, and the composite oxide were weighed such that the nickel in the nickel hydroxide and the aluminum in the aluminum hydroxide were each 0.5 mol % with respect to the cobalt, and the nickel hydroxide, the aluminum hydroxide, and the composite oxide were mixed by a dry method. The resulting mixture was stirred using a picobond (produced by HOSOKAWA MICRON CORPORATION) at a rotational speed of 3000 rpm for 10 minutes to give the mixture 904 (Step S52).

Subsequently, in Step S53, the mixture 904 was heated. The heating was performed at 850° C. for 10 hours. During the heating, the mixture 904 was in a sagger covered with a lid. During the heating performed at the above heating temperature, the sagger was in a roller hearth kiln simulator furnace (produced by NORITAKE CO., LIMITED). Oxygen flow was performed at 10 L/min in the furnace (O₂ flow). The flow rate was adjusted such that a differential pressure gauge read 5 Pa. Cooling in the furnace was performed at a rate of 200° C./h, while oxygen flow was continued until the temperature reached 200° C. Thus, lithium cobalt oxide containing Mg, F, Ni, and Al was obtained (Step S54). This positive electrode active material (composite oxide), which was obtained through the above steps, was used as Sample 1.

As Sample 10, which was a reference, lithium cobalt oxide (Cellseed C-10N produced by NIPPON CHEMICAL INDUSTRIAL CO., LTD.) not subjected to any treatment was used.

### <Powder Volume Resistivity>

The powder volume resistivity of each of Samples 1 and 10 obtained as described above was measured.

The measurement was performed in a dry room with a dew point ranging from −100° C. to −10° C., both inclusive.

Table 2 and Table 3 show the volume resistivities and the measurement conditions of Samples 1 and 10. The measurement at room temperature was performed at a pressure of 16 MPa. As a measurement apparatus, MCP-PD51 (produced by Mitsubishi Chemical Analytech Co., Ltd.) was used; for a device with a four probe method, Hiresta-GP was used.

In the measurement at a thermostatic oven temperature of 45° C. or higher, the measurement apparatus illustrated in FIGS. 9A to 9C and FIG. 10 was used, the vise was closed with a torque wrench, and the load at this time was 60 kgf·cm (5.9 N·m). The pressure at this time was 1.52 MPa when measured with use of a pressure measurement film (Prescale LLW, produced by FUJIFILM Corporation). DMM6500 (produced by Keithley Instruments) was used as the resistance meter.

TABLE 2
Sample 1

| Temp. of | Logger | | | Voltage set | Volume |
|---|---|---|---|---|---|
| thermostatic | temp. | Resistance | Temp. | in source | resistivity |
| oven (° C.) | (° C.) | (Ω) | (K) | meter (V) | (Ω · cm) |
| 25 | 26.5 | 1.66E+10 | 299.65 | 5 | 2.03E+12 |
| 45 | 45.3 | 1.85E+09 | 318.45 | 5 | 2.26E+11 |
| 60 | 59.9 | 1.96E+08 | 333.05 | 5 | 2.39E+10 |
| 100 | 97.2 | 5.80E+06 | 370.35 | 5 | 7.09E+08 |
| 200 | 190.9 | 2.54E+04 | 464.05 | 5 | 3.10E+06 |

TABLE 3
Sample 10

| Temp. of | Logger | | | Voltage set | Volume |
|---|---|---|---|---|---|
| thermostatic | temp. | Resistance | Temp. | in source | resistivity |
| oven (° C.) | (° C.) | (Ω) | (K) | meter (V) | (Ω · cm) |
| 25 | 26.5 | 9.53E+02 | 299.65 | 1 | 1.12E+05 |
| 45 | 45.4 | 5.11E+02 | 318.55 | 1 | 6.01E+04 |
| 60 | 59.8 | 3.20E+02 | 332.95 | 1 | 3.77E+04 |
| 100 | 96.9 | 1.18E+02 | 370.05 | 1 | 1.38E+04 |
| 200 | 189.5 | 4.54E+00 | 462.65 | 1 | 5.34E+02 |

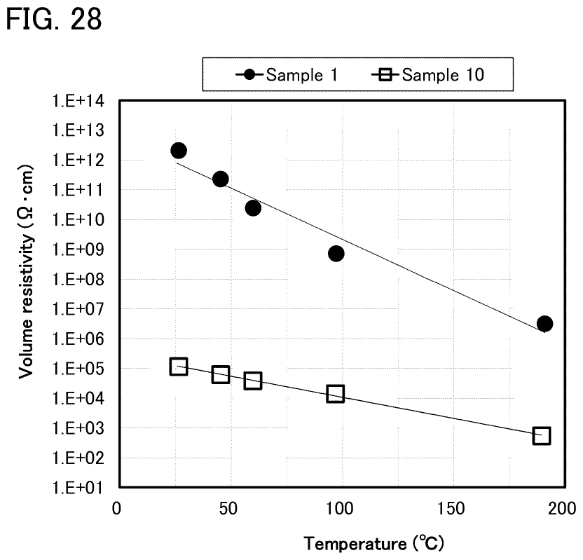

FIG. 28 is a semilog graph of data shown in Table 2 and Table 3, showing approximate straight lines of changes in volume resistivity. The temperature of FIG. 28 is the logger temperature, that is, a temperature read by the temperature sensor attached to the sample holder. The approximate straight line of Sample 1 is y=5.8×10¹²e^{-0.079x} and the approximate straight line of Sample 10 is y=2.8×10⁵e^{-0.033x}.

As shown in FIG. 28, the volume resistivities of the samples are decreased as the measurement temperature of the samples were increased. This is the property of semiconductors and insulators.

Furthermore, the volume resistivity of Sample 1 is much higher than that of Sample 10 at any measurement temperature; for example, the difference in volume resistivity was 1×10⁷ or higher at the logger temperature of 26.5° C.

As shown in Table 2, Table 3, and FIG. 28, the volume resistivity of Sample 1 is higher than or equal to 1.0×10¹⁰ Ω·cm, specifically higher than or equal to 1.0×10¹¹ Ω·cm at a temperature of higher than or equal to 20° C. and lower than or equal to 30° C. and at a pressure of higher than or equal to 10 MPa and lower than or equal to 20 MPa. On the other hand, the volume resistivity of Sample 10 is lower than 1.0×10⁶ Ω·cm in the same conditions.

In addition, the volume resistivity of Sample 1 is higher than or equal to 1.0×10¹⁰ Ω·cm, specifically higher than or equal to 1.0×10¹¹ Ω·cm at a temperature of higher than or equal to 40° C. and lower than or equal to 50° C. and lower than or equal to 0.3 MPa and at a pressure of higher than or equal to 2 MPa. On the other hand, the volume resistivity of Sample 10 is lower than or equal to 1.0×10⁶ Ω·cm, specifically 1.0×10⁵ Ω·cm in the same conditions.

Moreover, the volume resistivity of Sample 1 is higher than or equal to 1.0×10⁹ Ω·cm, specifically higher than or equal to 1.0×10¹⁰ Ω·cm at a temperature of higher than or equal to 55° C. and lower than or equal to 65° C. and lower than or equal to 0.3 MPa and at a pressure of higher than or equal to 2 MPa. On the other hand, the volume resistivity of Sample 10 is lower than or equal to 1.0×10⁶ Ω·cm, specifically 1.0×10⁵ Ω·cm in the same conditions.

Furthermore, the volume resistivity of Sample 1 is higher than or equal to 1.0×10⁶ Ω·cm, specifically higher than or equal to 1.0×10⁸ Ω·cm at a temperature of higher than or equal to 90° C. and lower than or equal to 110° C. and lower than or equal to 0.3 MPa and at a pressure of higher than or equal to 2 MPa. On the other hand, the volume resistivity of Sample 10 is lower than or equal to 1.0×10⁶ Ω·cm, specifically lower than or equal to 1.0×10⁵ Ω·cm in the same conditions.

Furthermore, the volume resistivity of Sample 1 is higher than or equal to 1.0×10⁶ Ω·cm at a temperature of higher than or equal to 180° C. and lower than or equal to 200° C. and lower than or equal to 0.3 MPa and at a pressure of higher than or equal to 2 MPa. On the other hand, the volume resistivity of Sample 10 is lower than or equal to 1.0×10³ Ω·cm in the same conditions.

The above description indicates that the volume resistivity of Sample 1 is high probably because the additive elements are distributed in the surface portion at preferable concentrations.

### <Fabrication of Half-Cell>

Sample 1 described above, acetylene black (AB), and poly(vinylidene fluoride) (PVDF) were prepared as a positive electrode active material, a conductive material, and a binding agent, respectively. The PVDF prepared was one dissolved in N-methyl-2-pyrrolidone (NMP) with the weight ratio of 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the application of the slurry on the positive electrode current collector, the solvent was volatilized.

After that, pressing was performed with a roller press machine to increase the density of the positive electrode active material layer over the positive electrode current collector. The pressing was performed with a linear pressure of 210 kN/m. Note that the temperature of each of an upper roll and a lower roll of the roller press machine was 120° C. The loading amount of the positive electrode active material was greater than or equal to 18 mg/cm² and less than or equal to 20 mg/cm².

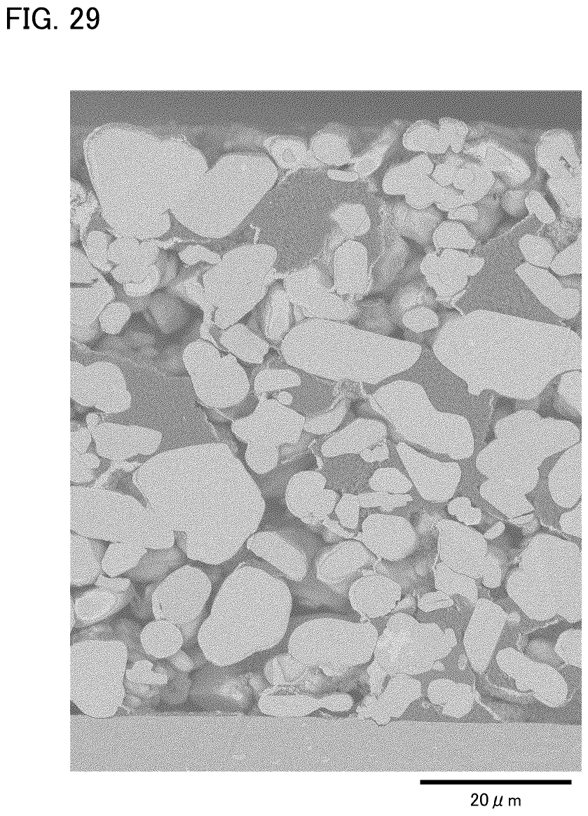

Through the above steps, the positive electrode including Sample 1 was obtained. FIG. 29 shows a cross-sectional SEM image of the positive electrode.

As an electrolyte solution, a mixture of ethylene carbonate (EC) and diethyl carbonate (DEC) at a volume ratio of 3:7 to which vinylene carbonate (VC) was added as an additive at 2 wt % was used. As an electrolyte contained in the electrolyte solution, 1 mol/L lithium hexafluorophosphate (LiPF₆) was used. As a separator, polypropylene was used.

A lithium metal was prepared as a counter electrode. Thus, a coin-type half-cell including the above positive electrode was fabricated.

As a comparative example, a half-cell was fabricated using Sample 10 which was lithium cobalt oxide not subjected to any treatment. The half-cell was fabricated in the same manner as described above, except that the loading amount of the positive electrode active material was approximately 7 mg/cm².

### <Charge-Discharge Cycle Performance>

A charge-discharge cycle test was performed on the coin-type half-cell formed above.

Rates of charge-discharge cycle test conditions are described. The rate at discharging is referred to as discharge rate and the discharge rate refers to the relative ratio of a current in discharge to the battery capacity and is expressed in a unit C. A current corresponding to 1 C in a battery with a rated capacity X (Ah) is X A. The case where discharge is performed at a current of 2X (A) is rephrased as follows: discharge is performed at 2 C. The case where discharge is performed at a current of X/2 A is rephrased as follows: discharge is performed at 0.5 C. The rate at charging is referred to as charge rate and similarly, for the charge rate, the case where charge is performed at a current of 2X (A) is rephrased as follows: charge is performed at 2 C, and the case where charge is performed at a current of X/2 (A) is rephrased as follows: charge is performed at 0.5 C. The charge rate and the discharge rate are collectively referred to as a charge-discharge rate.

In the charge-discharge cycle test, a set of charge and discharge is one cycle, the number of cycles was 50, and the discharge capacity retention rate (%) in the 50th cycle was calculated by (the discharge capacity in the 50th cycle/the maximum value of the discharge capacity in the 50 cycles)×100. That is, in the test, 50 charge-discharge cycles were performed was performed, the discharge capacity in each cycle was measured, and the ratio of the value of the discharge capacity measured in the 50th cycle to the maximum value of the discharge capacity in the 50 cycles (the maximum discharge capacity) was calculated. A higher discharge capacity retention rate enables a smaller reduction in battery capacity after repeated charge and discharge, which means favorable battery performance. Note that the above number of the cycles is an example.

In the charge-discharge cycle test, current is measured. Specifically, in measurement for charge and discharge, a battery voltage and a current flowing in a battery are preferably measured by a four-terminal method. In charging, electrons flow from a positive electrode terminal to a negative electrode terminal through a charge-discharge measurement system and thus, a charge current flows from the negative electrode terminal to the positive electrode terminal through the charge-discharge measurement system. In discharging, electrons flow from the negative electrode terminal to the positive electrode terminal through the charge-discharge measurement system and thus, a discharge current flows from the positive electrode terminal to the negative electrode terminal through the charge-discharge measurement system. The charge current and discharge current are measured with an ammeter of the charge-discharge measurement system, the total amount of the current flowing during one charge and the total amount of the current flowing during one discharge respectively correspond to charge capacity and discharge capacity. For example, the total amount of the discharge current flowing during the discharge in the first cycle can be regarded as the discharge capacity in the first cycle, and the total amount of the discharge current flowing during the discharge in the 50th cycle can be regarded as the discharge capacity in the 50th cycle.

The above-described charge-discharge cycle test was performed on the half-cell including Sample 1 and the half-cell including Sample 10 at the ambient temperatures of 25° C. and 45° C. (the ambient temperature is not mentioned hereinafter). The ambient temperature represents the temperature of the thermostatic oven where the samples were placed.

Constant current charge was performed on the half-cell including Sample 1 placed in the thermostatic oven under the charge condition of 0.2 C rate (in this example, 1 C=200 mA/g (the weight of the positive electrode active material) until the upper limit voltage reached 4.6 V, 4.7 V, 4.8 V, 4.9 V, or 5.0 V and constant voltage charge was performed until the current value reached 0.02 C. Charge in which constant current charge is performed and then constant voltage charge is performed is referred to as CC/CV charge. Constant current discharge was performed under the discharge condition of 0.2 C rate until the lower limit voltage reached 2.5 V. A break period was provided between charge and discharge, and the break period was 10 minutes in this example. A charge-discharge test system (TOSCAT-3100, produced by TOYO SYSTEM Co., Ltd.) was used as the charge-discharge measurement system.

For the half-cell including Sample 10, the same charge-discharge conditions were employed, except that the rate was 0.1 C.

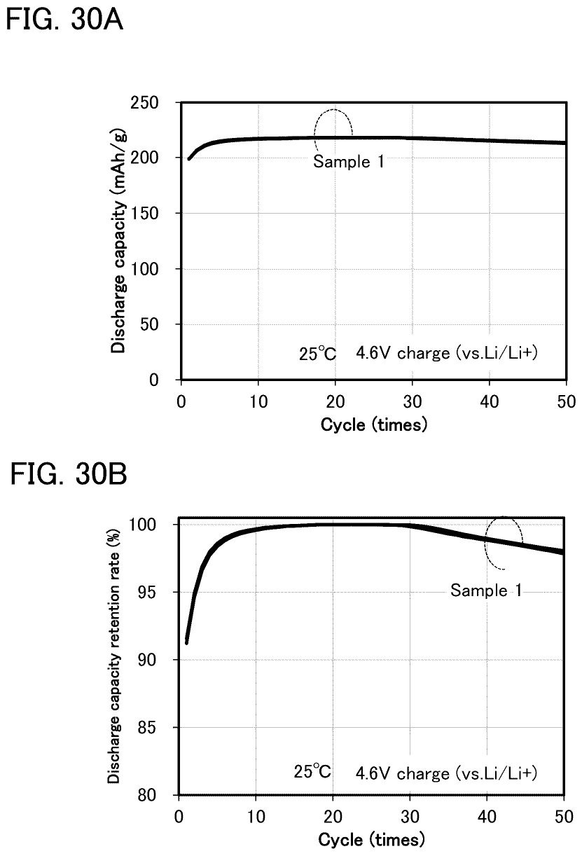

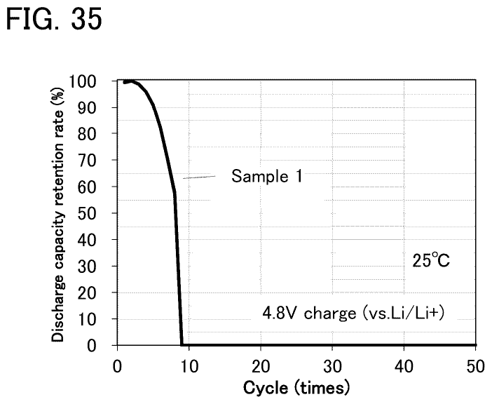

FIGS. 30A and 30B, FIGS. 31A and 31B, FIGS. 32A and 32B, FIGS. 33A and 33B, FIG. 35, FIG. 36, and FIG. 37 are graphs showing the charge-discharge cycle performance of the half-cell including Sample 1. In FIGS. 30A to 33B, n=3, and in FIGS. 35 to 37 n=2.

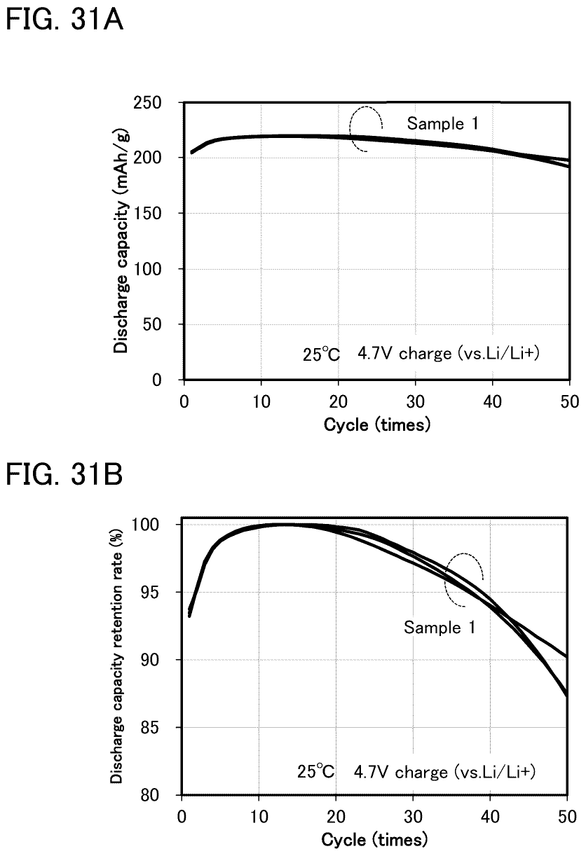

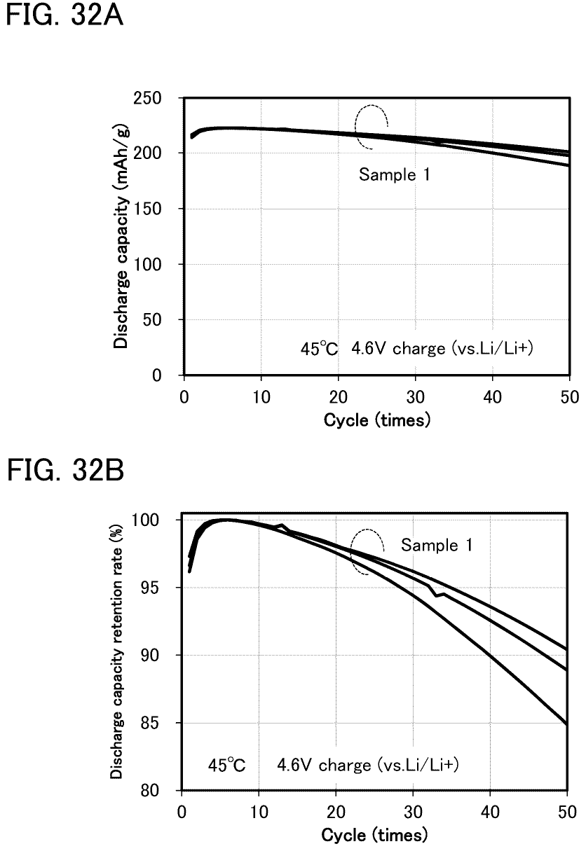

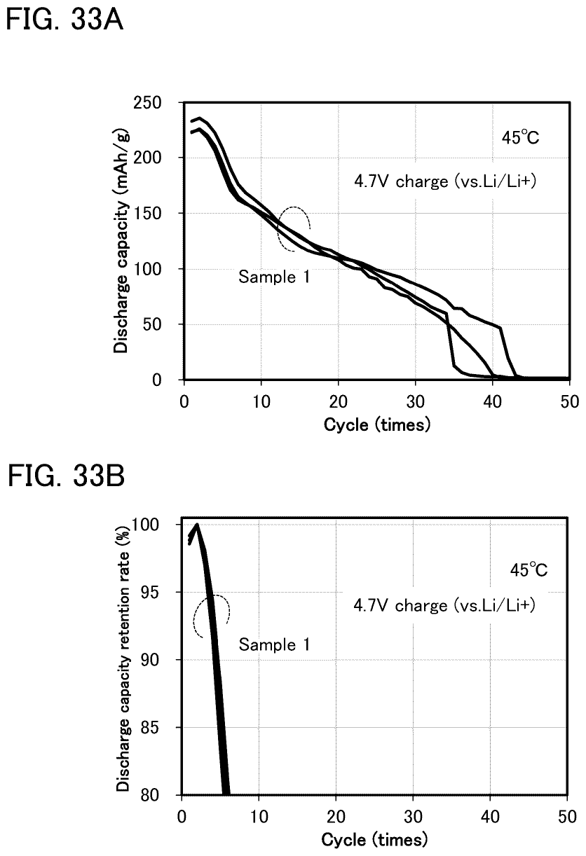

FIG. 30A is a graph of discharge capacity in a charge-discharge cycle test at 25° C. with an upper limit voltage of 4.6 V, and FIG. 30B is a graph of a discharge capacity retention rate. FIG. 31A is a graph of discharge capacity in a charge-discharge cycle test at 25° C. with upper limit voltage of 4.7 V, and FIG. 31B is a graph of a discharge capacity retention rate. FIG. 32A is a graph of discharge capacity in a charge-discharge cycle test at 45° C. with upper limit voltage of 4.6 V, and FIG. 32B is a graph of a discharge capacity retention rate. FIG. 33A is a graph of discharge capacity in a charge-discharge cycle test at 45° C. with upper limit voltage of 4.7 V, and FIG. 33B is a graph of a discharge capacity retention rate.

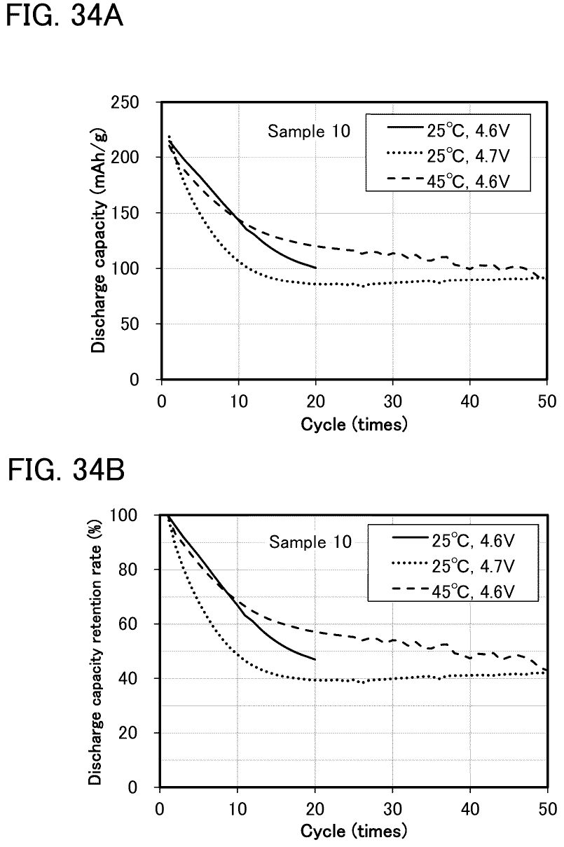

FIGS. 34A and 34B show charge-discharge cycle performance of Sample 10 (n=1) of the comparative example. FIG. 34A is a graph of discharge capacities in the charge-discharge cycle test at 25° C. with the upper limit voltage of 4.6 V, in the charge-discharge cycle test at 25° C. with the upper limit voltage of 4.7 V, and in the charge-discharge cycle test at 45° C. with the upper limit voltage of 4.6 V, and FIG. 34B is a graph of a discharge capacity retention rate.

Sample 1 showed excellent charge-discharge cycle performance at any temperature at an upper limit voltage of 4.6 V. Sample 1 also showed excellent charge-discharge cycle performance at 25° C. and even at an upper limit voltage of 4.7 V, as compared with Sample 10.

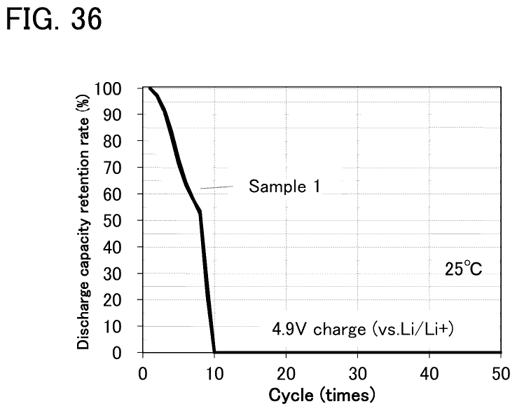

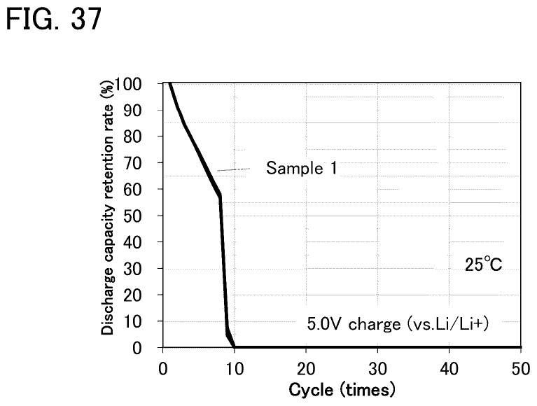

FIG. 35 is a graph of a discharge capacity retention rate in the charge-discharge cycle test at 25° C. with the upper limit voltage of 4.8 V, FIG. 36 is a graph of a discharge capacity retention rate in the charge-discharge cycle test at 25° C. with the upper limit voltage of 4.9 V, and FIG. 37 is a graph of a discharge capacity retention rate in the charge-discharge cycle test at 25° C. with the upper limit voltage of 5.0 V.

### <Loading Amount and Rate Characteristics>

Next, a relation between the loading amount of the positive electrode active material and the charge-discharge rate characteristics was evaluated. Half-cells including Sample 1 were fabricated in the same manner as described above, except that the loading amounts of the positive electrode active material are 5 mg/cm², 7 mg/cm², 10 mg/cm², 16 mg/cm², and 21 mg/cm².

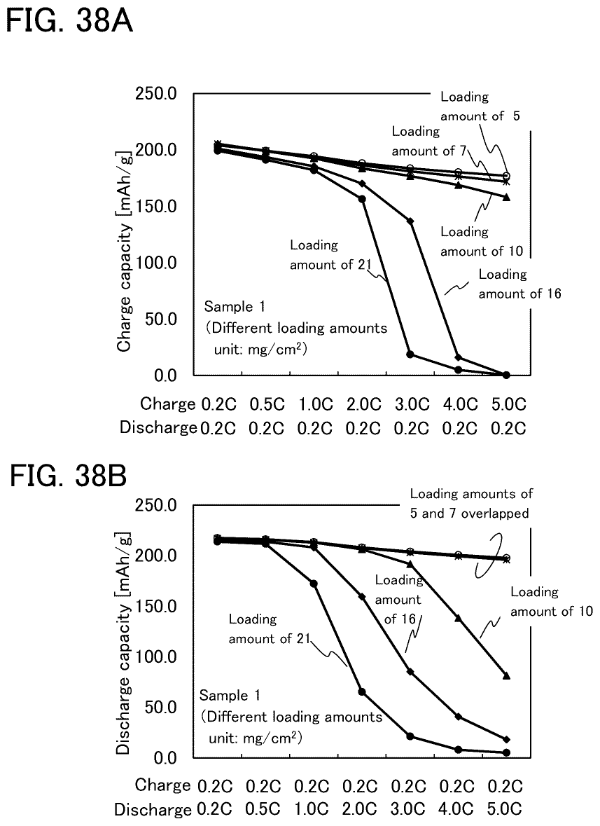

A charge rate test was performed on the half-cells. The discharge conditions were fixed in which constant current discharge was performed down to 2.5 V as the lower limit voltage at 0.2 C rate. The charge conditions were as follows: in first to third cycles, constant current charge was performed up to 4.6 V as the upper limit voltage at 0.2 C and constant voltage charge was performed until the current value reached 0.02 C, and then, in fourth to tenth cycles, the rate was changed per cycle in the order of 0.5 C, 1 C, 2 C, 3 C, 4 C, 5 C, and 0.2 C and the conditions other than the charge rate were the same as those in the first to third cycles. The ambient temperature was 25° C. FIG. 38A shows the results of the charge rate characteristics.

A discharge rate test was performed on half cells fabricated in the same manner. The charge conditions were fixed in which constant current charge was performed up to 4.6 V as the upper limit voltage at 0.2 C rate and constant voltage charge was performed until the current value reached 0.02 C. The discharge conditions were as follows: in first to third cycles, constant current discharge was performed down to 2.5 V as the lower limit voltage at 0.2 C rate, and then, in fourth to tenth cycles, the rate was changed per cycle in the order of 0.5 C, 1 C, 2 C, 3 C, 4 C, 5 C, and 0.2 C and the conditions other than the discharge rate were the same as those in the first to third cycles. The ambient temperature was 25° C. FIG. 38B shows the results of the discharge rate characteristics.

As shown in FIG. 38A, the cells with the loading amounts of the positive electrode active materials of 10 mg/cm² or less showed favorable charge rate characteristics at any rate. For example, the cell with the loading amount of 10 mg/cm² showed charge capacity of 158 mAh/g even when the charge rate was 5 C. Even the cells with large loading amounts of the positive electrode active materials showed favorable charge rate characteristics up to 2 C rate. For example, even the cell with the loading amount of 21 mg/cm² showed the charge capacity of 156 mAh/g at 2 C rate.

As shown in FIG. 38B, the cells with the loading amounts of the positive electrode active materials of 7 mg/cm² or less all showed favorable discharge rate characteristics at any rate. For example, the cell with the loading amount of 7 mg/cm² showed discharge capacity of 196 mAh/g even at the charge rate of 5 C. Even the cells with large loading amounts of the positive electrode active materials showed favorable discharge rate characteristics up to 1 C rate. For example, the cell with the loading amount of 21 mg/cm² showed discharge capacity of 172 mAh/g even at the 2 C rate.

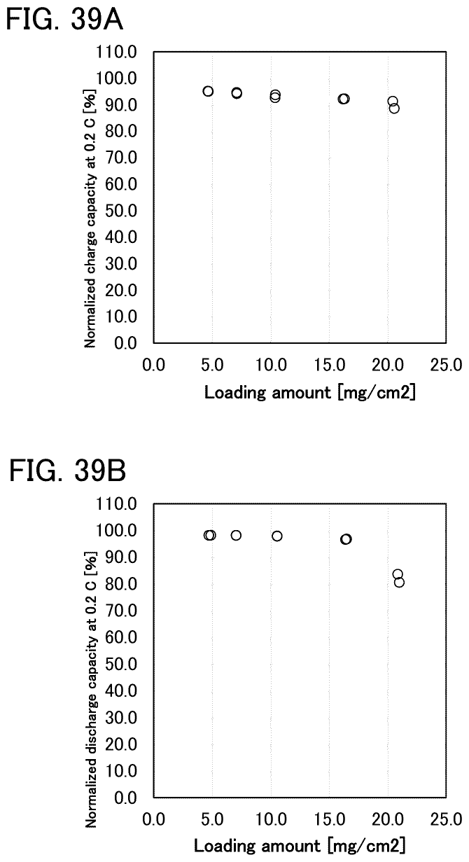

FIGS. 39A and 39B show a comparison between the loading amounts at 1 C rate. The charge capacity at the charge rate of 1 C in FIG. 38A are normalized by the charge capacity at 0.2 C. The discharge capacity at the discharge rate of 1 C in FIG. 38B are normalized by the discharge capacity at 0.2 C.

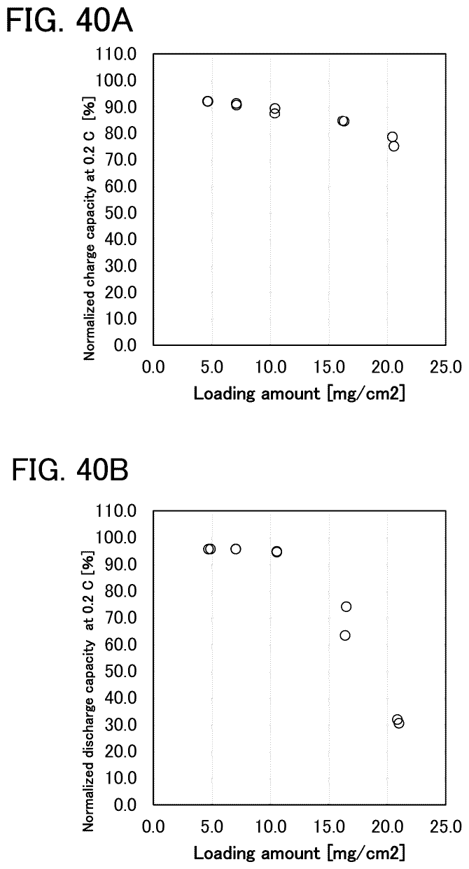

FIGS. 40A and 40B show a comparison between the loading amounts at 2 C rate. The charge capacity at the charge rate of 2 C in FIG. 38A are normalized by the charge capacity at 0.2 C. The discharge capacity at the discharge rate of 2 C in FIG. 38B are normalized by the discharge capacity at 0.2 C.

### <Fabrication of Full-Cell and Nail Penetration Test>

Next, a secondary battery including Sample 1 as the positive electrode active material and graphite as the negative electrode active material and a secondary battery including Sample 10 as the positive electrode active material and graphite as the negative electrode active material were fabricated, and a nail penetration test was performed as a safety test.

Positive electrodes using Samples 1 and 10 were fabricated in the same manner as described above, except that the loading amounts of the positive electrode active materials were greater than or equal to 20 mg/cm² and less than or equal to 22 mg/cm².

Graphite was prepared as a negative electrode active material. For a binder, CMC and SBR were prepared. Carbon fiber (VGCF (registered trademark) produced by Showa Denko K.K) was prepared as a conductive material. Then, graphite, VGCF, CMC, and SBR were mixed at a weight ratio of 97:1:1:1 to form a slurry, and the slurry was applied on a copper negative electrode current collector. As a solvent of the slurry, water was used.

After the application of the slurry on the negative electrode current collector, the solvent was volatilized. Through the above steps, a negative electrode was obtained.

As an electrolyte solution, an organic electrolyte solution was prepared by dissolving lithium hexafluorophosphate (LiPF₆) in a mixed organic solvent containing ethylene carbonate (EC) and diethyl carbonate (DEC) at a volume ratio of EC:DEC=30:70 in such a manner that LiPF₆ was at 1 mol/L with respect to the mixed organic solvent. Note that no additive agent was used.

As the separator, a 25-μm-thick porous polypropylene film was used.

As the exterior body, an aluminum laminate film was used.

Table 4 shows fabrication conditions of the cells fabricated using the above materials.

TABLE 4

| Positive | Active material | Sample 1 | | Sample 10 | |
|---|---|---|---|---|---|
| electrode | Binder | PVDF | | | |
| | Conductive material | Acetylene black | | | |
| | Loading amount | 20.4 | mg/cm² | 21.5 | mg/cm² |
| | (One side) | | | | |
| | Current collector foil | Al (two-way mirror)/20 μm | | | |
| | material/thickness | | | | |
| | Thickness of active | 76 | μm | 83 | μm |
| | material layer | | | | |
| | (Average in one side) | | | | |
| Negative | Active material | Spherical natural graphite | | | |
| electrode | Binder, thickener | SBR, CMC | | | |
| | Conductive material | VGCF | | | |
| | Loading amount | 13.9 | mg/cm² | 13.7 | mg/cm² |
| | (One side) | | | | |
| | Current collector foil | Cu/18 μm | | | |
| | material/thickness | | | | |
| | Thickness of active | 119 | μm | 118 | μm |
| | material layer | | | | |
| | (Average in one side) | | | | |
| Separator | Material/Thickness | PP (polypropylene)/25 μm | | | |
| Electrolyte | Main solvent/additive | EC:DEC (3:7) | | | |
| solution | Lithium salt | 1M LiPF6 | | | |
| Cell | Number of positive | 7 pieces (both-side coating) | | | |
| conditions | electrodes | | | | |
| | Number of negative | 6 pieces (both-side coating) + 2 | | | |
| | electrodes | exterior pieces (one-side coating) | | | |
| | Exterior body | Aluminum laminate | | | |
| Nail | Charge voltage | 4.5 V (full-cell) | | 4.2 V (full-cell) | |
| penetration | (aging) | | | | |

| test | Charge voltage | 4.5 V (full-cell) | |
|---|---|---|---|
| | (nail penetration) | | |
| | Design capacity | 1200 mAh | |
| | Capacity ratio between | 0.84 | 0.83 |
| | positive and negative | | |
| | electrodes | | |
| | Decision | No ignition | Smoking |

These cells were subjected to initial charge and discharge. The initial charge and discharge are sometimes referred to as aging or conditioning. Table 5 shows details of the initial charge and discharge of the cell including Sample 1 and Table 6 shows details of the initial charge and discharge of the cell including Sample 10.

TABLE 5

| | Charge/ | |
|---|---|---|
| | discharge | Conditions |
| Step A1 | Constant | At 0.01 C and ambient temperature of 25° C. |
| | current | Charge is finished when the end-of-charge voltage |
| | charge | reaches 4.5 V or the end capacity reaches 15 mAh/g. |
| Step A2 | Constant | At 0.1 C and ambient temperature of 25° C. |
| | current | Charge is finished when the end-of-charge voltage |
| | charge | reaches 4.5 V or the end capacity reaches 120 |
| | | mAh/g. |
| Step A3 | N/A | Sample is placed in thermostatic oven at 60° C. for |
| | | 24 hours. |
| Step A4 | N/A | One side of the cell is opened in a glove box and |
| | | is sealed again under a reduced pressure of −60 kPa. |
| Step A5 | Constant | At 0.1 C, 4.5 V, and ambient temperature of 25° C. |
| | current- | Charge is finished when the end-of-charge current |
| | constant | reaches 0.01 C or lower or the end time reaches 10 |
| | voltage | hours. |
| | charge | |
| Step A6 | Constant | At 0.2 C and ambient temperature of 25° C. |
| | current | Discharge is finished when the end-of-discharge |
| | discharge | voltage reaches 2.5 V or the end time reaches 8 |
| | | hours. |
| Step A7 | Constant | At 0.2 C, 4.5 V, and ambient temperature of 25° C. |
| | current- | Charge is finished when the end-of-charge current |
| | constant | reaches 0.02 C or less or the end time reaches 8 |
| | voltage | hours. |
| | charge | |
| Step A8 | Constant | At 0.2 C and ambient temperature of 25° C. |
| | current | Discharge is finished when the end-of-discharge |
| | discharge | voltage reaches 2.5 V or the end time reaches 8 |
| | | hours. |

*Repeat Step A7 and Step A8 three times

TABLE 6

| | Charge/ | |
|---|---|---|
| | discharge | Conditions |
| Step A1 | Constant | At 0.01 C and ambient temperature of 25° C. |
| | current | Charge is finished when the end-of-charge |
| | charge | voltage reaches 4.2 V or the end capacity reaches |
| | | 15 mAh/g. |
| Step A2 | Constant | At 0.1 C and ambient temperature of 25° C. |
| | current | Charge is finished when the end-of-charge |
| | charge | voltage reaches 4.2 V or the end capacity reaches |
| | | 120 mAh/g. |
| Step A3 | N/A | Sample is placed in thermostatic oven at 60° C. |
| | | for 24 hours. |
| Step A4 | N/A | One side of the cell is opened in a glove box and |
| | | is sealed again under a reduced pressure of −60 kPa. |
| Step A5 | Constant | At 0.1 C, 4.2 V, and ambient temperature of 25° C. |
| | current- | Charge is finished when the end-of-charge |
| | constant | current reaches 0.01 C or lower or the end time |
| | voltage | reaches 10 hours. |
| | charge | |
| Step A6 | Constant | At 0.2 C and ambient temperature of 25° C. |
| | current | Discharge is finished when the end-of-discharge |
| | discharge | voltage reaches 2.5 V or the end time reaches 8 |
| | | hours. |
| Step A7 | Constant | At 0.2 C, 4.2 V, and ambient temperature of 25° C. |
| | current- | Charge is finished when the end-of-charge |
| | constant | current reaches 0.02 C or lower or the end time |
| | voltage | reaches 8 hours. |
| | charge | |
| Step A8 | Constant | At 0.2 C and ambient temperature of 25° C. |
| | current | Discharge is finished when the end-of discharge |
| | discharge | voltage reaches 2.5 V or the end time reaches 8 |
| | | hours. |

*Repeat Step A7 and Step A8 three times

After the initial charge and discharge, the nail penetration test was performed on the cell including Sample 1 and the cell including Sample 10. For the nail penetration test, Advanced Safety Tester produced by ESPEC CORP was used. A nail having a diameter of 3 mm was used. The operation speed of nail penetration was 5 mm/s. The nail penetration depth was 10 mm. The other conditions in the nail penetration test were compliant with SAE J2464, “Electric and Hybrid Electric Vehicle Rechargeable Energy Storage System (RESS) Safety and Abuse Testing”.

The cell including Sample 1 and the cell including Sample 10 were fully charged under conditions of Step A7 in Table 5. At this time, the battery voltage was 4.5 V. The temperature was adjusted so that the battery temperature reached 25° C. before the nail penetration test. The battery temperature in the nail penetration test refers to a temperature read by a temperature sensor; the battery temperature in the case where the temperature sensor is in contact with an exterior body is equal to the temperature of the exterior body.

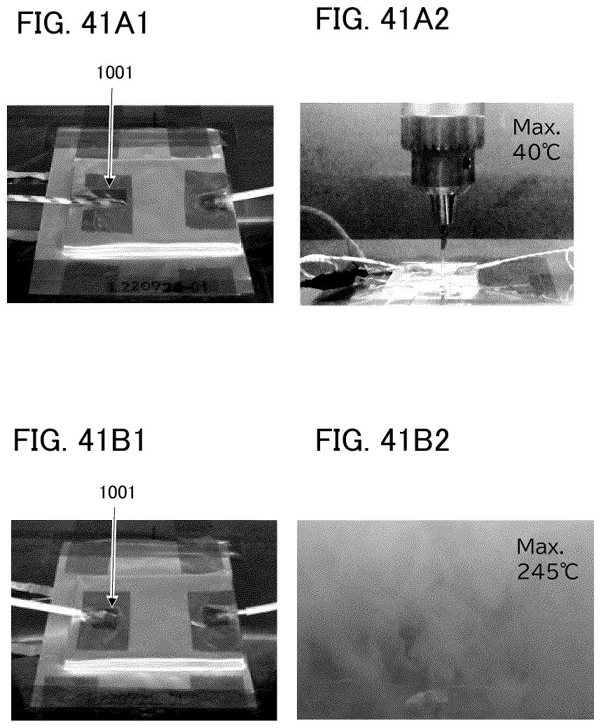

FIG. 41A1 is a photograph of the exterior of the cell including Sample 1, and FIG. 41B1 is a photograph of the exterior of the cell including Sample 10. A temperature sensor 1001 was attached to the exterior body near a tab (within 3 cm from the tab) included in the cell.

FIG. 41A2 shows a state where the nail penetration test was performed on the cell including Sample 1. In the cell including Sample 1, smoking, ignition, and the like were not observed. The maximum temperature of the battery was 40° C.

FIG. 41B2 shows a state where the nail penetration test was performed on the cell including Sample 10. In the cell including Sample 10, a large amount of smoke was generated. The maximum temperature of the battery was 245° C.

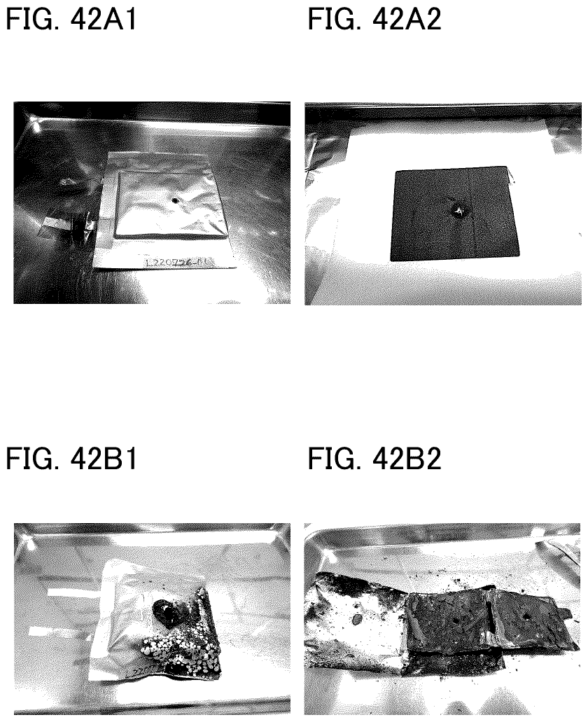

FIG. 42A1 shows a state after the nail penetration test performed on the cell including Sample 1. FIG. 42A2 shows the positive electrode taken out from the cell. Anomalies were not particularly found except for the hole opened by the nail. Note that the region coated with the active material layer in the positive electrode shown in FIG. 42A2 is 41 mm high and 50 mm wide.

FIG. 42B1 shows a state after the nail penetration test performed on the cell including Sample 10. FIG. 42B2 shows the positive electrode and the negative electrode taken out from the cell. As for Sample 10, the exterior body was swelled largely and the active material layers of the positive electrode and the negative electrode were collapsed. It was confirmed that thermal runway occurred in the entire secondary battery including Sample 10.

From the above, it can be considered that Sample 1 has a high powder volume resistivity and thus generates a smaller amount of current flowing through the nail than that Sample 10 in the nail penetration test, whereby heat generation can be suppressed. Moreover, it is also considered that the positive electrode active material of Sample 1 has a stable crystal structure in a high-voltage charge state as compared with that of Sample 10, and thermal decomposition reaction that causes oxygen release is suppressed, resulting in inhibition of thermal runway. It is also considered that an appropriate shell is formed in Sample 1 and thus the reaction between the positive electrode active material surface and the electrolyte solution is suppressed, resulting in inhibition of thermal runway. In other words, the positive electrode active material of one embodiment of the present invention is highly safe because it does not easily ignite when abnormalities such as an internal short circuit occurs.

This application is based on Japanese Patent Application Serial No. 2022-130430 filed with Japan Patent Office on Aug. 18, 2022 and Japanese Patent Application Serial No. 2022-203401 filed with Japan Patent Office on Dec. 20, 2022, the entire contents of which are hereby incorporated by reference.

What is claimed is:

1. A positive electrode active material comprising:
lithium;
a transition metal M;
an additive element; and
oxygen,
wherein a powder volume resistivity of the positive electrode active material is higher than or equal to 1.0×10¹⁰ Ω·cm at a temperature of higher than or equal to 20° C. and lower than or equal to 30° C. and at a pressure of higher than or equal to 10 MPa and lower than or equal to 20 MPa.

2. The positive electrode active material according to claim 1,
wherein a median diameter of the positive electrode active material is greater than or equal to 3 μm and less than or equal to 10 μm.

3. The positive electrode active material according to claim 1,
wherein the additive element is at least one of magnesium, fluorine, nickel, and aluminum.

4. The positive electrode active material according to claim 1,
wherein the additive element comprises magnesium and nickel, and
wherein a peak of a detected amount of magnesium and a peak of a detected amount of nickel are observed in a region ranging from a surface to a depth of 3 nm or less.

5. The positive electrode active material according to claim 4,
wherein the peak of the detected amount of magnesium is closer to the surface than the peak of the detected amount of nickel.

6. The positive electrode active material according to claim 4,
wherein the peak of the detected amount of nickel is closer to the surface than the peak of the detected amount of magnesium.

7. The positive electrode active material according to claim 4,
wherein the additive element further comprises aluminum, and
wherein a peak of a detected amount of aluminum is observed in a region ranging from the surface to a depth of greater than or equal to 5 nm and less than or equal to 30 nm.

8. A positive electrode active material comprising:
lithium;
a transition metal M;
an additive element; and
oxygen,
wherein a powder volume resistivity of the positive electrode active material is higher than or equal to 1.0×10⁵ Ω·cm at a temperature of higher than or equal to 180° C. and lower than or equal to 200° C. and at a pressure of higher than or equal to 0.3 MPa and lower than or equal to 2 MPa.

9. The positive electrode active material according to claim 8,
wherein a median diameter of the positive electrode active material is greater than or equal to 3 μm and less than or equal to 10 μm.

10. The positive electrode active material according to claim 8,
wherein the additive element is at least one of magnesium, fluorine, nickel, and aluminum.

11. The positive electrode active material according to claim 8,
wherein the additive element comprises magnesium and nickel, and
wherein a peak of a detected amount of magnesium and a peak of a detected amount of nickel are observed in a region ranging from a surface to a depth of 3 nm or less.

12. The positive electrode active material according to claim 11,
wherein the peak of the detected amount of magnesium is closer to the surface than the peak of the detected amount of nickel.

13. The positive electrode active material according to claim 11,
wherein the peak of the detected amount of nickel is closer to the surface than the peak of the detected amount of magnesium.

14. The positive electrode active material according to claim 11,
wherein the additive element further comprises aluminum, and
wherein a peak of a detected amount of aluminum is observed in a region ranging from the surface to a depth of greater than or equal to 5 nm and less than or equal to 30 nm.

15. A secondary battery comprising:
a positive electrode comprising a positive electrode active material comprising lithium, a transition metal M, an additive element, and oxygen; and
an electrolyte solution,
wherein the electrolyte solution has a current density of less than or equal to 1.0 mA·cm⁻² at any voltage of lower than or equal to 5.0 V when a linear sweep voltammetry measurement is performed at a voltage scanning rate of 1.0 mV·s⁻¹ at a temperature of 25° C. on a coin cell comprising a working electrode in which a mixture of a conductive material and a binder with a ratio of 1:1 is applied to a current collector coated with carbon; a lithium metal counter electrode; and a separator.

16. The secondary battery according to claim 15,
wherein the conductive material of the coin cell comprises acetylene black,
wherein the binder of the coin cell comprises poly(vinylidene fluoride),
wherein the current collector of the coin cell comprises aluminum foil, and
wherein the separator of the coin cell comprises a polypropylene separator.
